(19) United States
(12) Patent Application Publication
(10) Pub. No.: US 2026/0182573 A1
(43) Pub. Date: Jul. 2, 2026

(54) MIXTURES OF SUCCINATE DEHYDROGENASE INHIBITORS AND PICOLINAMIDES

(71) Applicant: FMC CORPORATION, Philadelphia, PA (US)

(72) Inventors: Henry K. NGUGI, Newark, DE (US); Sylvain PIERRE, Nambsheim Haut-Rhin (FR); Patrick FAVIER, Ceillac Hautes-Alpes (FR)

(21) Appl. No.: 19/130,674

(22) PCT Filed: Nov. 16, 2023
(86) PCT No.: PCT/US2023/079934

§ 371 Date: May 16, 2025

Related U.S. Application Data
(60) Provisional application No. 63/426,582, filed on Nov. 18, 2022.

(51) Int. Cl. A01N 43/56; A01N 43/40; A01P 3/00

(52) U.S. Cl. CPC A01N 43/56; A01N 43/40; A01P 3/00

(57) ABSTRACT

Disclosed is a composition comprising (a1) a succinate dehydrogenase inhibitor (SDHI) and (a2) a picolinamide.

Also disclosed is a method for controlling plant diseases caused by fungal plant pathogens comprising applying to the plant or portion thereof, or to the plant seed, a fungicidally effective amount of a composition comprising (a1) a succinate dehydrogenase inhibitor (SDHI) and (a2) a picolinamide.

### FIELD OF THE INVENTION

This invention relates to agrochemical compositions comprising mixtures including a succinate dehydrogenase inhibitor (SDHI) and a picolinamide and methods for using such mixtures for protecting a plant or plant seed from diseases caused by fungal pathogens.

### BACKGROUND OF THE INVENTION

The control of plant diseases caused by fungal plant pathogens is extremely important in achieving high crop efficiency. Plant disease damage to ornamental, vegetable, field, cereal and fruit crops can cause significant reduction in productivity and thereby result in increased costs to the consumer. In addition to often being highly destructive, plant diseases can be difficult to control and may develop resistance to commercial fungicides. Many products are commercially available for these purposes, but the need continues for new fungicidal compounds which are more effective, less costly, less toxic, environmentally safer or have different sites of action. Besides introduction of new fungicides, combinations of fungicides are often used to facilitate disease control, to broaden spectrum of control and to retard resistance development. Furthermore, certain rare combinations of fungicides demonstrate a greater-than-additive (i.e. synergistic) effect to provide commercially important levels of plant disease control. The advantages of particular fungicide combinations are recognized in the art to vary, depending on such factors as the particular plant species and plant disease to be treated, whether the plant disease is from a resistant strain of fungi, and whether the plants are treated before or after infection with the fungal plant pathogen. Accordingly, new advantageous combinations are needed to provide a variety of options to best satisfy particular plant disease control needs. Such combinations have now been discovered.

PCT Patent Publications WO 2012/084812 and WO 2013/186325 disclose certain succinate dehydrogenase inhibitors (SDHI) selected from pyrazole-4-carboxamide derivatives, their mixtures and their use as fungicides.

PCT Patent Publication WO 2007/048556 discloses certain succinate dehydrogenase inhibitors (SDHI) selected from heterocyclic amide derivatives, their mixtures and their use as fungicides.

U.S. Patent Publication US 2008/0293798 discloses fungicidal mixtures comprising a succinate dehydrogenase inhibitor (SDHI) selected from 1-methylpyrazol-4-ylcarboxanilide derivatives.

PCT Patent Publications WO 2003/035617, WO 2016/109257, WO 2018/129237, and WO 2019/173665 disclose picolinamide compounds, their mixtures and their use as fungicides.

### SUMMARY OF THE INVENTION

This invention relates to a fungicidal composition (i.e. combination, mixture) comprising:
(a1) a succinate dehydrogenase inhibitor (SDHI); and
(a2) a picolinamide.

This invention also relates to a composition comprising: (a1) a succinate dehydrogenase inhibitor (SDHI); and (a2) a picolinamide; and at least one component (b).

This invention also relates to a composition comprising: (a1) a succinate dehydrogenase inhibitor (SDHI); and (a2) a picolinamide, wherein the SDHI and the picolinamide are present in a synergistically effective amount; and optionally at least one component (b).

This invention also relates to a composition comprising one of the aforesaid compositions and at least one additional component selected from the group consisting of surfactants, solid diluents, and liquid diluents.

This invention also relates to a method for controlling plant diseases caused by fungal plant pathogens, including resistant strains of fungal pathogens, comprising applying to the plant or portion thereof, or to the plant seed, a fungicidally effective amount of one of the aforesaid compositions.

The aforedescribed method can also be described as a method for protecting a plant or plant seed from diseases caused by fungal pathogens comprising applying a fungicidally effective amount of one of the aforesaid compositions to the plant (or portion thereof) or plant seed (directly or through the environment (e.g., growing medium) of the plant or plant seed).

### DETAILS OF THE INVENTION

As used herein, the terms “comprises,” “comprising,” “includes,” “including,” “has,” “having,” “contains,” “containing,” “characterized by” or any other variation thereof, are intended to cover a non-exclusive inclusion, subject to any limitation explicitly indicated. For example, a composition, mixture, process, method, article, or apparatus that comprises a list of elements is not necessarily limited to only those elements but may include other elements not expressly listed or inherent to such composition, mixture, process, method, article, or apparatus.

The transitional phrase “consisting of” excludes any element, step, or ingredient not specified. If in the claim, such would close the claim to the inclusion of materials other than those recited except for impurities ordinarily associated therewith. When the phrase “consisting of” appears in a clause of the body of a claim, rather than immediately following the preamble, it limits only the element set forth in that clause; other elements are not excluded from the claim as a whole.

The transitional phrase “consisting essentially of” is used to define a composition, method or apparatus that includes materials, steps, features, components, or elements, in addition to those literally disclosed, provided that these additional materials, steps, features, components, or elements do not materially affect the basic and novel characteristic(s) of the claimed invention. The term “consisting essentially of” occupies a middle ground between “comprising” and “consisting of”.

Where applicants have defined an invention or a portion thereof with an open-ended term such as “comprising,” it should be readily understood that (unless otherwise stated) the description should be interpreted to also describe such an invention using the terms “consisting essentially of” or “consisting of.”

Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, the indefinite articles “a” and “an” preceding an element or component of the invention are intended to be nonrestrictive regarding the number of instances (i.e. occurrences) of the element or component. Therefore “a” or “an” should be read to include one or at least one, and the singular word form of the element or component also includes the plural unless the number is obviously meant to be singular.

The term “agronomic” refers to the production of field crops such as for food and fiber and includes the growth of maize or corn, soybeans and other legumes, rice, cereal (e.g., wheat, oats, barley, rye and rice), leafy vegetables (e.g., lettuce, cabbage, and other cole crops), fruiting vegetables (e.g., tomatoes, pepper, eggplant, crucifers and cucurbits), potatoes, sweet potatoes, grapes, cotton, tree fruits (e.g., pome, stone and citrus), small fruit (e.g., berries and cherries) and other specialty crops (e.g., canola, sunflower and olives).

The term “nonagronomic” refers to other than field crops, such as horticultural crops (e.g., greenhouse, nursery or ornamental plants not grown in a field), residential, agricultural, commercial and industrial structures, turf (e.g., sod farm, pasture, golf course, lawn, sports field, etc.), wood products, stored product, agro-forestry and vegetation management, public health (i.e. human) and animal health (e.g., domesticated animals such as pets, livestock and poultry, undomesticated animals such as wildlife) applications.

The term “crop vigor” refers to rate of growth or biomass accumulation of a crop plant. An “increase in vigor” refers to an increase in growth or biomass accumulation in a crop plant relative to an untreated control crop plant. The term “crop yield” refers to the return on crop material, in terms of both quantity and quality, obtained after harvesting a crop plant. An “increase in crop yield” refers to an increase in crop yield relative to an untreated control crop plant.

The term “biologically effective amount” refers to the amount of a biologically active compound sufficient to produce the desired biological effect when applied to (i.e. contacted with) a fungus to be controlled or its environment, or to a plant, the seed from which the plant is grown, or the locus of the plant (e.g., growth medium) to protect the plant from injury by the fungal disease or for other desired effect (e.g., increasing plant vigor).

As referred to in the present disclosure and claims, “plant” includes members of Kingdom Plantae, particularly seed plants (Spermatopsida), at all life stages, including young plants (e.g., germinating seeds developing into seedlings) and mature, reproductive stages (e.g., plants producing flowers and seeds). Portions of plants include geotropic members typically growing beneath the surface of the growing medium (e.g., soil), such as roots, tubers, bulbs and corms, and also members growing above the growing medium, such as foliage (including stems and leaves), flowers, fruits and seeds.

As referred to herein, the term “seedling”, used either alone or in a combination of words means a young plant developing from the embryo of a seed.

As referred to herein, the term “broadleaf” used either alone or in words such as “broadleaf crop” means dicot or dicotyledon, a term used to describe a group of angiosperms characterized by embryos having two cotyledons.

As referred to in this disclosure, the terms “fungal pathogen” and “fungal plant pathogen” include pathogens in the Ascomycota, Basidiomycota and Zygomycota phyla, and the fungal-like Oomycota class that are the causal agents of a broad spectrum of plant diseases of economic importance, affecting ornamental, turf, vegetable, field, cereal and fruit crops. In the context of this disclosure, “protecting a plant from disease” or “control of a plant disease” includes preventative action (interruption of the fungal cycle of infection, colonization, symptom development and spore production) and/or curative action (inhibition of colonization of plant host tissues).

As used herein, the term “mode of action” (MOA) is as define by the Fungicide Resistance Action Committee (FRAC), and is used to distinguish fungicides according to their biochemical mode of action in the biosynthetic pathways of plant pathogens, and their resistance risk. FRAC-defined modes of actions include (A) nucleic acid synthesis, (B) mitosis and cell division, (C) respiration, (D) amino acid and protein synthesis, (E) signal transduction, (F) lipid synthesis and membrane integrity, (G) sterol biosynthesis in membranes, (H) cell wall biosynthesis, (I) melanin synthesis in cell wall, (P) host plant defense induction, (U) unknown mode of action, (NC) not classified, (M) multi-site contact activity and (BM) biologicals with multiple modes of action. Each mode of action (i.e. letters A through BM) contain one or more subgroups (e.g., A includes subgroups A1, A2, A3 and A4) based either on individual validated target sites of action, or in cases where the precise target site is unknown, based on cross resistance profiles within a group or in relation to other groups. Each of these subgroups (e.g., A1, A2, A3 and A4) is assigned a FRAC code (a number and/or letter). For example, the FRAC code for subgroup A1 is 4. Additional information on target sites and FRAC codes can be obtained from publicly available databases maintained, for example, by FRAC.

As used herein, the term “cross resistance” refers to the phenomenon that occurs when a pathogen develops resistance to one fungicide and simultaneously becomes resistant to one or more other fungicides. These other fungicides are typically, but not always, in the same chemical class or have the same target site of action, or can be detoxified by the same mechanism.

In the present disclosure, phrases such as “fungicide resistance”, or “resistant strain of fungus”, and the like, refer to a fungal pathogen that survives and reproduces in the presence of a fungicide. Resistance development is an evolutionary process occurring after a period of exposure of the pathogen to a fungicide. For example, a pathogen that is initially sensitive to a fungicide becomes less sensitive over time and is no longer controlled adequately by the fungicide. Resistance can develop as qualitative or quantitative resistance. Qualitative resistance, also known as single gene or major gene resistance, happens when loss of efficacy is brought about by a single mutation in the target gene. Quantitative resistance, also known as multiple gene resistance, occurs when a gradual reduction in sensitivity is brought about by the development of many individual genetic changes, such as mutations in the target gene or over-expression of the target gene. Additional information on fungal species with resistance towards fungicides and the corresponding gene mutations is regularly published by the FRAC, and publicly available on their website.

Compounds of this invention can exist as one or more stereoisomers. Stereoisomers are isomers of identical constitution but differing in the arrangement of their atoms in space and include enantiomers, diastereomers, cis- and trans-isomers (also known as geometric isomers) and atropisomers. Atropisomers result from restricted rotation about single bonds where the rotational barrier is high enough to permit isolation of the isomeric species. One skilled in the art will appreciate that one stereoisomer may be more active and/or may exhibit beneficial effects when enriched relative to the other stereoisomer(s) or when separated from the other stereoisomer(s). Additionally, the skilled artisan knows how to separate, enrich, and/or to selectively prepare said stereoisomers. For a comprehensive discussion of all aspects of stereoisomerism, see Ernest L. Eliel and Samuel H. Wilen, Stereochemistry of Organic Compounds, John Wiley & Sons, 1994.

This invention also includes compounds of the recited formulae wherein one stereoisomer is enriched relative to the other stereoisomer(s). For example, the ratio of the (Z)- to (E)-isomers in any compounds of the recited formulae, whether produced stereoselectivity or non-stereoselectivity, may take on a broad range of values. In addition, this invention includes compounds that are enriched compared to the racemic mixture in an enantiomer of the recited formulae. Also included are the essentially pure enantiomers of compounds of the recited formulae. When enantiomerically enriched, one enantiomer is present in greater amounts than the other, and the extent of enrichment can be defined by an expression of enantiomeric excess (“ee”), which is defined as (2x−1) 100%, where x is the mole fraction of the dominant enantiomer in the mixture (e.g., an ee of 20% corresponds to a 60:40 ratio of enantiomers).

The compositions of this invention may have at least a 50% enantiomeric excess; at least a 75% enantiomeric excess; at least a 90% enantiomeric excess; or at least a 94% enantiomeric excess of the more active isomer.

Compounds of this invention can exist as one or more conformational isomers due to restricted rotation about an amide bond (e.g., C(═O)—N) in the recited formulae (or recited chemical name). This invention comprises mixtures of conformational isomers. In addition, this invention includes compounds that are enriched in one conformer relative to others.

This invention comprises all stereoisomers, conformational isomers and mixtures thereof in all proportions as well as isotopic forms such as deuterated compounds.

One skilled in the art will appreciate that not all nitrogen containing heterocycles can form N-oxides since the nitrogen requires an available lone pair for oxidation to the oxide; one skilled in the art will recognize those nitrogen-containing heterocycles which can form N-oxides. One skilled in the art will also recognize that tertiary amines can form N-oxides. Synthetic methods for the preparation of N-oxides of heterocycles and tertiary amines are very well known by one skilled in the art including the oxidation of heterocycles and tertiary amines with peroxy acids such as peracetic and m-chloroperbenzoic acid (MCPBA), hydrogen peroxide, alkyl hydroperoxides such as t-butyl hydroperoxide, sodium perborate, and dioxiranes such as dimethyldioxirane. These methods for the preparation of N-oxides have been extensively described and reviewed in the literature, see for example: T. L. Gilchrist in Comprehensive Organic Synthesis, vol. 7, pp 748-750, S. V. Ley, Ed., Pergamon Press; M. Tisler and B. Stanovnik in Comprehensive Heterocyclic Chemistry, vol. 3, pp 18-20, A. J. Boulton and A. McKillop, Eds., Pergamon Press; M. R. Grimmett and B. R. T. Keene in Advances in Heterocyclic Chemistry, vol. 43, pp 149-161, A. R. Katritzky, Ed., Academic Press; M. Tisler and B. Stanovnik in Advances in Heterocyclic Chemistry, vol. 9, pp 285-291, A. R. Katritzky and A. J. Boulton, Eds., Academic Press; and G. W. H. Cheeseman and E. S. G. Werstiuk in Advances in Heterocyclic Chemistry, vol. 22, pp 390-392, A. R. Katritzky and A. J. Boulton, Eds., Academic Press.

One skilled in the art recognizes that because in the environment and under physiological conditions salts of chemical compounds are in equilibrium with their corresponding nonsalt forms, salts share the biological utility of the nonsalt forms. Thus a wide variety of salts of the compounds of the recited formulae (or recited chemical name) are useful for control of plant diseases caused by fungal plant pathogens (i.e. are agriculturally suitable). The salts of the compounds of the recited formulae include acid-addition salts with inorganic or organic acids such as hydrobromic, hydrochloric, nitric, phosphoric, sulfuric, acetic, butyric, fumaric, lactic, maleic, malonic, oxalic, propionic, -salicylic, tartaric, 4-toluenesulfonic or valeric acids. When a compound of the recited formulae contains an acidic moiety such as a carboxylic acid, salts also include those formed with organic or inorganic bases such as pyridine, triethylamine or ammonia, or amides, hydrides, hydroxides or carbonates of sodium, potassium, lithium, calcium, magnesium or barium. Accordingly, the present invention comprises compounds selected from the recited formulae, N-oxides, and agriculturally suitable salts, and solvates thereof.

Compounds selected from the recited formulae, stereoisomers, tautomers, N-oxides, and salts thereof, typically exist in more than one form, and the recited formulae thus includes all crystalline and non-crystalline forms of the compounds that the recited formulae represents. Non-crystalline forms include embodiments which are solids such as waxes and gums as well as embodiments which are liquids such as solutions and melts. Crystalline forms include embodiments which represent essentially a single crystal type and embodiments which represent a mixture of polymorphs (i.e. different crystalline types). The term “polymorph” refers to a particular crystalline form of a chemical compound that can crystallize in different crystalline forms, these forms having different arrangements and/or conformations of the molecules in the crystal lattice. Although polymorphs can have the same chemical composition, they can also differ in composition due to the presence or absence of co-crystallized water or other molecules, which can be weakly or strongly bound in the lattice. Polymorphs can differ in such chemical, physical and biological properties as crystal shape, density, hardness, color, chemical stability, melting point, hygroscopicity, suspensibility, dissolution rate and biological availability. One skilled in the art will appreciate that a polymorph of a compound represented by the recited formulae can exhibit beneficial effects (e.g., suitability for preparation of useful formulations, improved biological performance) relative to another polymorph or a mixture of polymorphs of the same compound represented by the recited formulae. Preparation and isolation of a particular polymorph of a compound represented by the recited formulae can be achieved by methods known to those skilled in the art including, for example, crystallization using selected solvents and temperatures. For a comprehensive discussion of polymorphism see R. Hilfiker, Ed., Polymorphism in the Pharmaceutical Industry, Wiley-VCH, Weinheim, 2006.

As described in the Summary of the Invention, an aspect of the present invention is directed at a composition comprising: (a1) a succinate dehydrogenase inhibitor (SDHI); and (a2) a picolinamide, and at least one component (b). More particularly, the at least one component (b) is selected from the group consisting of
(b1) methyl benzimidazole carbamate (MBC) fungicides;
(b2) dicarboximide fungicides;
(b3) demethylation inhibitor (DMI) fungicides;
(b4) phenylamide (PA) fungicides;
(b5) amine/morpholine fungicides;
(b6) phospholipid biosynthesis inhibitor fungicides;
(b7) additional succinate dehydrogenase inhibitor (SDHI) fungicides;
(b8) hydroxy(2-amino)pyrimidine fungicides;
(b9) anilinopyrimidine (AP) fungicides;
(b10) N-phenyl carbamate fungicides;
(b11) quinone outside inhibitor (QoI) fungicides;
(b12) phenylpyrrole (PP) fungicides;
(b13) azanaphthalene fungicides;
(b14) cell peroxidation inhibitor fungicides;
(b15) melanin biosynthesis inhibitor-reductase (MBI-R) fungicides;
(b16a) melanin biosynthesis inhibitor-dehydratase (MBI-D) fungicides;
(b16b) melanin biosynthesis inhibitor-polyketide synthase (MBI-P) fungicides;
(b17) keto reductase inhibitor (KRI) fungicides;
(b18) squalene-epoxidase inhibitor fungicides;
(b19) polyoxin fungicides;
(b20) phenylurea fungicides;
(b21) quinone inside inhibitor (QiI) fungicides;
(b22) benzamide and thiazole carboxamide fungicides;
(b23) enopyranuronic acid antibiotic fungicides;
(b24) hexopyranosyl antibiotic fungicides;
(b25) glucopyranosyl antibiotic: protein synthesis fungicides;
(b26) glucopyranosyl antibiotic fungicides;
(b27) cyanoacetamide-oxime fungicides;
(b28) carbamate fungicides;
(b29) oxidative phosphorylation uncoupling fungicides;
(b30) organo tin fungicides;
(b31) carboxylic acid fungicides;
(b32) heteroaromatic fungicides;
(b33) phosphonate fungicides;
(b34) phthalamic acid fungicides;
(b35) benzotriazine fungicides;
(b36) benzene-sulfonamide fungicides;
(b37) pyridazinone fungicides;
(b38) thiophene-carboxamide fungicides;
(b39) complex I NADH oxidoreductase inhibitor fungicides;
(b40) carboxylic acid amide (CAA) fungicides;
(b41) tetracycline antibiotic fungicides;
(b42) thiocarbamate fungicides;
(b43) benzamide fungicides;
(b44) microbial fungicides;
(b45) quinone outside inhibitor, stigmatellin binding (QoSI) fungicides;
(b46) plant extract fungicides;
(b47) cyanoacrylate fungicides;
(b48) polyene fungicides;
(b49) oxysterol binding protein inhibitor (OSBPI) fungicides;
(b50) aryl-phenyl-ketone fungicides;
(b51) host plant defense induction fungicides;
(b52) multi-site activity fungicides;
(b53) biologicals with multiple modes of action;
(b54) fungicides other than fungicides of component (a1) and component (a2) and components (b1) through (b53); and
salts of compounds of (b1) through (b54).

Of note are embodiments wherein component (b) comprises at least one fungicidal compound from each of two different groups selected from (b1) through (b54).

“Methyl benzimidazole carbamate (MBC) fungicides (b1)” (FRAC code 1) inhibit mitosis by binding to β-tubulin during microtubule assembly. Inhibition of microtubule assembly can disrupt cell division, transport within the cell and cell structure. Methyl benzimidazole carbamate fungicides include benzimidazole and thiophanate fungicides. The benzimidazoles include benomyl, carbendazim, fuberidazole and thiabendazole. The thiophanates include thiophanate and thiophanate-methyl.

“Dicarboximide fungicides (b2)” (FRAC code 2) inhibit a mitogen-activated protein (MAP)/histidine kinase in osmotic signal transduction. Examples include chlozolinate, dimethachlone, iprodione, procymidone and vinclozolin.

“Demethylation inhibitor (DMI) fungicides (b3)” (FRAC code 3) (Sterol Biosynthesis Inhibitors (SBI): Class I) inhibit C14-demethylase, which plays a role in sterol production. Sterols, such as ergosterol, are needed for membrane structure and function, making them essential for the development of functional cell walls. Therefore, exposure to these fungicides results in abnormal growth and eventually death of sensitive fungi. DMI fungicides are divided between several chemical classes: piperazines, pyridines, pyrimidines, imidazoles, triazoles and triazolinthiones. The piperazines include triforine. The pyridines include buthiobate, pyrifenox, pyrisoxazole and (αS)-[3-(4-chloro-2-fluorophenyl)-5-(2,4-difluorophenyl)-4-isoxazolyl]-3-pyridinemethanol. The pyrimidines include fenarimol, nuarimol and triarimol. The imidazoles include econazole, imazalil, oxpoconazole, pefurazoate, prochloraz and triflumizole. The triazoles include azaconazole, bitertanol, bromuconazole, cyproconazole, difenoconazole, diniconazole (including diniconazole-M), epoxiconazole, etaconazole, fenbuconazole, fluquinconazole, flusilazole, flutriafol, hexaconazole, imibenconazole, ipconazole, ipfentrifluconazole, mefentrifluconazole, metconazole, myclobutanil, penconazole, propiconazole, quinconazole, simeconazole, tebuconazole, tetraconazole, triadimefon, triadimenol, triticonazole, uniconazole, uniconazole-P, α-(1-chlorocyclopropyl)-α-[2-(2,2-dichlorocyclopropyl)ethyl]-1H-1,2,4-triazole-1-ethanol, rel-1-[[(2R,3S)-3-(2-chlorophenyl)-2-(2,4-difluorophenyl)-2-oxiranyl]methyl]-1H-1,2,4-triazole, rel-2-[[(2R,3S)-3-(2-chlorophenyl)-2-(2,4-difluorophenyl)-2-oxiranyl]methyl]-1,2-dihydro-3H-1,2,4-triazole-3-thione and rel-1-[[(2R,3S)-3-(2-chlorophenyl)-2-(2,4-difluorophenyl)-2-oxiranyl]methyl]-5-(2-propen-1-ylthio)-1H-1,2,4-triazole. The triazolinthiones include prothioconazole. Biochemical investigations have shown that all of the above mentioned fungicides are DMI fungicides as described by K. H. Kuck et al. in Modern Selective Fungicides—Properties, Applications and Mechanisms of Action, H. Lyr (Ed.), Gustav Fischer Verlag: New York, 1995, 205-258.

“Phenylamide (PA) fungicides (b4)” (FRAC code 4) are specific inhibitors of RNA polymerase in Oomycete fungi. Sensitive fungi exposed to these fungicides show a reduced capacity to incorporate uridine into rRNA. Growth and development in sensitive fungi is prevented by exposure to this class of fungicide. Phenylamide fungicides include acylalanine, oxazolidinone and butyrolactone fungicides. The acylalanines include benalaxyl, benalaxyl-M (also known as kiralaxyl), furalaxyl, metalaxyl and metalaxyl-M (also known as mefenoxam). The oxazolidinones include oxadixyl. The butyrolactones include ofurace.

“Amine/morpholine fungicides (b5)” (FRAC code 5) (SBI: Class II) inhibit two target sites within the sterol biosynthetic pathway, Δ⁸→Δ⁷ isomerase and Δ¹⁴ reductase. Sterols, such as ergosterol, are needed for membrane structure and function, making them essential for the development of functional cell walls. Therefore, exposure to these fungicides results in abnormal growth and eventually death of sensitive fungi. Amine/morpholine fungicides (also known as non-DMI sterol biosynthesis inhibitors) include morpholine, piperidine and spiroketal-amine fungicides. The morpholines include aldimorph, dodemorph, fenpropimorph, tridemorph and trimorphamide. The piperidines include fenpropidin and piperalin. The spiroketal-amines include spiroxamine.

“Phospholipid biosynthesis inhibitor fungicides (b6)” (FRAC code 6) inhibit growth of fungi by affecting phospholipid biosynthesis. Phospholipid biosynthesis fungicides include phosphorothiolates and dithiolane fungicides. The phosphorothiolates include edifenphos, iprobenfos and pyrazophos. The dithiolanes include isoprothiolane.

“Succinate dehydrogenase inhibitor (SDHI) fungicides (b7)” (FRAC code 7) inhibit complex II fungal respiration by disrupting a key enzyme in the Krebs Cycle (TCA cycle) named succinate dehydrogenase. Inhibiting respiration prevents the fungus from making ATP, and thus inhibits growth and reproduction. SDHI fungicides include phenylbenzamide, phenyl-oxo-ethyl thiophene amide, pyridinyl-ethyl-benzamides, furan carboxamide, oxathiin carboxamide, thiazole carboxamide, pyrazole-4-carboxamide, N-cyclopropyl-N-benzyl-pyrazole carboxamide, N-methoxy(phenylethyl)pyrazole carboxamide, pyridine carboxamide and pyrazine carboxamide fungicides. The phenylbenzamides include benodanil, flutolanil and mepronil. The phenyl-oxo-ethyl thiophene amides include isofetamid. The pyridinyl-ethyl-benzamides include fluopyram. The furan carboxamides include fenfuram. The oxathiin carboxamides include carboxin and oxycarboxin. The thiazole carboxamides include thifluzamide. The pyrazole-4-carboxamides include benzovindiflupyr, bixafen, flubeneteram (provisional common name, Registry Number 1676101-39-5), fluindapyr, fluxapyroxad, furametpyr, inpyrfluxam, isopyrazam, penflufen, penthiopyrad, pyrapropoyne (provisional common name, Registry Number 1803108-03-3), sedaxane and N-[2-(2,4-dichlorophenyl)-2-methoxy-1-methylethyl]-3-(difluoromethyl)-1-methyl-1H-pyrazole-4-carboxamide. The N-cyclopropyl-N-benzyl-pyrazole carboxamides include isoflucypram. The N-methoxy(phenylethyl)pyrazole carboxamides include pydiflumetofen. The pyridine carboxamides include boscalid. The pyrazine carboxamides include pyraziflumid.

“Hydroxy(2-amino)pyrimidine fungicides (b8)” (FRAC code 8) inhibit nucleic acid synthesis by interfering with adenosine deaminase. Examples include bupirimate, dimethirimol and ethirimol.

“Anilinopyrimidine (AP) fungicides (b9)” (FRAC code 9) are proposed to inhibit biosynthesis of the amino acid methionine and to disrupt the secretion of hydrolytic enzymes that lyse plant cells during infection. Examples include cyprodinil, mepanipyrim and pyrimethanil.

“N-Phenyl carbamate fungicides (b10)” (FRAC code 10) inhibit mitosis by binding to β-tubulin and disrupting microtubule assembly. Inhibition of microtubule assembly can disrupt cell division, transport within the cell and cell structure. Examples include diethofencarb.

“Quinone outside inhibitor (QoI) fungicides (b11)” (FRAC code 11) inhibit complex III mitochondrial respiration in fungi by affecting ubiquinol oxidase. Oxidation of ubiquinol is blocked at the “quinone outside” (Qo) site of the cytochrome bc₁ complex, which is located in the inner mitochondrial membrane of fungi. Inhibiting mitochondrial respiration prevents normal fungal growth and development. Quinone outside inhibitor fungicides include methoxyacrylate, methoxyacetamide, methoxycarbamate, oximinoacetate, oximinoacetamide and dihydrodioxazine fungicides (collectively also known as strobilurin fungicides), oxazolidinedione, imidazolinone, benzyl-carbamate and tetrazolinones (subgroup A) fungicides. The methoxyacrylates include azoxystrobin, coumoxystrobin, enoxastrobin (also known as enestroburin), flufenoxystrobin, picoxystrobin and pyraoxystrobin. The methoxyacetamides include mandestrobin. The methoxy-carbamates include pyraclostrobin, pyrametostrobin and triclopyricarb. The oximino-acetates include kresoxim-methyl and trifloxystrobin. The oximino-acetamides include dimoxystrobin, fenaminstrobin, metominostrobin and orysastrobin. The dihydrodioxazines include fluoxastrobin. The oxazolidinediones include famoxadone. The imidazolinones include fenamidone. The benzyl-carbamates include pyribencarb. The tetrazolinones include metyltetraprole.

“Phenylpyrrole (PP) fungicides (b12)” (FRAC code 12) inhibit a MAP/histidine kinase associated with osmotic signal transduction in fungi. Fenpiclonil and fludioxonil are examples of this fungicide class.

“Azanaphthalene fungicides (b13)” (FRAC code 13) are proposed to inhibit signal transduction by a mechanism which is as yet unknown. They have been shown to interfere with germination and/or appressorium formation in fungi that cause powdery mildew diseases. Azanaphthalene fungicides include aryloxyquinolines and quinazolinones. The aryloxyquinolines include quinoxyfen. The quinazolinones include proquinazid.

“Cell peroxidation inhibitor fungicides (b14)” (FRAC code 14) are proposed to inhibit lipid peroxidation which affects membrane synthesis in fungi. Members of this class, such as etridiazole, may also affect other biological processes such as respiration and melanin biosynthesis. Cell peroxidation fungicides include aromatic hydrocarbon and 1,2,4-thiadiazole fungicides. The aromatic hydrocarbon fungicides include biphenyl, chloroneb, dicloran, quintozene, tecnazene and tolclofos-methyl. The 1,2,4-thiadiazoles include etridiazole.

“Melanin biosynthesis inhibitor-reductase (MBI-R) fungicides (b15)” (FRAC code 16.1) inhibit the naphthal reduction step in melanin biosynthesis. Melanin is required for host plant infection by some fungi. Melanin biosynthesis inhibitor-reductase fungicides include isobenzofuranone, pyrroloquinolinone and triazolobenzothiazole fungicides. The isobenzofuranones include fthalide. The pyrroloquinolinones include pyroquilon. The triazolobenzothiazoles include tricyclazole.

“Melanin biosynthesis inhibitor-dehydratase (MBI-D) fungicides (b16a)” (FRAC code 16.2) inhibit scytalone dehydratase in melanin biosynthesis. Melanin is required for host plant infection by some fungi. Melanin biosynthesis inhibitor-dehydratase fungicides include cyclopropanecarboxamide, carboxamide and propionamide fungicides. The cyclopropanecarboxamides include carpropamid. The carboxamides include diclocymet. The propionamides include fenoxanil.

“Melanin biosynthesis inhibitor-polyketide synthase (MBI-P) fungicides (b16b)” (FRAC code 16.3) inhibit polyketide synthase in melanin biosynthesis. Melanin is required for host plant infection by some fungi. Melanin biosynthesis inhibitor-polyketide synthase fungicides include trifluoroethylcarbamate fungicides. The trifluoroethylcarbamates include tolprocarb.

“Keto reductase inhibitor (KRI) fungicides (b17)” (FRAC code 17) inhibit 3-keto reductase during C4-demethylation in sterol production. Keto reductase inhibitor fungicides (also known as Sterol Biosynthesis Inhibitors (SBI): Class III) include hydroxyanilides and amino-pyrazolinones. Hydroxyanilides include fenhexamid. Amino-pyrazolinones include fenpyrazamine. Additionally, Quinofumelin (provisional common name, Registry Number 861647-84-9) and ipflufenoquin (provisional common name, Registry Number 1314008-27-9) are believed to be keto reductase inhibitor fungicides.

“Squalene-epoxidase inhibitor fungicides (b18)” (FRAC code 18) (SBI: Class IV) inhibit squalene-epoxidase in the sterol biosynthesis pathway. Sterols such as ergosterol are needed for membrane structure and function, making them essential for the development of functional cell walls. Therefore exposure to these fungicides results in abnormal growth and eventually death of sensitive fungi. Squalene-epoxidase inhibitor fungicides include thiocarbamate and allylamine fungicides. The thiocarbamates include pyributicarb. The allylamines include naftifine and terbinafine.

“Polyoxin fungicides (b19)” (FRAC code 19) inhibit chitin synthase. Examples include polyoxin.

“Phenylurea fungicides (b20)” (FRAC code 20) are proposed to affect cell division. Examples include pencycuron.

“Quinone inside inhibitor (QiI) fungicides (b21)” (FRAC code 21) inhibit complex III mitochondrial respiration in fungi by affecting ubiquinone reductase. Reduction of ubiquinone is blocked at the “quinone inside” (Qi) site of the cytochrome bc₁ complex, which is located in the inner mitochondrial membrane of fungi. Inhibiting mitochondrial respiration prevents normal fungal growth and development. Quinone inside inhibitor fungicides include cyanoimidazole, sulfamoyl-triazole and picolinamide fungicides. The cyanoimidazoles include cyazofamid. The sulfamoyl-triazoles include amisulbrom. The picolinamides include fenpicoxamid, florylpicoxamid and metarylpicoxamid.

“Benzamide and thiazole carboxamide fungicides (b22)” (FRAC code 22) inhibit mitosis by binding to β-tubulin and disrupting microtubule assembly. Inhibition of microtubule assembly can disrupt cell division, transport within the cell and cell structure. The benzamides include toluamides such as zoxamide. The thiazole carboxamides include ethylamino-thiazole carboxamides such as ethaboxam.

“Enopyranuronic acid antibiotic fungicides (b23)” (FRAC code 23) inhibit growth of fungi by affecting protein biosynthesis. Examples include blasticidin-S.

“Hexopyranosyl antibiotic fungicides (b24)” (FRAC code 24) inhibit growth of fungi by affecting protein biosynthesis. Examples include kasugamycin.

“Glucopyranosyl antibiotic: protein synthesis fungicides (b25)” (FRAC code 25) inhibit growth of fungi by affecting protein biosynthesis. Examples include streptomycin.

“Glucopyranosyl antibiotic fungicides (b26)” (FRAC code U18, previously FRAC code 26 reclassified to U18) are proposed to inhibit trehalase and inositol biosynthesis. Examples include validamycin.

“Cyanoacetamide-oxime fungicides (b27)” (FRAC code 27) include cymoxanil.

“Carbamate fungicides (b28)” (FRAC code 28) are considered multi-site inhibitors of fungal growth. They are proposed to interfere with the synthesis of fatty acids in cell membranes, which then disrupts cell membrane permeability. Iodocarb, propamocarb and prothiocarb are examples of this fungicide class.

“Oxidative phosphorylation uncoupling fungicides (b29)” (FRAC code 29) inhibit fungal respiration by uncoupling oxidative phosphorylation. Inhibiting respiration prevents normal fungal growth and development. This class includes dinitrophenyl crotonates such as binapacryl, meptyldinocap and dinocap, and 2,6-dinitroanilines such as fluazinam.

“Organo tin fungicides (b30)” (FRAC code 30) inhibit adenosine triphosphate (ATP) synthase in oxidative phosphorylation pathway. Examples include fentin acetate, fentin chloride and fentin hydroxide.

“Carboxylic acid fungicides (b31)” (FRAC code 31) inhibit growth of fungi by affecting deoxyribonucleic acid (DNA) topoisomerase type II (gyrase). Examples include oxolinic acid.

“Heteroaromatic fungicides (b32)” (FRAC code 32) are proposed to affect DNA/ribonucleic acid (RNA) synthesis. Heteroaromatic fungicides include isoxazoles and isothiazolones. The isoxazoles include hymexazole and the isothiazolones include octhilinone.

“Phosphonate fungicides (b33)” (FRAC code P07, previously FRAC code 33 reclassified to P07) include phosphorous acid and its various salts, including fosetyl-aluminum.

“Phthalamic acid fungicides (b34)” (FRAC code 34) include tecloftalam.

“Benzotriazine fungicides (b35)” (FRAC code 35) include triazoxide.

“Benzene-sulfonamide fungicides (b36)” (FRAC code 36) include flusulfamide.

“Pyridazinone fungicides (b37)” (FRAC code 37) include diclomezine.

“Thiophene-carboxamide fungicides (b38)” (FRAC code 38) are proposed to affect ATP production. Examples include silthiofam.

“Complex I NADH oxidoreductase inhibitor fungicides (b39)” (FRAC code 39) inhibit electron transport in mitochondria and include pyrimidinamines such as diflumetorim, pyrazole-5-carboxamides such as tolfenpyrad, and quinazoline such as fenazaquin.

“Carboxylic acid amide (CAA) fungicides (b40)” (FRAC code 40) inhibit cellulose synthase which prevents growth and leads to death of the target fungus. Carboxylic acid amide fungicides include cinnamic acid amide, valinamide carbamate and mandelic acid amide fungicides. The cinnamic acid amides include dimethomorph, flumorph and pyrimorph. The valinamide carbamates include benthiavalicarb, benthiavalicarb-isopropyl, iprovalicarb, tolprocarb and valifenalate (also known as valiphenal). The mandelic acid amides include mandipropamid, N-[2-[4-[[3-(4-chlorophenyl)-2-propyn-1-yl]oxy]-3-methoxyphenyl]ethyl]-3-methyl-2-[(methylsulfonyl)amino]butanamide and N-[2-[4-[[3-(4-chlorophenyl)-2-propyn-1-yl]oxy]-3-methoxyphenyl]ethyl]-3-methyl-2-[(ethylsulfonyl)amino]butanamide.

“Tetracycline antibiotic fungicides (b41)” (FRAC code 41) inhibit growth of fungi by affecting protein synthesis. Examples include oxytetracycline.

“Thiocarbamate fungicides (b42)” (FRAC code M12, previously FRAC code 42 reclassified to M12) include methasulfocarb.

“Benzamide fungicides (b43)” (FRAC code 43) inhibit growth of fungi by delocalization of spectrin-like proteins. Examples include pyridinylmethyl benzamides such as fluopicolide and fluopimomide.

“Microbial fungicides (b44)” (FRAC code BM02, previously FRAC code 44 reclassified to BM02) disrupt fungal pathogen cell membranes. Microbial fungicides include Bacillus species such as Bacillus amyloliquefaciens strains AP-136, AP-188, AP-218, AP-219, AP-295, QST713, FZB24, F727, MB1600, D747, FCC1256 (deposited as ATCC No. PTA-122162, disclosed in PCT/US2019/053424), TJ100 (also called strain 1 BE; known from EP2962568), and the fungicidal lipopeptides which they produce.

“Quinone outside inhibitor, stigmatellin binding (QoSI) fungicides (b45)” (FRAC code 45) inhibit complex III mitochondrial respiration in fungi by affecting ubiquinone reductase at the “quinone outside” (Qo) site, stigmatellin binding sub-site, of the cytochrome bc₁ complex. Inhibiting mitochondrial respiration prevents normal fungal growth and development. QoSI fungicides include triazolo-pyrimidylamines such as ametoctradin.

“Plant extract fungicides (b46)” (FRAC code 46) cause cell membrane disruption. Plant extract fungicides include terpene hydrocarbons, terpene alcohols and terpen phenols such as the extract from Melaleuca alternifolia (tea tree) and plant oils (mixtures) such as eugenol, geraniol and thymol.

“Cyanoacrylate fungicides (b47)” (FRAC code 47) bind to the myosin motor domain and effect motor activity and actin assembly. Cyanoacrylates include fungicides such as phenamacril.

“Polyene fungicides (b48)” (FRAC code 48) cause disruption of the fungal cell membrane by binding to ergosterol, the main sterol in the membrane. Examples include natamycin (pimaricin).

“Oxysterol binding protein inhibitor (OSBPI) Fungicides (b49)” (FRAC code 49) bind to the oxysterol-binding protein in oomycetes causing inhibition of zoospore release, zoospore motility and sporangia germination. Oxysterol binding fungicides include piperidinyl-thiazole-isoxazolines such as oxathiapiprolin and fluoxapiprolin.

“Aryl-phenyl-ketone fungicides (b50)” (FRAC code 50, previously FRAC code U8 reclassified to 50) inhibit the growth of mycelium in fungi. Aryl-phenyl ketone fungicides include benzophenones such as metrafenone, and benzoylpyridines such as pyriofenone.

“Host plant defense induction fungicides (b51)” induce host plant defense mechanisms. Host plant defense induction fungicides include benzothiadiazole (FRAC code P01), benzisothiazole (FRAC code P02), thiadiazole carboxamide (FRAC code P03), polysaccharide (FRAC code P04), plant extract (FRAC code P05), microbial (FRAC code P06) and phosphonate fungicides (FRAC code P07, see (b33) above). The benzothiadiazoles include acibenzolar-S-methyl. The benzisothiazoles include probenazole. The thiadiazole carboxamides include tiadinil and isotianil. The polysaccharides include laminarin. The plant extracts include extract from Reynoutria sachalinensis (giant knotweed). The microbials include Bacillus mycoides isolate J and cell walls of Saccharomyces cerevisiae strain LAS 117.

“Multi-site activity fungicides (b52)” inhibit fungal growth through multiple sites of action and have contact/preventive activity. Multi-site activity fungicides include copper fungicides (FRAC code M01), sulfur fungicides (FRAC code M02), dithiocarbamate fungicides (FRAC code M03), phthalimide fungicides (FRAC code M04), chloronitrile fungicides (FRAC code M05), sulfamide fungicides (FRAC code M06), multi-site contact guanidine fungicides (FRAC code M07), triazine fungicides (FRAC code M08), quinone fungicides (FRAC code M09), quinoxaline fungicides (FRAC code M10), maleimide fungicides (FRAC code M11) and thiocarbamate (FRAC code M12, see (b42) above) fungicides. Copper fungicides are inorganic compounds containing copper, typically in the copper(II) oxidation state; examples include copper oxychloride, copper sulfate and copper hydroxide, including compositions such as Bordeaux mixture (tribasic copper sulfate). Sulfur fungicides are inorganic chemicals containing rings or chains of sulfur atoms; examples include elemental sulfur. Dithiocarbamate fungicides contain a dithiocarbamate molecular moiety; examples include ferbam, mancozeb, maneb, metiram, propineb, thiram, zinc thiazole, zineb and ziram. Phthalimide fungicides contain a phthalimide molecular moiety; examples include folpet, captan and captafol. Chloronitrile fungicides contain an aromatic ring substituted with chloro and cyano; examples include chlorothalonil. Sulfamide fungicides include dichlofluanid and tolyfluanid. Multi-site contact guanidine fungicides include, guazatine, iminoctadine albesilate and iminoctadine triacetate. Triazine fungicides include anilazine. Quinone fungicides include dithianon. Quinoxaline fungicides include quinomethionate (also known as chinomethionate). Maleimide fungicides include fluoroimide.

“Biologicals with multiple modes of action (b53)” include agents from biological origins showing multiple mechanisms of action without evidence of a dominating mode of action. This class of fungicides includes polypeptide (lectin), phenol, sesquiterpene, tritepenoid and coumarin fungicides (FRAC code BM01) such as extract from the cotyledons of lupine plantlets. This class also includes microbial fungicides (FRAC code BM02, see (b44) above).

“Fungicides other than fungicides of component (a1) and component (a2) and components (b1) through (b53); (b54)”; include certain fungicides whose mode of action may be unknown. These include: (b54.1) “phenyl-acetamide fungicides” (FRAC code U06), (b54.2) “guanidine fungicides” (FRAC code U12), (b54.3) “thiazolidine fungicides” (FRAC code U13), (b54.4) “pyrimidinone-hydrazone fungicides” (FRAC code U14), (b54.5) “4-quinolylacetate fungicides” (FRAC code U16), (54.6) “tetrazolyloxime fungicides” (FRAC code U17) and “glucopyranosyl antibiotic fungicides” (FRAC code U18, see (b26) above). The phenyl-acetamides include cyflufenamid. The guanidines include dodine. The thiazolidines include flutianil. The pyrimidinone-hydrazones include ferimzone. The 4-quinolylacetates include tebufloquin. The tetrazolyloximes include picarbutrazox.

The (b54) class also includes bethoxazin, dichlobentiazox (provisional common name, Registry Number 957144-77-3), dipymetitrone (provisional common name, Registry Number 16114-35-5), flometoquin, neo-asozin (ferric methanearsonate), pyrrolnitrin, tolnifanide (Registry Number 304911-98-6), N-[4-[4-chloro-3-(trifluoromethyl)phenoxy]-2,5-dimethylphenyl]-N-ethyl-N-methylmethanimidamide, 5-fluoro-2-[(4-fluorophenyl)methoxy]-4-pyrimidinamine and 4-fluorophenyl N-[1-[[[1-(4-cyanophenyl)ethyl]sulfonyl]methyl]propyl]carbamate, N-[5-bromo-2-methyl-6-(1-methyl-2-propoxyethoxy)-3-pyridinyl]-N-ethyl-N-methyl-methanimidamide, N′-[5-bromo-2-methyl-6-[(1R)-1-methyl-2-propoxyethoxy]-3-pyridinyl]-N-ethyl-N-methyl-methanimidamide, and N-[5-bromo-2-methyl-6-[(1S)-1-methyl-2-propoxyethoxy]-3-pyridinyl]-N-ethyl-N-methyl-methanimidamide.

Additional “Fungicides other than fungicides of classes (1) through (54)” whose mode of action may be unknown, or may not yet be classified include a fungicidal compound selected from components (b54.8) through (b54.14), as discussed below.

Component (54.9) relates to 3-chloro-4-(2,6-difluorophenyl)-6-methyl-5-phenylpyridazine (provisional common name pyridachlometyl, Registry Number 1358061-55-8), which is believed to be promoter tubulin polymerization, resulting antifungal activity against fungal species belonging to the phyla Ascomycota and Basidiomycota.

Component (54.10) relates to aminopyrifen (provisional common name) (Registry Number 1531626-08-0, CAS name 4-phenoxyphenyl)methyl 2-amino-6-methyl-pyridine-3-carboxylate) which is believed to inhibit GWT-1 protein in glycosylphosphatidylinositol-anchor biosynthesis in Neurospora crassa.

Component (b54.11) relates a compound of Formula b54.11

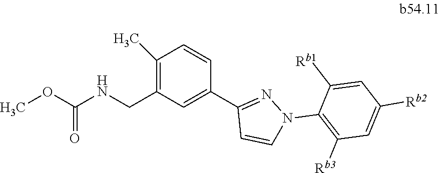

wherein
R^{b1} and R^{b3} are each independently halogen; and
R^{b2} is H, halogen, C₁-C₃ alkyl, C₁-C₃ haloalkyl or C₃-C₆ cycloalkyl.

Examples of compounds of Formula b54.11 include (b54.11a) methyl N-[[5-[1-(2,6-difluoro-4-formylphenyl)-1H-pyrazol-3-yl]-2-methylphenyl]methyl]carbamate, (b54.11b) methyl N-[[5-[1-(4-cyclopropyl-2,6-dichlorophenyl)-1H-pyrazol-3-yl]-2-methylphenyl]methyl]carbamate, (b54.11c) methyl N-[[5-[1-(4-chloro-2,6-difluorophenyl)-1H-pyrazol-3-yl]-2-methylphenyl]-methyl]carbamate, (b54.11d) methyl N-[[5-[1-(4-cyclopropyl-2,6-difluorophenyl)-1H-pyrazol-3-yl]-2-methylphenyl]methyl]carbamate, (b54.11e) methyl N-[[5-[1-[2,6-difluoro-4-(1-methylethyl)phenyl]-1H-pyrazol-3-yl]-2-methylphenyl]methyl]carbamate and (b54.11f) methyl N-[[5-[1-[2,6-difluoro-4-(trifluoromethyl)phenyl]-1H-pyrazol-3-yl]-2-methylphenyl]methyl]carbamate. Compounds of Formula b54.11, their use as fungicides and methods of preparation are generally known; see, for example, PCT Patent Publications WO 2008/124092, WO 2014/066120 and WO 2020/097012.

Component (b54.12) relates a compound of Formula b54.12

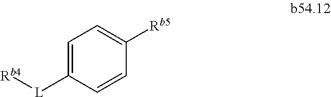

wherein
R^{b4} is

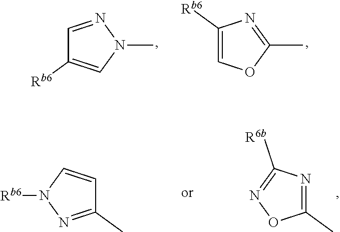

R^{b6} is C₂-C₄ cyanoalkyl, C₂-C₄ alkoxycarbonyl or C₂-C₄ haloalkylaminocarbonyl;
L is CH₂ or CH₂O, wherein the atom to the right is connected to the phenyl ring in Formula b54.12; and
R^{b5} is

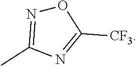

Examples of compounds of Formula b54.12 include (b54.12a) N-(2,2,2-trifluoroethyl)-2-[[4-[5-(trifluoromethyl)-1,2,4-oxadiazol-3-yl]phenyl]methyl]-4-oxazolecarboxamide, (b54.12b) ethyl 1-[[4-[5-(trifluoromethyl)-1,2,4-oxadiazol-3-yl]phenoxy]methyl]-1H-pyrazole-4-carboxylate, (b54.12c) 3-[[4-[5-(trifluoromethyl)-1,2,4-oxadiazol-3-yl]phenyl]methyl]-1H-pyrazole-1-acetonitrile and (b54.12d) N-(2,2,2-trifluoroethyl)-5-[[4-[5-(trifluoromethyl)-1,2,4-oxadiazol-3-yl]phenyl]methyl]-1,2,4-oxadiazole-3-carboxamide. Compounds of Formula b54.12, their use as fungicides and methods of preparation are generally known; see, for example, PCT Patent Publication WO 2020/056090.

Component (b54.13) relates a compound of Formula b54.13

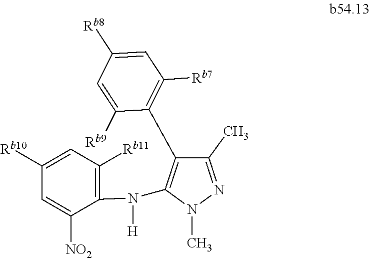

wherein
R^{b7}, R^{b8} and R^{b9} are each independently H, halogen or cyano; and
R^{b10} and R^{b11} are each independently H, halogen, C₁-C₃ alkyl or C₁-C₃ methoxy.

Examples of compounds of Formula b54.13 include (b54.13a) 4-(2-chloro-4-fluorophenyl)-N-(2-fluoro-4-methyl-6-nitrophenyl)-1,3-dimethyl-1H-pyrazol-5-amine, (b54.13b) 4-(2-chloro-4-fluorophenyl)-N-(2-fluoro-6-nitrophenyl)-1,3-dimethyl-1H-pyrazol-5-amine, (b54.13c) 3,5-difluoro-4-[5-[(4-methoxy-2-nitrophenyl)amino]-1,3-dimethyl-1H-pyrazol-4-yl]-benzonitrile, (b54.13d) N-(2-chloro-4-fluoro-6-nitrophenyl)-4-(2-chloro-4-fluorophenyl)-1,3-dimethyl-1H-pyrazol-5-amine, (b54.13e) 4-(2-chloro-4,6-difluorophenyl)-1,3-dimethyl-N-(2-nitrophenyl)-1H-pyrazol-5-amine, and (b54.13f) 4-(2-chloro-4,6-difluorophenyl)-1,3-dimethyl-N-(4-methyl-2-nitrophenyl)-1H-pyrazol-5-amine. Compounds of Formula b54.13, their use as fungicides and methods of preparation are generally known; see, for example, PCT Patent Publication WO 2020051402.

Component (54.14) relates to N-(2-fluorophenyl)-4-[5-(trifluoromethyl)-1,2,4-oxadiazol-3-yl]benzamide (common name flufenoxadiazam, Registry Number 1839120-27-2), which is believed to be a class II histone deacetylases (HDAC) inhibitor.

Embodiments of this disclosure can be combined in any manner provided that the combinations result in obtaining the compositions and methods claimed herein.

Embodiments of the present invention as described in the Summary of the Invention include those described below. In the following Embodiments, the recited formulae include stereoisomers, N-oxides, and salts thereof, and reference to “a compound of Formula r” or “a compound of Formula II” includes the definitions of substituents specified in the Summary of the Invention unless further defined in the Embodiments.
Embodiment A1. The composition described in the Summary of the Invention, wherein the SDHI is selected from:
   (a1-a) phenylbenzamides, benodanil, flutolanil, mepronil, phenyl-oxo-ethyl thiophene amides, isofetamid, fluopyram, furan carboxamides, fenfuram, oxathiin carboxamides, carboxin and oxycarboxin, thiazole carboxamides, thifluzamide, pyrazole-4-carboxamides, benzovindiflupyr, bixafen, flubeneteram, fluindapyr, fluxapyroxad, furametpyr, inpyrfluxam, isopyrazam, penflufen, penthiopyrad, sedaxane, N-[2-(2,4-dichlorophenyl)-2-methoxy-1-methylethyl]-3-(difluoromethyl)-1-methyl-1H-pyrazole-4-carboxamide, N-cyclopropyl-N-benzyl-pyrazole carboxamides, isoflucypram, N-methoxy(phenylethyl)pyrazole carboxamides, pydiflumetofen, pyridine carboxamides, boscalid, pyrazine carboxamide fungicides, and pyraziflumid; and
   (a1-b) aminoindane amides having the structure of formula (I):

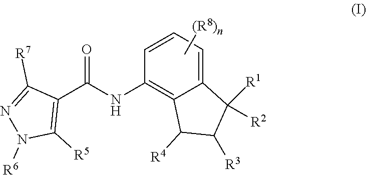

wherein
R¹, R², R³ and R⁴ are each independently H, C₁-C₄ alkyl, C₁-C₄ haloalkyl, C₃-C₆ cycloalkyl or C₃-C₆ halocycloalkyl;
R⁵ and R⁷ are each independently H, C₁-C₄ alkyl or C₁-C₄ haloalkyl;
R⁶ is C₁-C₄ alkyl, C1-C4 haloalkyl, C₃-C₆ cycloalkyl, C₃-C₆ halocycloalkyl, C₁-C₄ alkoxy, C₁-C₄ haloalkoxy, C₁-C₄ alkylthio or C₁-C₄ haloalkylthio;
R⁸ is halo, —OH, —SH, C₁-C₄ alkyl, C₁-C₄ haloalkyl, C₁-C₄ alkoxy, C₁-C₄ haloalkoxy, C₁-C₄ alkylthio or C₁-C₄ haloalkylthio; and
n is 0 to 3, and
(a1-c) combinations thereof.
Embodiment A2. The composition described in Embodiment A1, wherein the SDHI is an aminoindane amide having the structure of formula (I):

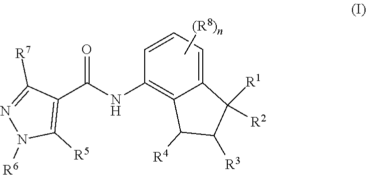

wherein
R¹, R², R³ and R⁴ are each independently H, C₁-C₄ alkyl, C₁-C₄ haloalkyl, C₃-C₆ cycloalkyl or C₃-C₆ halocycloalkyl;
R⁵ and R⁷ are each independently H, C₁-C₄ alkyl or C₁-C₄ haloalkyl;
R⁶ is C₁-C₄ alkyl, C₁-C₄ haloalkyl, C₃-C₆ cycloalkyl, C₃-C₆ halocycloalkyl, C₁-C₄ alkoxy, C₁-C₄ haloalkoxy, C₁-C₄ alkylthio or C₁-C₄ haloalkylthio;
R⁸ is halo, —OH, —SH, C₁-C₄ alkyl, C₁-C₄ haloalkyl, C₁-C₄ alkoxy, C₁-C₄ haloalkoxy, C₁-C₄ alkylthio or C₁-C₄ haloalkylthio; and
n is 0 to 3.
Embodiment A3. The composition described in Embodiment A2, wherein
   R¹, R², R⁴, and R⁶ are each independently C₁-C₄ alkyl;
   R³ is H, C₁-C₄ alkyl or C₁-C₄ haloalkyl;
   R⁵ and R⁷ are each independently H, C₁-C₄ alkyl or C₁-C₄ haloalkyl;
   R⁸ is halo, C₁-C₄ alkyl or C₁-C₄ haloalkyl; and
   n is 0 to 3.
Embodiment A4. The composition described in Embodiment A2, wherein R¹, R², R⁴ and R⁶ are each methyl.
Embodiment A5. The composition described in Embodiment A2, wherein R³ is H.
Embodiment A6. The composition described in Embodiment A2 wherein R⁷ is methyl, difluoromethyl or trifluoromethyl.
Embodiment A7. The composition described in Embodiment A2 wherein R⁵ is H or methyl.
Embodiment A8. The composition described in Embodiment A2 wherein n is 1 to 3.
Embodiment A9. The composition described in Embodiment A2 wherein R⁸ is halo.
Embodiment A10. The composition described in Embodiment A2 wherein R⁸ is F.
Embodiment A11. The composition described in Embodiment A2 wherein the aminoindane amide of formula (I) is

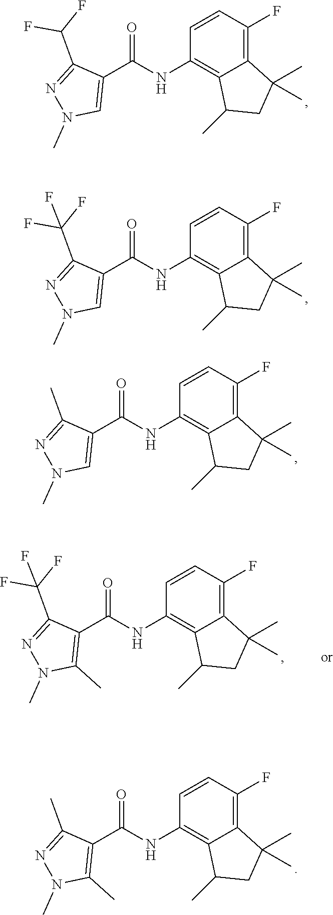

Embodiment A12. The composition described in Embodiments A2 or A11 wherein the aminoindane amide of Formula (I) is (fluindapyr)

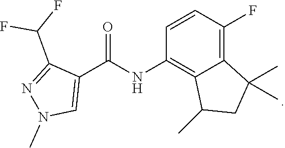 [SMILES: CC1CC(C)(C)c2c(F)ccc(NC(=O)c3cn(C)nc3C(F)F)c21]

Embodiment A13a. The composition described in Embodiment A2 wherein n is 0.
Embodiment A13b. The composition described in Embodiment A2 wherein n is 1.
Embodiment A14a. The composition described in Embodiment A1 wherein the SDHI is selected from phenylbenzamides, benodanil, flutolanil, mepronil, phenyl-oxo-ethyl thiophene amides, isofetamid, pyridinyl-ethyl-benzamides, fluopyram, furan carboxamides, fenfuram, oxathiin carboxamides, carboxin and oxycarboxin, thiazole carboxamides, thifluzamide, pyrazole-4-carboxamides, benzovindiflupyr, bixafen, flubeneteram, fluindapyr, fluxapyroxad, furametpyr, inpyrfluxam, isopyrazam, penflufen, penthiopyrad, sedaxane, N-[2-(2,4-dichlorophenyl)-2-methoxy-1-methylethyl]-3-(difluoromethyl)-1-methyl-1H-pyrazole-4-carboxamide, N-cyclopropyl-N-benzyl-pyrazole carboxamides, isoflucypram, N-methoxy(phenylethyl)pyrazole carboxamides, pydiflumetofen, pyridine carboxamides, boscalid, pyrazine carboxamide fungicides, and pyraziflumid.
Embodiment A14b. The composition described in Embodiment A14a wherein the SDHI is selected from benzovindiflupyr, bixafen, fluindapyr, fluxapyroxad, inpyrfluxam, isoflucypram, pydiflumetofen, and boscalid.
Embodiment A14c. The composition described in Embodiment A14b wherein the SDHI is selected from benzovindiflupyr, bixafen, fluindapyr, fluxapyroxad, and boscalid.
Embodiment A14d. The composition described in Embodiment A14c wherein the SDHI is selected from benzovindiflupyr, fluindapyr, and fluxapyroxad.
Embodiment A15. The composition described in Embodiment A14a wherein the SDHI is selected from phenylbenzamides.
Embodiment A16. The composition described in Embodiment A14a wherein the SDHI is benodanil.
Embodiment A17. The composition described in Embodiment A14a wherein the SDHI is flutolanil.
Embodiment A18. The composition described in Embodiment A14a wherein the SDHI is mepronil.
Embodiment A19. The composition described in Embodiment A14a wherein the SDHI is selected from phenyl-oxo-ethyl thiophene amides.
Embodiment A20. The composition described in Embodiment A14a wherein the SDHI is isofetamid.
Embodiment A21. The composition described in Embodiment A14a wherein the SDHI is selected from pyridinyl-ethyl-benzamides.
Embodiment A22. The composition described in Embodiment A14a wherein the SDHI is fluopyram.
Embodiment A23. The composition described in Embodiment A14a wherein the SDHI is selected from furan carboxamides.
Embodiment A24. The composition described in Embodiment A14a wherein the SDHI is fenfuram.
Embodiment A25. The composition described in Embodiment A14a wherein the SDHI is selected from oxathiin carboxamides.
Embodiment A26. The composition described in Embodiment A14a wherein the SDHI is carboxin.
Embodiment A27. The composition described in Embodiment A14a wherein the SDHI is oxycarboxin.
Embodiment A28. The composition described in Embodiment A14a wherein the SDHI is selected from thiazole carboxamides.
Embodiment A29. The composition described in Embodiment A14a wherein the SDHI is thifluzamide.
Embodiment A30. The composition described in Embodiment A14a wherein the SDHI is selected from pyrazole-4-carboxamides.
Embodiment A31. The composition described in Embodiment A14a wherein the SDHI is benzovindiflupyr.
Embodiment A32. The composition described in Embodiment A14a wherein the SDHI is bixafen.
Embodiment A33. The composition described in Embodiment A14a wherein the SDHI is flubeneteram.
Embodiment A34. The composition described in Embodiment A14a wherein the SDHI is fluindapyr.
Embodiment A35. The composition described in Embodiment A14a wherein the SDHI is fluxapyroxad.
Embodiment A36. The composition described in Embodiment A14a wherein the SDHI is furametpyr.
Embodiment A37. The composition described in Embodiment A14a wherein the SDHI is inpyrfluxam.
Embodiment A38. The composition described in Embodiment A14a wherein the SDHI is isopyrazam.
Embodiment A39. The composition described in Embodiment A14a wherein the SDHI is penflufen.
Embodiment A40. The composition described in Embodiment A14a wherein the SDHI is penthiopyrad.
Embodiment A41. The composition described in Embodiment A14a wherein the SDHI is sedaxane.
Embodiment A42. The composition described in Embodiment A14a wherein the SDHI is N-[2-(2,4-dichlorophenyl)-2-methoxy-1-methylethyl]-3-(difluoromethyl)-1-methyl-1H-pyrazole-4-carboxamide.
Embodiment A43. The composition described in Embodiment A14a wherein the SDHI is selected from N-cyclopropyl-N-benzyl-pyrazole carboxamides.
Embodiment A44. The composition described in Embodiment A14a wherein the SDHI is isoflucypram.
Embodiment A45. The composition described in Embodiment A14a wherein the SDHI is selected from N-methoxy(phenylethyl)pyrazole carboxamides.
Embodiment A46. The composition described in Embodiment A14a wherein the SDHI is pydiflumetofen.
Embodiment A47. The composition described in Embodiment A14a wherein the SDHI is selected from pyridine carboxamides.
Embodiment A48. The composition described in Embodiment A14a wherein the SDHI is boscalid.
Embodiment A49. The composition described in Embodiment A14a wherein the SDHI is selected from pyridine carboxamide fungicides.
Embodiment A50. The composition described in Embodiment A14a wherein the SDHI is pyraziflumid.
Embodiment B1. The composition described in the Summary of the Invention wherein the picolinamide is selected from:
   (a2-a) fenpicoxamid, florylpicoxamid, [(1S,2S)-2-(4-fluoro-2-methyl-phenyl)-1,3-dimethyl-butyl](2S)-2-[(3-acetoxy-4-methoxy-pyridine-2-carbonyl)amino]propanoate, [(1S,2S)-2-(4-fluoro-2-methyl-phenyl)-1,3-dimethyl-butyl](2S)-2-[[3-(acetoxymethoxy)-4-methoxy-pyridine-2-carbonyl]amino]propanoate and [(1S,2S)-2-(4-fluoro-2-methyl-phenyl)-1,3-dimethyl-butyl](2S)-2-[(3-hydroxy-4-methoxy-pyridine-2-carbonyl)amino]propanoate;
   (a2-b) metarylpicoxamid;
   (a2-c) picolinamides having the structure of formula (II):

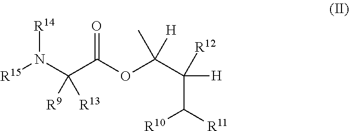

wherein
R⁹ is H or alkyl, substituted with 0, 1 or multiple R¹⁹;
R¹⁰ and R¹¹ are independently selected from C₂-C₆ alkyl, C₃-C₆ cycloalkyl, aryl or heteroaryl, each optionally substituted with 0, 1, or multiple selected from R¹⁹ and R¹⁰ and R¹¹ are taken together to form a 3-6 membered saturated or partially saturated carbocycle or heterocycle, optionally substituted with 0, 1, or multiple R¹⁹;
R¹² is aryl or heteroaryl, each optionally substituted with 0, 1 or multiple R¹⁹;
R¹³ is H or alkyl, each substituted with 0, 1 or multiple R¹⁹;
R¹⁴ is H or C(O)R¹⁶;
R¹⁵ is H, C(O)R¹⁶ or Q;
Q is

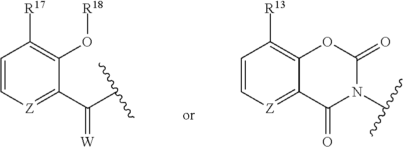

wherein Z is N or N⁺→O⁻ and W is O or S;
R¹⁶ is alkoxy or benzyloxy, each optionally substituted with 0, 1, or multiple R¹⁹;
R¹⁷ is H, alkoxy or halo, each optionally substituted with 0, 1, or multiple R¹⁹;
R¹⁸ is from H, —C(O)R²⁰, or —CH₂OC(O)R²⁰;
R¹⁹ is H, alkyl, aryl, acyl, halo, alkenyl, alkynyl, alkoxy, cyano or heterocyclyl, each optionally substituted with 0, 1, or multiple R²¹;
R²⁰ is alkyl, alkoxy or aryl, each optionally substituted with 0, 1, or multiple R¹⁹; and
R²¹ is H, alkyl, aryl, acyl, halo, alkenyl, alkoxy or heterocyclyl; and
(a2-d) combinations thereof.
Embodiment B2. The composition described in Embodiment B1 wherein the picolinamide is a picolinamide having the structure of formula (II):

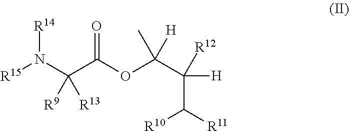

wherein
R⁹ is H or alkyl, substituted with 0, 1, or multiple R¹⁹;
R¹⁰ and R¹¹ are C₂-C₆ alkyl, C₃-C₆ cycloalkyl, aryl or heteroaryl, each optionally substituted with 0, 1 or multiple R¹⁹ or R¹⁰ and R¹¹ are taken together to form a 3-6 membered saturated or partially saturated carbocycle or heterocycle, optionally substituted with 0, 1, or multiple R¹⁹;
R¹² is aryl or heteroaryl, each optionally substituted with 0, 1, or multiple R¹⁹;
R¹³ is H or alkyl, each substituted with 0, 1, or multiple R¹⁹;
R¹⁴ is H or C(O)R¹⁶;
R¹⁵ is H, C(O)R¹⁶ or Q;
Q is

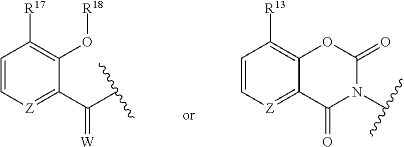

wherein Z is N or N⁺→O⁻ and W is O or S;
R¹⁶ is alkoxy or benzyloxy, each optionally substituted with 0, 1, or multiple R¹⁹;
R¹⁷ is H, alkoxy or halo, each optionally substituted with 0, 1, or multiple R¹⁹;
R¹⁸ is H, —C(O)R²⁰ or —CH₂OC(O)R²⁰;
R¹⁹ is H, alkyl, aryl, acyl, halo, alkenyl, alkynyl, alkoxy, cyano or heterocyclyl, each optionally substituted with 0, 1, or multiple R²¹;
R²⁰ is alkyl, alkoxy or aryl, each optionally substituted with 0, 1, or multiple R¹⁹; and
R²¹ is selected from H, alkyl, aryl, acyl, halo, alkenyl, alkoxy or heterocyclyl.
Embodiment B3. The composition described in Embodiment B2 wherein R¹⁴ is H and R¹⁵ is Q.
Embodiment B4. The composition described in Embodiment B2, wherein Z is N.
Embodiment B5. The composition described in Embodiment B2, wherein W is O.
Embodiment B6. The composition described in Embodiment B2, wherein R¹⁷ is alkoxy.
Embodiment B7. The composition described in Embodiment B2, wherein R¹⁸ is H.
Embodiment B8. The composition described in Embodiment B2, wherein R⁹ and R¹³ are independently selected from H or alkyl, R¹⁰ and R¹¹ are independently selected from C₂-C₆ alkyl or taken together to form a 3-6 membered saturated carbocycle, each optionally substituted with 0, 1, or multiple R¹⁹, and R¹² is aryl, optionally substituted with 0, 1, or multiple R¹⁹.
Embodiment B9. The composition described in Embodiment B1, wherein the picolinamide is selected from fenpicoxamid, florylpicoxamid, [(1S,2S)-2-(4-fluoro-2-methyl-phenyl)-1,3-dimethyl-butyl](2S)-2-[(3-acetoxy-4-methoxy-pyridine-2-carbonyl)amino]propanoate, [(1S,2S)-2-(4-fluoro-2-methyl-phenyl)-1,3-dimethyl-butyl](2S)-2-[[3-(acetoxymethoxy)-4-methoxy-pyridine-2-carbonyl]amino]propanoate, and [(1S,2S)-2-(4-fluoro-2-methyl-phenyl)-1,3-dimethyl-butyl](2S)-2-[(3-hydroxy-4-methoxy-pyridine-2-carbonyl)amino]propanoate.
Embodiment B10. The composition described in Embodiment B9, wherein the picolinamide is fenpicoxamid.
Embodiment B11. The composition described in Embodiment B9, wherein the picolinamide is florylpicoxamid.
Embodiment B12. The composition described in Embodiment B9, wherein the picolinamide is [(1S,2S)-2-(4-fluoro-2-methyl-phenyl)-1,3-dimethyl-butyl](2S)-2-[(3-acetoxy-4-methoxy-pyridine-2-carbonyl)amino]propanoate.
Embodiment B13. The composition described in Embodiment B9, wherein the picolinamide is [(1S,2S)-2-(4-fluoro-2-methyl-phenyl)-1,3-dimethyl-butyl](2S)-2-[[3-(acetoxymethoxy)-4-methoxy-pyridine-2-carbonyl]amino]propanoate.
Embodiment B14. The composition described in Embodiment B9, wherein the picolinamide is [(1S,2S)-2-(4-fluoro-2-methyl-phenyl)-1,3-dimethyl-butyl](2S)-2-[(3-hydroxy-4-methoxy-pyridine-2-carbonyl)amino]propanoate.
Embodiment B15. The composition described in Embodiment B1, wherein the picolinamide is metarylpicoxamid.

Embodiments of this invention, including the Embodiments above as well as any other embodiments described herein, can be combined in any manner, and the descriptions of variables in the embodiments pertain not only to the compositions comprising (a1) a succinate dehydrogenase inhibitor (SDHI) and (a2) a picolinamide, but also to compositions comprising (a1) a succinate dehydrogenase inhibitor (SDHI) and (a2) a picolinamide with at least one invertebrate pest control compound or agent. In addition, embodiments of this invention, including the Embodiments above as well as any other embodiments described herein, and any combination thereof, pertain to the methods of the present invention. Therefore of note as a further embodiment is the composition disclosed above comprising (a1) a succinate dehydrogenase inhibitor (SDHI) and (a2) a picolinamide, and at least one invertebrate pest control compound or agent.
Embodiment C1. The composition described in the Summary of the Invention, further comprising at least one component (b).
Embodiment C2. The composition described in Embodiment C1, wherein the composition further comprises at least one component (b) selected from:
   (b1) methyl benzimidazole carbamate (MBC) fungicides;
   (b2) dicarboximide fungicides;
   (b3) demethylation inhibitor (DMI) fungicides;
   (b4) phenylamide (PA) fungicides;
   (b5) amine/morpholine fungicides;
   (b6) phospholipid biosynthesis inhibitor fungicides;
   (b7) additional succinate dehydrogenase inhibitor (SDHI) fungicides;
   (b8) hydroxy(2-amino)pyrimidine fungicides;
   (b9) anilinopyrimidine (AP) fungicides;
   (b10) N-phenyl carbamate fungicides;
   (b11) quinone outside inhibitor (QoI) fungicides;
   (b12) phenylpyrrole (PP) fungicides;
   (b13) azanaphthalene fungicides;
   (b14) cell peroxidation inhibitor fungicides;
   (b15) melanin biosynthesis inhibitor-reductase (MBI-R) fungicides;
   (b16a) melanin biosynthesis inhibitor-dehydratase (MBI-D) fungicides;
   (b16b) melanin biosynthesis inhibitor-polyketide synthase (MBI-P) fungicides;
   (b17) keto reductase inhibitor (KRI) fungicides;
   (b18) squalene-epoxidase inhibitor fungicides;
   (b19) polyoxin fungicides;
   (b20) phenylurea fungicides;
   (b21) quinone inside inhibitor (QiI) fungicides;
   (b22) benzamide and thiazole carboxamide fungicides;
   (b23) enopyranuronic acid antibiotic fungicides;
   (b24) hexopyranosyl antibiotic fungicides;
   (b25) glucopyranosyl antibiotic: protein synthesis fungicides;
   (b26) glucopyranosyl antibiotic fungicides;
   (b27) cyanoacetamide-oxime fungicides;
   (b28) carbamate fungicides;
   (b29) oxidative phosphorylation uncoupling fungicides;
   (b30) organo tin fungicides;
   (b31) carboxylic acid fungicides;
   (b32) heteroaromatic fungicides;
   (b33) phosphonate fungicides;
   (b34) phthalamic acid fungicides;
   (b35) benzotriazine fungicides;
   (b36) benzene-sulfonamide fungicides;
   (b37) pyridazinone fungicides;
   (b38) thiophene-carboxamide fungicides;
   (b39) complex I NADH oxidoreductase inhibitor fungicides;
   (b40) carboxylic acid amide (CAA) fungicides;
   (b41) tetracycline antibiotic fungicides;
   (b42) thiocarbamate fungicides;
   (b43) benzamide fungicides;
   (b44) microbial fungicides;
   (b45) quinone outside inhibitor, stigmatellin binding (QoSI) fungicides;
   (b46) plant extract fungicides;
   (b47) cyanoacrylate fungicides;
   (b48) polyene fungicides;
   (b49) oxysterol binding protein inhibitor (OSBPI) fungicides;
   (b50) aryl-phenyl-ketone fungicides;
   (b51) host plant defense induction fungicides;
   (b52) multi-site activity fungicides;
   (b53) biologicals with multiple modes of action;
   (b54) fungicides other than fungicides of component (a1) and component (a2) and components (b1) through (b53); and
   salts of compounds of (b1) through (b54).
Embodiment C3. The composition described in Embodiment C2, wherein component (b) comprises at least one fungicidal compound from each of two different groups selected from (b1) through (b54).
Embodiment C4. The composition described in Embodiment C1 wherein component (b) includes at least one compound selected from (b1) methyl benzimidazole carbamate fungicides such as benomyl, carbendazim, fuberidazole thiabendazole, thiophanate and thiophanate-methyl.
Embodiment C5. The composition described in Embodiment C1 wherein component (b) includes at least one compound selected from (b2) dicarboximide fungicides such as chlozolinate, dimethachlone, iprodione, procymidone and vinclozolin.
Embodiment C6. The composition described in Embodiment C1 wherein component (b) includes at least one compound selected from (b3) demethylation inhibitor fungicides such as azaconazole, bitertanol, bromuconazole, buthiobate, cyproconazole, difenoconazole, diniconazole (including diniconazole-M), econazole, epoxiconazole, etaconazole, fenarimol, fenbuconazole, fluquinconazole, flusilazole, flutriafol, hexaconazole, imazalil, imibenconazole, ipconazole, ipfentrifluconazole, mefentrifluconazole, metconazole, myclobutanil, nuarimol, oxpoconazole, pefurazoate, penconazole, prochloraz, propiconazole, pyrifenox, pyrisoxazole, quinconazole, simeconazole, tebuconazole, tetraconazole, triadimefon, triadimenol, triarimol, triflumizole, triforine, triticonazole, uniconazole and uniconazole-P.
Embodiment C7. The composition described in Embodiment C1 wherein component (b) includes at least one compound selected from (b4) phenylamide fungicides such as benalaxyl, benalaxyl-M, furalaxyl, metalaxyl, metalaxyl-M, ofurace and oxadixyl.
Embodiment C8. The composition described in Embodiment C1 wherein component (b) includes at least one compound selected from (b5) amine/morpholine fungicides such as aldimorph, dodemorph, fenpropidin, fenpropimorph, piperalin, spiroxamine, tridemorph and trimorphamide.
Embodiment C9. The composition described in Embodiment C1 wherein component (b) includes at least one compound selected from (b6) phospholipid biosynthesis inhibitor fungicides such as edifenphos, iprobenfos, isoprothiolane and pyrazophos.
Embodiment C10. The composition described in Embodiment C1 wherein component (b) includes at least one compound selected from (b7) succinate dehydrogenase inhibitor fungicides such as benodanil, benzovindiflupyr, bixafen, boscalid, carboxin, fenfuram, flubeneteram, fluindapyr, fluopyram, flutolanil, fluxapyroxad, furametpyr, inpyrfluxam, isofetamid, isoflucypram, isopyrazam, mepronil, oxycarboxin, penflufen, penthiopyrad, pydiflumetofen, pyrapropoyne, pyraziflumid, sedaxane and thifluzamide.
Embodiment C11. The composition described in Embodiment C1 wherein component (b) includes at least one compound selected from (b8) hydroxy(2-amino)pyrimidine fungicides such as bupirimate, dimethirimol and ethirimol.
Embodiment C12. The composition described in Embodiment C1 wherein component (b) includes at least one compound selected from (b9) anilinopyrimidine fungicides such as cyprodinil, mepanipyrim and pyrimethanil.
Embodiment C13. The composition described in Embodiment C1 wherein component (b) includes at least one compound selected from (b10) N-phenyl carbamate fungicides such as diethofencarb.
Embodiment C14. The composition described in Embodiment C1 wherein component (b) includes at least one compound selected from (b11) fungicides quinone outside inhibitor fungicides such as azoxystrobin, coumoxystrobin, dimoxystrobin, enoxastrobin, famoxadone, fenamidone, fenaminstrobin, flufenoxystrobin, fluoxastrobin, kresoxim-methyl, mandestrobin, metominostrobin, metyltetraprole, orysastrobin, picoxystrobin, pyraclostrobin, pyrametostrobin, pyraoxystrobin, pyribencarb, triclopyricarb and trifloxystrobin.
Embodiment C15. The composition described in Embodiment C1 wherein component (b) includes at least one compound selected from (b12) phenylpyrrole fungicides compound such as fenpiclonil and fludioxonil.
Embodiment C16. The composition described in Embodiment C1 wherein component (b) includes at least one compound selected from (b13) azanaphthalene fungicides such as quinoxyfen and proquinazid.
Embodiment C17. The composition described in Embodiment C1 wherein component (b) includes at least one compound selected from (b14) cell peroxidation inhibitor fungicides such as biphenyl, chloroneb, dicloran, etridiazole quintozene, tecnazene and tolclofos-methyl.
Embodiment C18. The composition described in Embodiment C1 wherein component (b) includes at least one compound selected from (b15) melanin biosynthesis inhibitors-reductase fungicides such as fthalide, pyroquilon and tricyclazole.
Embodiment C19a. The composition described in Embodiment C1 wherein component (b) includes at least one compound selected from (b16a) melanin biosynthesis inhibitors-dehydratase fungicides such as carpropamid, diclocymet and fenoxanil.
Embodiment C19b. The composition described in Embodiment C1 wherein component (b) includes at least one compound selected from (b16b) melanin biosynthesis inhibitor-polyketide synthase fungicides such as tolprocarb.
Embodiment C20. The composition described in Embodiment C1 wherein component (b) includes at least one compound selected from (b17) keto reductase inhibitor fungicides such as fenhexamid, fenpyrazamine, ipflufenoquin and quinofumelin.
Embodiment C21. The composition described in Embodiment C1 wherein component (b) includes at least one compound selected from (b18) squalene-epoxidase inhibitor fungicides such as naftifine, pyributicarb and terbinafine.
Embodiment C22. The composition described in Embodiment C1 wherein component (b) includes at least one compound selected from (b19) polyoxin fungicides such as polyoxin.
Embodiment C23. The composition described in Embodiment C1 wherein component (b) includes at least one compound selected from (b20) phenylurea fungicides such as pencycuron.
Embodiment C24. The composition described in Embodiment C1 wherein component (b) includes at least one compound selected from (b21) quinone inside inhibitor fungicides such as amisulbrom, cyazofamid, fenpicoxamid and florylpicoxamid.
Embodiment C24a. The composition described in Embodiment C1 wherein component (b) includes at least one compound selected from (b21) quinone inside inhibitor fungicides such as metarylpicoxamid.
Embodiment C25. The composition described in Embodiment C1 wherein component (b) includes at least one compound selected from (b22) benzamide and thiazole carboxamide fungicides such as ethaboxam and zoxamide.
Embodiment C26. The composition described in Embodiment C1 wherein component (b) includes at least one compound selected from (b23) enopyranuronic acid antibiotic fungicides such as blasticidin-S.
Embodiment C27. The composition described in Embodiment C1 wherein component (b) includes at least one compound selected from (b24) hexopyranosyl antibiotic fungicides such as kasugamycin.
Embodiment C28. The composition described in Embodiment C1 wherein component (b) includes at least one compound selected from (b25) glucopyranosyl antibiotic: protein synthesis fungicides such as streptomycin.
Embodiment C29. The composition described in Embodiment C1 wherein component (b) includes at least one compound selected from (b26) glucopyranosyl antibiotic: trehalase and inositol biosynthesis fungicides such as validamycin.
Embodiment C30. The composition described in Embodiment C1 wherein component (b) includes at least one compound selected from (b27) cyanoacetamide-oxime fungicides such as cymoxanil.
Embodiment C31. The composition described in Embodiment C1 wherein component (b) includes at least one compound selected from (b28) carbamate fungicides such as iodocarb, propamocarb and prothiocarb.
Embodiment C32. The composition described in Embodiment C1 wherein component (b) includes at least one compound selected from (b29) oxidative phosphorylation uncoupling fungicides such as binapacryl, dinocap, fluazinam and meptyldinocap.
Embodiment C33. The composition described in Embodiment C1 wherein component (b) includes at least one compound selected from (b30) organo tin fungicides such as fentin acetate, fentin chloride and fentin hydroxide.
Embodiment C34. The composition described in Embodiment C1 wherein component (b) includes at least one compound selected from (b31) carboxylic acid fungicides such as oxolinic acid.
Embodiment C35. The composition described in Embodiment C1 wherein component (b) includes at least one compound selected from (b32) heteroaromatic fungicides such as hymexazole and octhilinone.
Embodiment C36. The composition described in Embodiment C1 wherein component (b) includes at least one compound selected from (b33) phosphonate fungicides such as phosphorous acid and its various salts, including fosetyl-aluminum.
Embodiment C37. The composition described in Embodiment C1 wherein component (b) includes at least one compound selected from (b34) phthalamic acid fungicides such as tecloftalam.
Embodiment C38. The composition described in Embodiment C1 wherein component (b) includes at least one compound selected from (b35) benzotriazine fungicides such as triazoxide.
Embodiment C39. The composition described in Embodiment C1 wherein component (b) includes at least one compound selected from (b36) benzene-sulfonamide fungicides such as flusulfamide.
Embodiment C40. The composition described in Embodiment C1 wherein component (b) includes at least one compound selected from (b37) pyridazinone fungicides such as diclomezine.
Embodiment C41. The composition described in Embodiment C1 wherein component (b) includes at least one compound selected from (b38) thiophene-carboxamide fungicides such as silthiofam.
Embodiment C42. The composition described in Embodiment C1 wherein component (b) includes at least one compound selected from (b39) complex I NADH oxidoreductase inhibitor fungicides such as diflumetorim, fenazaquin and tolfenpyrad.
Embodiment C43. The composition described in Embodiment C1 wherein component (b) includes at least one compound selected from (b40) carboxylic acid amide fungicides such as benthiavalicarb, benthiavalicarb-isopropyl, dimethomorph, flumorph, iprovalicarb, mandipropamid, pyrimorph, tolprocarb and valifenalate.
Embodiment C44. The composition described in Embodiment C1 wherein component (b) includes at least one compound selected from (b41) tetracycline antibiotic fungicides such as oxytetracycline.
Embodiment C45. The composition described in Embodiment C1 wherein component (b) includes at least one compound selected from (b42) thiocarbamate fungicides such as methasulfocarb.
Embodiment C46. The composition described in Embodiment C1 wherein component (b) includes at least one compound selected from (b43) benzamide fungicides such as fluopicolide and fluopimomide.
Embodiment C47. The composition described in Embodiment C1 wherein component (b) includes at least one compound selected from (b44) microbial fungicides such as Bacillus amyloliquefaciens strains AP-136, AP-188, AP-218, AP-219, AP-295, D747, F727, FCC1256, FZB24, FZB42, MB1600, QST713, RTI301, RTI472, TJ100 (also called strain 1 BE; known from EP2962568), and the fungicidal lipopeptides which they produce.
Embodiment C48. The composition described in Embodiment C1 wherein component (b) includes at least one compound selected from (b45) quinone outside inhibitor, stigmatellin binding fungicides such as ametoctradin.
Embodiment C49. The composition described in Embodiment C1 wherein component (b) includes at least one compound selected from (b46) plant extract fungicides such as eugenol, geraniol and thymol.
Embodiment C50. The composition described in Embodiment C1 wherein component (b) includes at least one compound selected from (b47) cyanoacrylate fungicides such as phenamacril.
Embodiment C51. The composition described in Embodiment C1 wherein component (b) includes at least one compound selected from (b48) polyene fungicides such as natamycin.
Embodiment C52. The composition described in Embodiment C1 wherein component (b) includes at least one compound selected from (b49) oxysterol binding protein inhibitor fungicides such as oxathiapiprolin and fluoxapiprolin.
Embodiment C53. The composition described in Embodiment C1 wherein component (b) includes at least one compound selected from (b50) aryl-phenyl-ketone fungicides such as metrafenone and pyriofenone.
Embodiment C54. The composition described in Embodiment C1 wherein component (b) includes at least one compound selected from (b51) host plant defense induction fungicides such as acibenzolar-S-methyl, probenazole, tiadinil, isotianil, laminarin, extract from Reynoutria sachalinensis and Bacillus mycoides isolate J and cell walls of Saccharomyces cerevisiae strain LAS117.
Embodiment C55. The composition described in Embodiment C1 wherein component (b) includes at least one compound selected from (b52) multi-site activity fungicides such as copper oxychloride, copper sulfate, copper hydroxide, Bordeaux composition (tribasic copper sulfide), elemental sulfur, ferbam, mancozeb, maneb, metiram, propineb, thiram, zinc thiazole, zineb, ziram, folpet, captan, captafol, chlorothalonil, dichlofluanid, tolyfluanid, guazatine, iminoctadine albesilate, iminoctadine triacetate, anilazine, dithianon, quinomethionate and fluoroimide.
Embodiment C56. The composition described in Embodiment C1 wherein component (b) includes at least one compound selected from (b53) biological fungicides with multiple modes of action such as extract from the cotyledons of lupine plantlets.
Embodiment C57. The composition described in Embodiment C1 wherein component (b) includes at least one compound selected from (b54) fungicides other than fungicides of component (a1) and component (a2) and components (b1) through (b53), such as bethoxazin, cyflufenamid, dichlobentiazox, dipymetitrone, dodine, ferimzone, flometoquin, flutianil, neo-asozin, picarbutrazox, pyrrolnitrin, tebufloquin, tolnifanide, N-[4-[4-chloro-3-(trifluoromethyl)phenoxy]-2,5-dimethylphenyl]-N-ethyl-N-methylmethanimidamide, 5-fluoro-2-[(4-fluorophenyl)methoxy]-4-pyrimidinamine and 4-fluorophenyl N-[1-[[[1-(4-cyanophenyl)ethyl]sulfonyl]methyl]propyl]carbamate (XR-539).
Embodiment C58. The composition described in Embodiment C1 wherein component (b) includes 3-chloro-4-(2,6-difluorophenyl)-6-methyl-5-phenylpyridazine (provisional common name pyridachlometyl).
Embodiment C59. The composition described in Embodiment C1 wherein component (b) includes aminopyrifen.
Embodiment C60. The composition described in Embodiment C1 wherein component (b) includes at least one fungicidal compound (fungicide) selected from the group consisting of azoxystrobin, benzovindiflupyr, boscalid (nicobifen), bixafen, bromuconazole, carbendazim, chlorothalonil, copper sulfate, cyflufenamid, cyproconazole, difenoconazole, dimoxystrobin, epoxiconazole, famoxadone, fenbuconazole, fenpropidin, fenpropimorph, florylpicoxamid, fluindapyr, flusilazole, flutriafol, fluxapyroxad, hexaconazole, inpyrfluxam, ipconazole, isoflucypram, kresoxim-methyl, mancozeb, mefentrifluconazole, manzate, metconazole, metominostrobin, metrafenone, metyltetraprole, myclobutanil, penconazole, penthiopyrad, picoxystrobin, prochloraz, propiconazole, proquinazid, prothioconazole, pydiflumetofen, pyraclostrobin, pyrametostrobin, pyraoxystrobin, pyriofenone quinoxyfen, tebuconazole, trifloxystrobin, triticonazole, N-(2,2,2-trifluoroethyl)-2-[[4-[5-(trifluoromethyl)-1,2,4-oxadiazol-3-yl]phenyl]methyl]-4-oxazolecarboxamide, ethyl 1-[[4-[5-(trifluoromethyl)-1,2,4-oxadiazol-3-yl]phenoxy]methyl]-1H-pyrazole-4-carboxylate, ethyl 1-[[4-[[(1Z)-2-ethoxy-3,3,3-trifluoro-1-propen-1-yl]oxy]phenyl]methyl]-1H-pyrazole-4-carboxylate and ethyl 1-[[4-[[2-(trifluoromethyl)-1,3-dioxolan-2-yl]methoxy]phenyl]methyl]-1H-pyrazole-4-carboxylate.
Embodiment C61. The composition of Embodiment C60 wherein component (b) includes at least one compound selected from the group consisting of azoxystrobin, benzovindiflupyr, bixafen, chlorothalonil, copper sulfate, cyflufenamid, cyproconazole, difenoconazole, dimoxystrobin, epoxiconazole, famoxadone, fenpropidin, fenpropimorph, florylpicoxamid, fluindapyr, flusilazole, flutriafol, fluxapyroxad, inpyrfluxam, isoflucypram, kresoxim-methyl, mancozeb, manzate, mefentrifluconazole, metconazole, metominostrobin, metrafenone, myclobutanil, penthiopyrad, picoxystrobin, propiconazole, proquinazid, prothioconazole, pydiflumetofen, pyraclostrobin, pyrametostrobin, pyraoxystrobin, pyriofenone, quinoxyfen, tebuconazole, trifloxystrobin, triticonazole, N-(2,2,2-trifluoroethyl)-2-[[4-[5-(trifluoromethyl)-1,2,4-oxadiazol-3-yl]phenyl]methyl]-4-oxazolecarboxamide, ethyl 1-[[4-[5-(trifluoromethyl)-1,2,4-oxadiazol-3-yl]phenoxy]methyl]-1H-pyrazole-4-carboxylate, ethyl 1-[[4-[[(1Z)-2-ethoxy-3,3,3-trifluoro-1-propen-1-yl]oxy]phenyl]methyl]-1H-pyrazole-4-carboxylate and ethyl 1-[[4-[[2-(trifluoromethyl)-1,3-dioxolan-2-yl]methoxy]phenyl]methyl]-1H-pyrazole-4-carboxylate.
Embodiment C62. The composition of Embodiment C61 wherein component (b) includes at least one compound selected from the group consisting of azoxystrobin, benzovindiflupyr, bixafen, chlorothalonil, copper sulfate, cyproconazole, difenoconazole, epoxiconazole, fenpropimorph, florylpicoxamid, fluindapyr, flutriafol, fluxapyroxad, inpyrfluxam, isoflucypram, mancozeb, mefentrifluconazole, metominostrobin, picoxystrobin, prothioconazole, pydiflumetofen, pyraclostrobin, tebuconazole, trifloxystrobin, ethyl 1-[[4-[[(1Z)-2-ethoxy-3,3,3-trifluoro-1-propen-1-yl]oxy]phenyl]methyl]-1H-pyrazole-4-carboxylate and ethyl 1-[[4-[[2-(trifluoromethyl)-1,3-dioxolan-2-yl]methoxy]phenyl]methyl]-1H-pyrazole-4-carboxylate.
Embodiment C63. The composition of Embodiment C62 wherein component (b) includes at least one compound selected from the group consisting of azoxystrobin, benzovindiflupyr, bixafen, chlorothalonil, copper sulfate, cyproconazole, difenoconazole, epoxiconazole, fenpropimorph, florylpicoxamid, fluindapyr, flutriafol, fluxapyroxad, inpyrfluxam, isoflucypram, mancozeb, mefentrifluconazole, metominostrobin, picoxystrobin, prothioconazole, pydiflumetofen, pyraclostrobin, tebuconazole and trifloxystrobin.
Embodiment C64. The composition of Embodiment C63 wherein component (b) includes at least one compound selected from the group consisting of azoxystrobin, benzovindiflupyr, chlorothalonil, cyproconazole, difenoconazole, epoxiconazole, fenpropimorph, fluindapyr, flutriafol, mancozeb, mefentrifluconazole, picoxystrobin, prothioconazole, pydiflumetofen, tebuconazole and trifloxystrobin.
Embodiment C65. The composition of Embodiment C1 wherein component (b) includes at least one compound selected from the group consisting of azoxystrobin, benzovindiflupyr, chlorothalonil, cyproconazole, difenoconazole, epoxiconazole, fenpropimorph, fluindapyr, flutriafol, mancozeb, mefentrifluconazole, metarylpicoxamid, picoxystrobin, prothioconazole, pydiflumetofen, tebuconazole and trifloxystrobin.
Embodiment C66. The composition of Embodiment C1 wherein component (b) includes at least two fungicidal compounds selected from the group consisting of azoxystrobin, benzovindiflupyr, bixafen, chlorothalonil, copper sulfate, cyproconazole, difenoconazole, epoxiconazole, fenpropimorph, florylpicoxamid, fluindapyr, flutriafol, fluxapyroxad, inpyrfluxam, isoflucypram, mancozeb, mefentrifluconazole, metominostrobin, picoxystrobin, prothioconazole, pydiflumetofen, pyraclostrobin, tebuconazole and trifloxystrobin.

Of note is the composition of any one of the embodiments described herein, wherein reference to Formula I or Formula II includes salts thereof but not N-oxides thereof, therefore the phrase “a compound of Formula I” or “a compound of Formula II” can be replaced by the phrase “a compound of Formula I or a salt thereof” or “a compound of Formula II or a salt thereof”.

Also noteworthy as embodiments are fungicidal compositions of the present invention comprising a fungicidally effective amount of a composition of any one of the embodiments described herein, and at least one additional component selected from the group consisting of surfactants, solid diluents and liquid diluents.

Embodiments of the invention further include methods for controlling plant diseases caused by fungal plant pathogens comprising applying to the plant or portion thereof, or to the plant seed or seedling, a fungicidally effective amount of a composition of any one of the embodiments described herein. Embodiments of the invention also include methods for protecting a plant or plant seed from diseases caused by fungal pathogens comprising applying a fungicidally effective amount of a composition of any one of the embodiments described herein to the plant or plant seed.

Some embodiments of the invention involve control of a plant disease or protection from a plant disease that primarily afflicts plant foliage and/or applying the composition of the invention to plant foliage (i.e. plants instead of seeds). The preferred methods of use include those involving the above preferred compositions; and the diseases controlled with particular effectiveness include plant diseases caused by fungal plant pathogens. Combinations of fungicides used in accordance with this invention can facilitate disease control and retard resistance development. Additionally, combinations of fungicides used in accordance with this invention can be particularly effective against fungal species with resistance towards fungicides.
Embodiment D1. The composition described in the Summary of the Invention, wherein the SDHI and the picolinamide are present in a ratio of SDHI:picolinamide in the range of from about 20:1 to about 1:20.
Embodiment D2. The composition described in Embodiment D1, wherein the SDHI and the picolinamide are present in a ratio of SDHI:picolinamide in the range of from about 10:1 to about 1:10.
Embodiment D3. The composition described in Embodiment D2, wherein the SDHI and the picolinamide are present in a ratio of SDHI:picolinamide in the range of from about 9:1 to about 1:9.
Embodiment D4. The composition described in Embodiment D3, wherein the SDHI and the picolinamide are present in a ratio of SDHI:picolinamide in the range of from about 8:1 to about 1:8.
Embodiment D5. The composition described in Embodiment D4, wherein the SDHI and the picolinamide are present in a ratio of SDHI:picolinamide in the range of from about 7:1 to about 1:7.
Embodiment D6. The composition described in Embodiment D5, wherein the SDHI and the picolinamide are present in a ratio of SDHI:picolinamide in the range of from about 6:1 to about 1:6.
Embodiment D7. The composition described in Embodiment D6, wherein the SDHI and the picolinamide are present in a ratio of SDHI:picolinamide in the range of from about 5:1 to about 1:5.
Embodiment D8. The composition described in Embodiment D7, wherein the SDHI and the picolinamide are present in a ratio of SDHI:picolinamide in the range of from about 4:1 to about 1:4.
Embodiment D9. The composition described in Embodiment D8, wherein the SDHI and the picolinamide are present in a ratio of SDHI:picolinamide in the range of from about 3:1 to about 1:3.
Embodiment D10. The composition described in Embodiment D9, wherein the SDHI and the picolinamide are present in a ratio of SDHI:picolinamide in the range of from about 2:1 to about 1:2.
Embodiment D11. The composition described in Embodiment D10, wherein the SDHI and the picolinamide are present in a ratio of SDHI:picolinamide of about 1.5:1.

Method embodiments further include:
Embodiment E1. A method for protecting a plant from a disease selected from rust, powdery mildew, Septoria and Botrytis diseases comprising applying to the plant a fungicidally effective amount of the composition described in the Summary of the Invention or any one of the embodiments described herein.
Embodiment E2. The method of Embodiment E1 wherein the disease is a rust disease and component (b) of the composition includes at least one fungicidal compound selected from (b3) demethylation inhibitor (DMI) fungicides, (b5) amine/morpholine fungicides, (b7) succinate dehydrogenase inhibitor fungicides, (b11) quinone outside inhibitor (QoI) fungicides, (b13) methyl benzimidazole carbamate fungicides and (b52) multi-site activity fungicides.
Embodiment E3. The method of Embodiment E2 wherein component (b) of the composition includes at least one fungicidal compound selected from (b3) demethylation inhibitor (DMI) fungicides, (b7) succinate dehydrogenase inhibitor fungicides, (b11) quinone outside inhibitor (QoI) fungicides and (b52) multi-site activity fungicides.
Embodiment E4. The method of Embodiment E3 wherein component (b) of the composition includes at least one fungicidal compound selected from (b3) demethylation inhibitor (DMI) fungicides, (b7) succinate dehydrogenase inhibitor fungicides and (b11) quinone outside inhibitor (QoI).
Embodiment E5. The method of Embodiment E1 wherein component (b) of the composition includes at least one fungicidal compound selected from the group consisting of azoxystrobin, benzovindiflupyr, bixafen, cyproconazole, difenoconazole, epoxiconazole, fenpropimorph, florylpicoxamid, fluindapyr, flutriafol, fluxapyroxad, inpyrfluxam, isoflucypram, mancozeb, mefentrifluconazole, metominostrobin, picoxystrobin, prothioconazole, pydiflumetofen, pyraclostrobin, tebuconazole and trifloxystrobin.
Embodiment E6. The method of Embodiment E5 wherein component (b) of the composition includes at least one fungicidal compound selected from the group consisting of azoxystrobin, benzovindiflupyr, cyproconazole, epoxiconazole, fenpropimorph, flutriafol, fluxapyroxad, metominostrobin, picoxystrobin, prothioconazole, pydiflumetofen, tebuconazole and trifloxystrobin.
Embodiment E7. The method of Embodiment E2 wherein the disease is Asian soybean rust caused by Phakopsora pachyrhizi.
Embodiment E8. The method of Embodiment E2 wherein the disease is wheat leaf rust caused by Puccinia recondita.
Embodiment E9. The method of Embodiment E1 wherein the disease is a powdery mildew disease and component (b) of the composition includes at least one fungicidal compound selected from (b3) demethylation inhibitor (DMI) fungicides, (b11) quinine outside inhibitor (QoI) fungicides, (b13) azanaphthalene fungicides and (b52) multi-site activity fungicides.
Embodiment E10. The method of Embodiment E9 wherein component (b) of the composition includes at least one fungicidal compound selected from (b3) demethylation inhibitor (DMI) fungicides, (b11) quinone outside inhibitor (QoI) fungicides and (b52) multi-site activity fungicides.
Embodiment E11. The method of Embodiment E9 wherein component (b) of the composition includes at least one fungicidal compound selected from the group consisting of azoxystrobin, chlorothalonil, copper sulfate, cyproconazole, difenoconazole, epoxiconazole, flutriafol, mancozeb, mefentrifluconazole, metominostrobin, picoxystrobin, prothioconazole, pyraclostrobin, tebuconazole and trifloxystrobin.
Embodiment E12. The method of Embodiment E11 wherein component (b) of the composition includes at least one fungicidal compound selected from the group consisting of cyproconazole, difenoconazole, epoxiconazole, flutriafol, mancozeb, prothioconazole, tebuconazole and trifloxystrobin.
Embodiment E13. The method of Embodiment E10 wherein component (b) of the composition includes at least one fungicidal compound selected from (b3) DMI fungicides.
Embodiment E14. The method of Embodiment E13 wherein component (b) of the composition includes at least one fungicidal compound selected from the group consisting of cyproconazole, difenoconazole, epoxiconazole, flutriafol, prothioconazole and tebuconazole.
Embodiment E15. The method Embodiment E10 wherein component (b) of the composition includes at least one fungicidal compound selected from (b11) QoI fungicides.
Embodiment E16. The method of Embodiment E15 wherein component (b) of the composition includes at least one fungicidal compound selected from the group consisting of azoxystrobin, picoxystrobin, pyraclostrobin and trifloxystrobin.
Embodiment E17. The method of Embodiment E9 wherein the disease is wheat powdery mildew caused by Erysiphe graminis.
Embodiment E18. The method of Embodiment E1 wherein the disease is a Septoria disease and component (b) of the composition includes at least one fungicidal compound selected from (b3) demethylation inhibitor (DMI) fungicides and (b11) quinine outside inhibitor (QoI) fungicides.
Embodiment E19. The method of Embodiment E18 wherein component (b) of the composition includes at least one fungicidal compound selected from the group consisting of azoxystrobin, cyproconazole, difenoconazole, epoxiconazole, fenpropimorph, florylpicoxamid, flutriafol, mefentrifluconazole, metominostrobin, picoxystrobin, prothioconazole, pyraclostrobin, tebuconazole and trifloxystrobin.
Embodiment E20. The method of Embodiment E18 wherein the disease is wheat leaf blotch caused by Zymoseptoria tritici.
Embodiment E21. The method of Embodiment E1 wherein the disease is a Botrytis disease and component (b) of the composition includes at least one fungicidal compound selected from (b11) quinone outside inhibitor (QoI) fungicides and (b52) multi-site activity fungicides.
Embodiment E22. The method of Embodiment E21 wherein component (b) of the composition includes at least one fungicidal compound selected from the group consisting of azoxystrobin, chlorothalonil, mancozeb, metominostrobin, picoxystrobin, pyraclostrobin and trifloxystrobin.
Embodiment E23. The method of Embodiment E22 wherein component (b) of the composition includes at least one fungicidal compound selected from the group consisting of azoxystrobin mancozeb, and trifloxystrobin.
Embodiment E24. The method of Embodiment E1 wherein components (a1), (a2), and (b) are applied in synergistically effective amounts (and in a synergistic ratio relative to each other).

Method embodiments also include:
Embodiment F1. A method for protecting a plant from a disease against at least one resistant strain of fungus comprising applying to the plant a fungicidally effective amount of the composition described in the Summary of the Invention or any one of the embodiments described herein.
Embodiment F2. The method of Embodiment F1 wherein the resistant strain of fungus develops as a result of cross resistance.
Embodiment F3. The method of Embodiment F1 wherein the resistant strain of fungus develops as a result of a gene mutation(s).
Embodiment F4. The method of any one of Embodiments F1 through F3 wherein the resistant strain of fungus is resistant to at least one SDHI fungicide (succinate dehydrogenase inhibitor).
Embodiment F5. The method of Embodiment F4 wherein the resistant strain of fungus is resistant to at least one SDHI fungicide when the wild type of this strain is sensitive to the fungicide.
Embodiment F6. The method of any one of Embodiments F1 through F5 wherein the resistant strain of fungus is selected from Alternaria alternata, Alternaria solani, Aspergillus oryzae, Botrytis cinerea, Corynespora cassiicola, Didymella bryoniae, Erysiphe necator, Phakopsora pachyrhizi, Podosphaera xanthii, Puccinia hordei, Puccinia triticina, Pyrenophora teres, Ramularia collo-cygni, Rhynchosporium secalis, Sclerotinia sclerotiorum, Stemphylium botryose, Ustilago maydis, Venturia inaequalis and Zymoseptoria tritici.
Embodiment F7. The method of any one of Embodiments F1 through F5 wherein the resistant strain of fungus is selected from Alternaria alternata, Alternaria solani, Aspergillus oryzae, Botrytis cinerea, Botrytis elliptica, Corynespora cassiicola, Didymella bryoniae, Mycosphaerella graminicola, Podosphaera xanthii, Sclerotinia sclerotiorum, Stemphylium botryose, Ustilago maydis and Zymoseptoria tritici.
Embodiment F8. The method of Embodiments F6 and F7 wherein the resistant strain of fungus is Zymoseptoria tritici.
Embodiment F9. The method of Embodiments F8 wherein the Zymoseptoria tritici is strain IPO323.
Embodiment F10. The method of Embodiment F8 wherein the Zymoseptoria tritici comprises at least one mutation in the CYP51 gene.
Embodiment F11. The method of Embodiment F8 wherein the Zymoseptoria tritici comprises at least two mutations in the CYP51 gene.
Embodiment F12. The method of Embodiment F8 wherein the Zymoseptoria tritici is strain TriR6.
Embodiment F12. The method of Embodiment F8 wherein the Zymoseptoria tritici is strain TriR10.

Of note are embodiments that are counterparts of Embodiments E1 through E24 and Embodiments F1 through F12 relating to a method for controlling plant diseases caused by fungal plant pathogens comprising applying to the plant or portion thereof, a fungicidally effective amount of a fungicidal composition of the invention.

### Formulation/Utility

The (a1) SDHI and (a2) picolinamide as described in the Summary of the Invention will generally be used as fungicidal active ingredients in a composition, i.e. formulation, with at least one additional component selected from the group consisting of surfactants, solid diluents and liquid diluents, which serve as a carrier. The formulation or composition ingredients are selected to be consistent with the physical properties of the active ingredient, mode of application and environmental factors such as soil type, moisture and temperature.

The mixtures of components (a1) and (a2) with component (b) (e.g., selected from (b1) to (b54) and salts thereof as described above) and/or one or more other biologically active compound or agent (i.e. insecticides, other fungicides, nematocides, acaricides, herbicides and other biological agents) can be formulated in a number of ways, including:
(i) component (a1), component (a2), component (b) and/or one or more other biologically active compounds or agents can be formulated separately and applied separately or applied simultaneously in an appropriate weight ratio, e.g., as a tank mix; or
(ii) component (a1), component (a2), component (b) and/or one or more other biologically active compounds or agents can be formulated together in the proper weight ratio.

Useful formulations include both liquid and solid compositions. Liquid compositions include solutions (including emulsifiable concentrates), suspensions, emulsions (including microemulsions, oil-in-water emulsions, flowable concentrates and/or suspoemulsions) and the like, which optionally can be thickened into gels. The general types of aqueous liquid compositions are soluble concentrate, suspension concentrate, capsule suspension, concentrated emulsion, microemulsion, oil-in-water emulsion, flowable concentrate and suspoemulsion. The general types of nonaqueous liquid compositions are emulsifiable concentrate, microemulsifiable concentrate, dispersible concentrate and oil dispersion.

The general types of solid compositions are dusts, powders, granules, pellets, prills, pastilles, tablets, filled films (including seed coatings) and the like, which can be water-dispersible (“wettable”) or water-soluble. Films and coatings formed from film-forming solutions or flowable suspensions are particularly useful for seed treatment. Active ingredient(s) can be (micro)encapsulated and further formed into a suspension or solid formulation; alternatively the entire formulation of active ingredient can be encapsulated (or “overcoated”). Encapsulation can control or delay release of the active ingredient. An emulsifiable granule combines the advantages of both an emulsifiable concentrate formulation and a dry granular formulation. High-strength compositions are primarily used as intermediates for further formulation.

In one composition embodiment, granules of a solid composition comprising component (a1) and component (a2) are mixed with granules of a solid composition comprising component (b). These mixtures can be further mixed with granules comprising additional agricultural protectants. Alternatively, two or more agricultural protectants (e.g., component (a1), component (a2), a component (b) compound, an agricultural protectant other than component (a1) or (a2) or (b)) can be combined in the solid composition of one set of granules, which is then mixed with one or more sets of granules of solid compositions comprising one or more additional agricultural protectants. These granule mixtures can be in accordance with the general granule mixture disclosure of PCT Patent Publication WO 94/24861 or more preferably the homogeneous granule mixture teaching of U.S. Pat. No. 6,022,552.

Sprayable formulations are typically extended in a suitable medium before spraying. Such liquid and solid formulations are formulated to be readily diluted in the spray medium, usually water, but occasionally another suitable medium like an aromatic or paraffinic hydrocarbon or vegetable oil. Spray volumes can range from about one to several thousand liters per hectare, but more typically are in the range from about ten to several hundred liters per hectare. Sprayable formulations can be tank mixed with water or another suitable medium for foliar treatment by aerial or ground application, or for application to the growing medium of the plant. Liquid and dry formulations can be metered directly into drip irrigation systems or metered into the furrow during planting. Liquid and solid formulations can be applied onto seeds of crops and other desirable vegetation as seed treatments before planting to protect developing roots and other subterranean plant parts and/or foliage through systemic uptake.

The formulations will typically contain effective amounts of active ingredient(s), diluent and surfactant within the following approximate ranges which add up to 100 percent by weight. As defined herein, the effective amount of active ingredient(s) includes an individual amount of an individual active ingredient or a combined amount of more than one active ingredient.

| | Weight Percent | | |
|---|---|---|---|
| | Active | | |
| | Ingredient(s) | Diluent | Surfactant |
| Water-Dispersible and Water- | 0.001-90 | 0-99.999 | 0-15 |
| soluble Granules, Tablets and | | | |
| Powders | | | |
| Oil Dispersions, Suspensions, | 1-50 | 40-99 | 0-50 |
| Emulsions, Solutions | | | |
| (including Emulsifiable | | | |
| Concentrates) | | | |
| Dusts | 1-25 | 70-99 | 0-5 |
| Granules and Pellets | 0.001-95 | 5-99.999 | 0-15 |
| High Strength Compositions | 90-99 | 0-10 | 0-2 |

Solid diluents include, for example, clays such as bentonite, montmorillonite, attapulgite and kaolin, gypsum, cellulose, titanium dioxide, zinc oxide, starch, dextrin, sugars (e.g., lactose, sucrose), silica, talc, mica, diatomaceous earth, urea, calcium carbonate, sodium carbonate and bicarbonate, and sodium sulfate. Typical solid diluents are described in Watkins et al., Handbook of Insecticide Dust Diluents and Carriers, 2nd Ed., Dorland Books, Caldwell, New Jersey.

Liquid diluents include, for example, water, N,N-dimethylalkanamides (e.g., N,N-dimethylformamide), limonene, dimethyl sulfoxide, N-alkylpyrrolidones (e.g., N-methylpyrrolidinone), alkyl phosphates (e.g., triethyl phosphate), ethylene glycol, triethylene glycol, propylene glycol, dipropylene glycol, polypropylene glycol, propylene carbonate, butylene carbonate, paraffins (e.g., white mineral oils, normal paraffins, isoparaffins), alkylbenzenes, alkylnaphthalenes, glycerine, glycerol triacetate, sorbitol, aromatic hydrocarbons, dearomatized aliphatics, alkylbenzenes, alkylnaphthalenes, ketones such as cyclohexanone, 2-heptanone, isophorone and 4-hydroxy-4-methyl-2-pentanone, acetates such as isoamyl acetate, hexyl acetate, heptyl acetate, octyl acetate, nonyl acetate, tridecyl acetate and isobornyl acetate, other esters such as alkylated lactate esters, dibasic esters, alkyl and aryl benzoates and 7-butyrolactone, and alcohols, which can be linear, branched, saturated or unsaturated, such as methanol, ethanol, n-propanol, isopropyl alcohol, n-butanol, isobutyl alcohol, n-hexanol, 2-ethylhexanol, n-octanol, decanol, isodecyl alcohol, isooctadecanol, cetyl alcohol, lauryl alcohol, tridecyl alcohol, oleyl alcohol, cyclohexanol, tetrahydrofurfuryl alcohol, diacetone alcohol, cresol and benzyl alcohol. Liquid diluents also include glycerol esters of saturated and unsaturated fatty acids (typically C₆-C₂₂), such as plant seed and fruit oils (e.g., oils of olive, castor, linseed, sesame, corn (maize), peanut, sunflower, grapeseed, safflower, cottonseed, soybean, rapeseed, coconut and palm kernel), animal-sourced fats (e.g., beef tallow, pork tallow, lard, cod liver oil, fish oil), and mixtures thereof. Liquid diluents also include alkylated fatty acids (e.g., methylated, ethylated, butylated) wherein the fatty acids may be obtained by hydrolysis of glycerol esters from plant and animal sources, and can be purified by distillation. Typical liquid diluents are described in Marsden, Solvents Guide, 2nd Ed., Interscience, New York, 1950.

The solid and liquid compositions of the present invention often include one or more surfactants. When added to a liquid, surfactants (also known as “surface-active agents”) generally modify, most often reduce, the surface tension of the liquid. Depending on the nature of the hydrophilic and lipophilic groups in a surfactant molecule, surfactants can be useful as wetting agents, dispersants, emulsifiers or defoaming agents.

Surfactants can be classified as nonionic, anionic or cationic. Nonionic surfactants useful for the present compositions include, but are not limited to: alcohol alkoxylates such as alcohol alkoxylates based on natural and synthetic alcohols (which may be branched or linear) and prepared from the alcohols and ethylene oxide, propylene oxide, butylene oxide or mixtures thereof, amine ethoxylates, alkanolamides and ethoxylated alkanolamides; alkoxylated triglycerides such as ethoxylated soybean, castor and rapeseed oils; alkylphenol alkoxylates such as octylphenol ethoxylates, nonylphenol ethoxylates, dinonyl phenol ethoxylates and dodecyl phenol ethoxylates (prepared from the phenols and ethylene oxide, propylene oxide, butylene oxide or mixtures thereof); block polymers prepared from ethylene oxide or propylene oxide and reverse block polymers where the terminal blocks are prepared from propylene oxide; ethoxylated fatty acids; ethoxylated fatty esters and oils; ethoxylated methyl esters; ethoxylated tristyrylphenol (including those prepared from ethylene oxide, propylene oxide, butylene oxide or mixtures thereof); fatty acid esters, glycerol esters, lanolin-based derivatives, polyethoxylate esters such as polyethoxylated sorbitan fatty acid esters, polyethoxylated sorbitol fatty acid esters and polyethoxylated glycerol fatty acid esters; other sorbitan derivatives such as sorbitan esters; polymeric surfactants such as random copolymers, block copolymers, alkyd peg (polyethylene glycol) resins, graft or comb polymers and star polymers; polyethylene glycols (pegs); polyethylene glycol fatty acid esters; silicone-based surfactants; and sugar-derivatives such as sucrose esters, alkyl polyglycosides; alkyl polysaccharides; and glucamides such as mixtures of octyl-N-methylglucamide and decyl-N-methylglucamide (e.g., products is obtainable under the Synergen® GA name from Clariant).

Useful anionic surfactants include, but are not limited to: alkylaryl sulfonic acids and their salts; carboxylated alcohol or alkylphenol ethoxylates; diphenyl sulfonate derivatives; lignin and lignin derivatives such as lignosulfonates; maleic or succinic acids or their anhydrides; olefin sulfonates; phosphate esters such as phosphate esters of alcohol alkoxylates, phosphate esters of alkylphenol alkoxylates and phosphate esters of styryl phenol ethoxylates; protein-based surfactants; sarcosine derivatives; styryl phenol ether sulfate; sulfates and sulfonates of oils and fatty acids; sulfates and sulfonates of ethoxylated alkylphenols; sulfates of alcohols; sulfates of ethoxylated alcohols; sulfonates of amines and amides such as N,N-alkyltaurates; sulfonates of benzene, cumene, toluene, xylene, and dodecyl and tridecylbenzenes; sulfonates of condensed naphthalenes; sulfonates of naphthalene and alkyl naphthalene; sulfonates of fractionated petroleum; sulfosuccinamates; and sulfosuccinates and their derivatives such as dialkyl sulfosuccinate salts.

Useful cationic surfactants include, but are not limited to: amides and ethoxylated amides; amines such as N-alkyl propanediamines, tripropylenetriamines and dipropylenetetramines, and ethoxylated amines, ethoxylated diamines and propoxylated amines (prepared from the amines and ethylene oxide, propylene oxide, butylene oxide or mixtures thereof); amine salts such as amine acetates and diamine salts; quaternary ammonium salts such as quaternary salts, ethoxylated quaternary salts and diquaternary salts; and amine oxides such as alkyldimethylamine oxides and bis-(2-hydroxyethyl)-alkylamine oxides.

Also useful for the present compositions are mixtures of nonionic and anionic surfactants or mixtures of nonionic and cationic surfactants. Nonionic, anionic and cationic surfactants and their recommended uses are disclosed in a variety of published references including McCutcheon's Emulsifiers and Detergents, annual American and International Editions published by McCutcheon's Division, The Manufacturing Confectioner Publishing Co.; Sisely and Wood, Encyclopedia of Surface Active Agents, Chemical Publ. Co., Inc., New York, 1964; and A. S. Davidson and B. Milwidsky, Synthetic Detergents, Seventh Edition, John Wiley and Sons, New York, 1987.

Compositions of this invention may also contain formulation auxiliaries and additives, known to those skilled in the art as formulation aids (some of which may be considered to also function as solid diluents, liquid diluents or surfactants). Such formulation auxiliaries and additives may control: pH (buffers), foaming during processing (antifoams such polyorganosiloxanes), sedimentation of active ingredients (suspending agents), viscosity (thixotropic thickeners), in-container microbial growth (antimicrobials), product freezing (antifreezes), color (dyes/pigment dispersions), wash-off (film formers or stickers), evaporation (evaporation retardants), and other formulation attributes. Film formers include, for example, polyvinyl acetates, polyvinyl acetate copolymers, polyvinylpyrrolidone-vinyl acetate copolymer, polyvinyl alcohols, polyvinyl alcohol copolymers and waxes. Examples of formulation auxiliaries and additives include those listed in McCutcheon's Volume 2: Functional Materials, annual International and North American editions published by McCutcheon's Division, The Manufacturing Confectioner Publishing Co.; and PCT Publication WO 03/024222.

Component (a1) and component (a2) and any other active ingredients are typically incorporated into the present compositions by dissolving the active ingredient in a solvent or by grinding in a liquid or dry diluent. Solutions, including emulsifiable concentrates, can be prepared by simply mixing the ingredients. If the solvent of a liquid composition intended for use as an emulsifiable concentrate is water-immiscible, an emulsifier is typically added to emulsify the active-containing solvent upon dilution with water. Active ingredient slurries, with particle diameters of up to 2,000 μm can be wet milled using media mills to obtain particles with average diameters below 3 μm. Aqueous slurries can be made into finished suspension concentrates (see, for example, U.S. Pat. No. 3,060,084) or further processed by spray drying to form water-dispersible granules. Dry formulations usually require dry milling processes, which produce average particle diameters in the 2 to 10 μm range. Dusts and powders can be prepared by blending and usually grinding (such as with a hammer mill or fluid-energy mill). Granules and pellets can be prepared by spraying the active material upon preformed granular carriers or by agglomeration techniques. See Browning, “Agglomeration”, Chemical Engineering, Dec. 4, 1967, pp 147-48, Perry's Chemical Engineer's Handbook, 4th Ed., McGraw-Hill, New York, 1963, pp 8-57 and following, and WO 91/13546. Pellets can be prepared as described in U.S. Pat. No. 4,172,714. Water-dispersible and water-soluble granules can be prepared as taught in U.S. Pat. Nos. 4,144,050, 3,920,442 and DE 3,246,493. Tablets can be prepared as taught in U.S. Pat. Nos. 5,180,587, 5,232,701 and 5,208,030. Films can be prepared as taught in GB 2,095,558 and U.S. Pat. No. 3,299,566.

One embodiment of the present invention relates to a method for controlling fungal pathogens, comprising diluting the fungicidal composition of the present invention (component (a1) and component (a2), formulated with surfactants, solid diluents and liquid diluents or a formulated mixture of component (a1) and component (a2), and at least one other fungicide) with water, and optionally adding an adjuvant to form a diluted composition, and contacting the fungal pathogen or its environment with an effective amount of said diluted composition.

Although a spray composition formed by diluting with water a sufficient concentration of the present fungicidal composition can provide sufficient efficacy for controlling fungal pathogens, separately formulated adjuvant products can also be added to spray tank mixtures. These additional adjuvants are commonly known as “spray adjuvants” or “tank-mix adjuvants”, and include any substance mixed in a spray tank to improve the performance of a pesticide or alter the physical properties of the spray mixture. Adjuvants can be anionic or nonionic surfactants, emulsifying agents, petroleum-based crop oils, crop-derived seed oils, acidifiers, buffers, thickeners or defoaming agents. Adjuvants are used to enhancing efficacy (e.g., biological availability, adhesion, penetration, uniformity of coverage and durability of protection), or minimizing or eliminating spray application problems associated with incompatibility, foaming, drift, evaporation, volatilization and degradation. To obtain optimal performance, adjuvants are selected with regard to the properties of the active ingredient, formulation and target (e.g., crops, insect pests).

The amount of adjuvants added to spray mixtures is generally in the range of about 0.1% to 2.5% by volume. The application rates of adjuvants added to spray mixtures are typically between about 1 to 5 L per hectare. Representative examples of spray adjuvants include: Adigor® (Syngenta) 47% methylated rapeseed oil in liquid hydrocarbons, Silwet® (Helena Chemical Company) polyalkyleneoxide modified heptamethyltrisiloxane and Assist® (BASF) 17% surfactant blend in 83% paraffin based mineral oil.

One method of seed treatment is by spraying or dusting the seed with a compound of the invention (i.e. as a formulated composition) before sowing the seeds. Compositions formulated for seed treatment generally comprise a film former or adhesive agent. Therefore typically a seed coating composition of the present invention comprises a biologically effective amount of component (a1) and component (a2) and a film former or adhesive agent. Seeds can be coated by spraying a flowable suspension concentrate directly into a tumbling bed of seeds and then drying the seeds. Alternatively, other formulation types such as wetted powders, solutions, suspoemulsions, emulsifiable concentrates and emulsions in water can be sprayed on the seed. This process is particularly useful for applying film coatings on seeds. Various coating machines and processes are available to one skilled in the art. Suitable processes include those listed in P. Kosters et al., Seed Treatment: Progress and Prospects, 1994 BCPC Mongraph No. 57, and references listed therein.

For further information regarding the art of formulation, see T. S. Woods, “The Formulator's Toolbox—Product Forms for Modern Agriculture” in Pesticide Chemistry and Bioscience, The Food-Environment Challenge, T. Brooks and T. R. Roberts, Eds., Proceedings of the 9th International Congress on Pesticide Chemistry, The Royal Society of Chemistry, Cambridge, 1999, pp. 120-133. Also see U.S. Pat. No. 3,235,361, Col. 6, line 16 through Col. 7, line 19 and Examples 10-41; U.S. Pat. No. 3,309,192, Col. 5, line 43 through Col. 7, line 62 and Examples 8, 12, 15, 39, 41, 52, 53, 58, 132, 138-140, 162-164, 166, 167 and 169-182; U.S. Pat. No. 2,891,855, Col. 3, line 66 through Col. 5, line 17 and Examples 1-4; Klingman, Weed Control as a Science, John Wiley and Sons, Inc., New York, 1961, pp 81-96; Hance et al., Weed Control Handbook, 8th Ed., Blackwell Scientific Publications, Oxford, 1989; and Developments in formulation technology, PJB Publications, Richmond, U K, 2000.

Water-soluble and water-dispersible formulations are typically diluted with water to form aqueous compositions before application. Aqueous compositions for direct applications to the plant or portion thereof (e.g., spray tank compositions) typically contain at least about 1 ppm or more (e.g., from 1 ppm to 100 ppm) of the compound(s) of this invention.

Seed is normally treated at a rate of from about 0.001 g (more typically about 0.1 g) to about 10 g per kilogram of seed (i.e. from about 0.0001 to 1% by weight of the seed before treatment). A flowable suspension formulated for seed treatment typically comprises from about 0.5 to about 70% of the active ingredient, from about 0.5 to about 30% of a film-forming adhesive, from about 0.5 to about 20% of a dispersing agent, from 0 to about 5% of a thickener, from 0 to about 5% of a pigment and/or dye, from 0 to about 2% of an antifoaming agent, from 0 to about 1% of a preservative, and from 0 to about 75% of a volatile liquid diluent.

The compositions of this invention are useful as plant disease control agents. The present invention therefore further comprises a method for controlling plant diseases caused by fungal plant pathogens comprising applying to the plant or portion thereof to be protected, or to the plant seed to be protected, an effective amount of a compound of the invention or a fungicidal composition containing said compound. The compounds and/or compositions of this invention provide control of diseases caused by a broad spectrum of fungal plant pathogens in the Ascomycota, Basidiomycota, Zygomycota phyla, and the fungal-like Oomycota class. They are effective in controlling a broad spectrum of plant diseases, particularly foliar pathogens of ornamental, turf, vegetable, field, cereal, and fruit crops. These pathogens include but are not limited to those listed in Table 1-1. For Ascomycetes and Basidiomycetes, names for both the sexual/teleomorph/perfect stage as well as names for the asexual/anamorph/imperfect stage (in parentheses) are listed where known. Synonymous names for pathogens are indicated by an equal sign. For example, the sexual/teleomorph/perfect stage name Phaeosphaeria nodorum is followed by the corresponding asexual/anamorph/imperfect stage name Stagnospora nodorum and the synonymous older name Septoria nodorum.

TABLE 1-1
Ascomycetes in the order Pleosporales including Alternaria solani, A. alternata and A. brassicae,
Guignardia bidwellii, Venturia inaequalis, Pyrenophora tritici-repentis (Dreschlera tritici-repentis =
Helminthosporium tritici-repentis) and Pyrenophora teres (Dreschlera teres = Helminthosporium
teres), Corynespora cassiicola, Phaeosphaeria nodorum (Stagonospora nodorum = Septoria
nodorum), Cochliobolus carbonum and C. heterostrophus, Leptosphaeria biglobosa and L.
maculans;
Ascomycetes in the order Mycosphaerellales including Mycosphaerella graminicola (Zymoseptoria
tritici = Septoria tritici), M. berkeleyi (Cercosporidium personatum), M. arachidis (Cercospora
arachidicola), Passalora sojina (Cercospora sojina), Cercospora zeae-maydis and C. beticola;
Ascomycetes in the order Erysiphales (the powdery mildews) such as Blumeria graminis f.sp. tritici
and Blumeria graminis f.sp. hordei, Erysiphe polygoni, E. necator (=Uncinula necator),
Podosphaera fuliginea (=Sphaerotheca fuliginea), and Podosphaera leucotricha (=Sphaerotheca
fuliginea);
Ascomycetes in the order Helotiales such as Botryotinia fuckeliana (Botrytis cinerea), Oculimacula
yallundae (=Tapesia yallundae; anamorph Helgardia herpotrichoides = Pseudocercosporella
herpetrichoides), Monilinia fructicola, Sclerotinia sclerotiorum, Sclerotinia minor, and Sclerotinia
homoeocarpa;
Ascomycetes in the order Hypocreales such as Giberella zeae (Fusarium graminearum), G.
monoliformis (Fusarium moniliforme), Fusarium solani and Verticillium dahliae;
Ascomycetes in the order Eurotiales such as Aspergillus flavus and A. parasiticus;
Ascomycetes in the order Diaporthales such as Cryptosphorella viticola (=Phomopsis viticola),
Phomopsis longicolla, and Diaporthe phaseolorum;
Other Ascomycete pathogens including Magnaporthe grisea, Gaeumannomyces graminis,
Rhynchosporium secalis, and anthracnose pathogens such as Glomerella acutata (Colletotrichum
acutatum), G. graminicola (C. graminicola) and G. lagenaria (C. orbiculare);
Basidiomycetes in the order Urediniales (the rusts) including Puccinia recondita, P. striiformis,
Puccinia hordei, P. graminis and P. arachidis), Hemileia vastatrix and Phakopsora pachyrhizi;
Basidiomycetes in the order Ceratobasidiales such as Thanatophorum cucumeris (Rhizoctonia solani)
and Ceratobasidium oryzae-sativae (Rhizoctonia oryzae);
Basidiomycetes in the order Polyporales such as Athelia rolfsii (Sclerotium rolfsii);
Basidiomycetes in the order Ustilaginales such as Ustilago maydis;
Zygomycetes in the order Mucorales such as Rhizopus stolonifer;
Oomycetes in the order Pythiales, including Phytophthora infestans, P. megasperma, P. parasitica,
P. sojae, P. cinnamomi and P. capsici, and Pythium pathogens such as Pythium aphanidermatum, P.
graminicola, P. irregulare, P. ultimum and P. dissoticum;
Oomycetes in the order Peronosporales such as Plasmopara viticola, P. halstedii, Peronospora
hyoscyami (=Peronospora tabacina), P. manshurica, Hyaloperonospora parasitica (=Peronospora
parasitica), Pseudoperonospora cubensis and Bremia lactucae;
and other genera and species closely related to all of the above pathogens.

In addition to their fungicidal activity, the compositions or combinations also have activity against bacteria such as Erwinia amylovora, Xanthomonas campestris, Pseudomonas syringae, and other related species. By controlling harmful microorganisms, the compositions of this invention are useful for improving (i.e. increasing) the ratio of beneficial to harmful microorganisms in contact with crop plants or their propagules (e.g., seeds, corms, bulbs, tubers, cuttings) or in the agronomic environment of the crop plants or their propagules.

Compositions of this invention are useful in treating all plants, plant parts and seeds. Plant and seed varieties and cultivars can be obtained by conventional propagation and breeding methods or by genetic engineering methods. Genetically modified plants or seeds (transgenic plants or seeds) are those in which a heterologous gene (transgene) has been stably integrated into the plant's or seed's genome. A transgene that is defined by its particular location in the plant genome is called a transformation or transgenic event.

Genetically modified plant cultivars which can be treated according to the invention include those that are resistant against one or more biotic stresses (pests such as nematodes, insects, mites, fungi, etc.) or abiotic stresses (drought, cold temperature, soil salinity, etc.), or that contain other desirable characteristics. Plants can be genetically modified to exhibit traits of, for example, herbicide tolerance, insect-resistance, modified oil profiles or drought tolerance.

Treatment of genetically modified plants and seeds with compounds of the invention may result in super-additive or enhanced effects. For example, reduction in application rates, broadening of the activity spectrum, increased tolerance to biotic/abiotic stresses or enhanced storage stability may be greater than expected from just simple additive effects of the application of compounds of the invention on genetically modified plants and seeds.

Compounds and compositions of this invention are useful in seed treatments for protecting seeds from plant diseases. In the context of the present disclosure and claims, treating a seed means contacting the seed with a biologically effective amount of a compound of this invention, which is typically formulated as a composition of the invention. This seed treatment protects the seed from soil-borne disease pathogens and generally can also protect roots and other plant parts in contact with the soil of the seedling developing from the germinating seed. The seed treatment may also provide protection of foliage by translocation of the compound of this invention or a second active ingredient within the developing plant. Seed treatments can be applied to all types of seeds, including those from which plants genetically transformed to express specialized traits will germinate. Representative examples include those expressing proteins toxic to invertebrate pests, such as Bacillus thuringiensis toxin or those expressing herbicide resistance such as glyphosate acetyltransferase, which provides resistance to glyphosate. Seed treatments with compounds and compositions of this invention can also increase vigor of plants growing from the seed.

Compounds and compositions of this invention are particularly useful in seed treatment for crops including, but not limited to, maize or corn, soybeans, cotton, cereal (e.g., wheat, oats, barley, rye and rice), potatoes, vegetables and oilseed rape.

Furthermore, the compounds and compositions of this invention are useful in treating postharvest diseases of fruits and vegetables caused by fungi, oomycetes and bacteria. These infections can occur before, during and after harvest. For example, infections can occur before harvest and then remain dormant until some point during ripening (e.g., host begins tissue changes in such a way that infection can progress or conditions become conducive for disease development); also infections can arise from surface wounds created by mechanical or insect injury. In this respect, the compositions of this invention can reduce losses (i.e. losses resulting from quantity and quality) due to postharvest diseases which may occur at any time from harvest to consumption. Treatment of postharvest diseases with compounds of the invention can increase the period of time during which perishable edible plant parts (e.g., fruits, seeds, foliage, stems, bulbs, tubers) can be stored refrigerated or un-refrigerated after harvest, and remain edible and free from noticeable or harmful degradation or contamination by fungi or other microorganisms. Treatment of edible plant parts before or after harvest with compounds of the invention can also decrease the formation of toxic metabolites of fungi or other microorganisms, for example, mycotoxins such as aflatoxins.

Plant disease control is ordinarily accomplished by applying an effective amount of a compound of this invention either pre- or post-infection, to the portion of the plant to be protected such as the roots, stems, foliage, fruits, seeds, tubers or bulbs, or to the media (soil or sand) in which the plants to be protected are growing. The compounds can also be applied to seeds to protect the seeds and seedlings developing from the seeds. The compounds can also be applied through irrigation water to treat plants. Control of postharvest pathogens which infect the produce before harvest is typically accomplished by field application of a compound of this invention, and in cases where infection occurs after harvest the compounds can be applied to the harvested crop as dips, sprays, fumigants, treated wraps and box liners.

The compounds and compositions of this invention can also be applied using an unmanned aerial vehicle (UAV) for the dispersion of the compositions disclosed herein over a planted area. In some embodiments the planted area is a crop-containing area. In some embodiments, the crop is selected from a monocot or dicot. In some embodiments, the crop is selected form rice, corn, barley, soybean, wheat, vegetable, tobacco, tea tree, fruit tree and sugar cane. In some embodiments, the compositions disclosed herein are formulated for spraying at an ultra-low volume. Products applied by drones may use water or oil as the spray carrier. Typical spray volume (including product) used for drone applications globally. 5.0 liters/ha-100 liters/ha (approximately 0.5-10 gpa). This includes the range of ultra low spray volume (ULV) to low spray volume (LV). Although not common there may be situations where even lower spray volumes could be used as low as 1.0 liter/ha (0.1 gpa).

Suitable rates of application (e.g., fungicidally effective amounts) of component (a1) and component (a2), as well as suitable rates of application (e.g., biologically effective amounts, fungicidally effective amounts or insecticidally effective amounts) for the mixtures and compositions comprising component (a1) and component (a2) according to this invention can be influenced by factors such as the plant diseases to be controlled (including diseases developing from known resistant strains of fungi) plant species to be protected, the population structure of the pathogen to be controlled, ambient moisture and temperature and should be determined under actual use conditions. One skilled in the art can easily determine through simple experimentation the fungicidally effective amount necessary for the desired level of plant disease control. Foliage can normally be protected when treated at a rate of from less than about 1 g/ha to about 5,000 g/ha of active ingredient. Seed and seedlings can normally be protected when seed is treated at a rate of from about 0.001 g (more typically about 0.1 g) to about 10 g per kilogram of seed. One skilled in the art can easily determine through simple experimentation the application rates of component (a1) and component (a2), and mixtures and compositions thereof, containing particular combinations of active ingredients according to this invention needed to provide the desired spectrum of plant protection and control of plant diseases and optionally other plant pests.

Compounds and compositions of the present invention may also be useful for increasing vigor of a crop plant. This method comprises contacting the crop plant (e.g., foliage, flowers, fruit or roots) or the seed from which the crop plant is grown with a composition comprising component (a1) and component (a2) in amount sufficient to achieve the desired plant vigor effect (i.e. biologically effective amount). Typically component (a1) and component (a2) are applied in a formulated composition. Although component (a1) and component (a2) are often applied directly to the crop plant or its seed, they can also be applied to the locus of the crop plant, i.e. the environment of the crop plant, particularly the portion of the environment in close enough proximity to allow component (a1) and component (a2) to migrate to the crop plant. The locus relevant to this method most commonly comprises the growth medium (i.e. medium providing nutrients to the plant), typically soil in which the plant is grown. Treatment of a crop plant to increase vigor of the crop plant thus comprises contacting the crop plant, the seed from which the crop plant is grown or the locus of the crop plant with a biologically effective amount of component (a1) and component (a2).

Increased crop vigor can result in one or more of the following observed effects: (a) optimal crop establishment as demonstrated by excellent seed germination, crop emergence and crop stand; (b) enhanced crop growth as demonstrated by rapid and robust leaf growth (e.g., measured by leaf area index), plant height, number of tillers (e.g., for rice), root mass and overall dry weight of vegetative mass of the crop; (c) improved crop yields, as demonstrated by time to flowering, duration of flowering, number of flowers, total biomass accumulation (i.e. yield quantity) and/or fruit or grain grade marketability of produce (i.e. yield quality); (d) enhanced ability of the crop to withstand or prevent plant disease infections and arthropod, nematode or mollusk pest infestations; and (e) increased ability of the crop to withstand environmental stresses such as exposure to thermal extremes, suboptimal moisture or phytotoxic chemicals.

The compounds and compositions of the present invention may increase the vigor of treated plants compared to untreated plants by preventing and/or curing plant diseases caused by fungal plant pathogens in the environment of the plants. In the absence of such control of plant diseases, the diseases reduce plant vigor by consuming plant tissues or sap, or transmitting plant pathogens such as viruses. Even in the absence of fungal plant pathogens, the compounds of the invention may increase plant vigor by modifying metabolism of plants. Generally, the vigor of a crop plant will be most significantly increased by treating the plant with a compound of the invention if the plant is grown in a nonideal environment, i.e. an environment comprising one or more aspects adverse to the plant achieving the full genetic potential it would exhibit in an ideal environment.

Of note is a method for increasing vigor of a crop plant wherein the crop plant is grown in an environment comprising plant diseases caused by fungal plant pathogens. Also of note is a method for increasing vigor of a crop plant wherein the crop plant is grown in an environment not comprising plant diseases caused by fungal plant pathogens. Also of note is a method for increasing vigor of a crop plant wherein the crop plant is grown in an environment comprising an amount of moisture less than ideal for supporting growth of the crop plant.

Compounds and compositions of this invention can also be mixed with one or more other biologically active compounds or agents including fungicides, insecticides, nematicides, bactericides, acaricides, herbicides, herbicide safeners, growth regulators such as insect molting inhibitors and rooting stimulants, chemosterilants, semiochemicals, repellents, attractants, pheromones, feeding stimulants, plant nutrients, other biologically active compounds or entomopathogenic bacteria, virus or fungi to form a multi-component pesticide giving an even broader spectrum of agricultural protection. Thus the present invention also pertains to a composition comprising component (a1) and component (a2) (in a fungicidally effective amount) and at least one additional biologically active compound or agent (in a biologically effective amount) and can further comprise at least one of a surfactant, a solid diluent or a liquid diluent. The other biologically active compounds or agents can be formulated in compositions comprising at least one of a surfactant, solid or liquid diluent. For mixtures of the present invention, one or more other biologically active compounds or agents can be formulated together with component (a1) and component (a2), to form a premix, or one or more other biologically active compounds or agents can be formulated separately from component (a1) and component (a2), and the formulations combined together before application (e.g., in a spray tank) or, alternatively, applied in succession.

As mentioned in the Summary of the Invention, one aspect of the present invention is a fungicidal composition comprising component (a1) and component (a2), and at least one other fungicide (i.e. component (b)). Of note is such a combination where the other fungicidal active ingredient has different site of action from component (a1) and/or component (a2). In certain instances, a combination with at least one other fungicidal active ingredient having a similar spectrum of control but a different site of action will be particularly advantageous for resistance management. Thus, a composition of the present invention can further comprise a fungicidally effective amount of at least one additional fungicidal active ingredient having a similar spectrum of control but a different site of action.

Examples of component (b) fungicides include acibenzolar-S-methyl, aldimorph, ametoctradin, amisulbrom, anilazine, azaconazole, azoxystrobin, benalaxyl (including benalaxyl-M), benodanil, benomyl, benthiavalicarb (including benthiavalicarb-isopropyl), benzovindiflupyr, bethoxazin, binapacryl, biphenyl, bitertanol, bixafen, blasticidin-S, boscalid, bromuconazole, bupirimate, buthiobate, captafol, captan, carbendazim, carboxin, carpropamid, chloroneb, chlorothalonil, chlozolinate, clotrimazole, copper hydroxide, copper oxychloride, copper sulfate, coumoxystrobin, cyazofamid, cyflufenamid, cymoxanil, cyproconazole, cyprodinil, dichlofluanid, diclocymet, diclomezine, dicloran, diethofencarb, difenoconazole, diflumetorim, dimethirimol, dimethomorph, dimoxystrobin, diniconazole (including diniconazole-M), dinocap, dithianon, dithiolanes, dodemorph, dodine, dipymetitrone, econazole, edifenphos, enoxastrobin (also known as enestroburin), epoxiconazole, etaconazole, ethaboxam, ethirimol, etridiazole, famoxadone, fenamidone, fenarimol, fenaminstrobin, fenbuconazole, fenfuram, fenhexamid, fenoxanil, fenpiclonil, fenpropidin, fenpropimorph, fenpyrazamine, fentin acetate, fentin chloride, fentin hydroxide, ferbam, ferimzone, flometoquin, florylpicoxamid, fluazinam, fludioxonil, flufenoxystrobin, fluindapyr, flumorph, fluopicolide, fluopimomide, fluopyram, fluoroimide, fluoxastrobin, fluquinconazole, flusilazole, flusulfamide, flutianil, flutolanil, flutriafol, fluxapyroxad, folpet, fthalide, fuberidazole, furalaxyl, furametpyr, guazatine, hexaconazole, hymexazole, imazalil, imibenconazole, iminoctadine albesilate, iminoctadine triacetate, iodocarb, ipconazole, ipfentrifluconazole, iprobenfos, iprodione, iprovalicarb, isoconazole, isofetamid, isoprothiolane, isoflucypram, isopyrazam, isotianil, kasugamycin, kresoxim-methyl, mancozeb, mandipropamid, mandestrobin, maneb, mepanipyrim, mepronil, meptyldinocap, metalaxyl (including metalaxyl-M/mefenoxam), mefentrifluconazole, metconazole, methasulfocarb, metiram, metominostrobin, metrafenone, miconazole, myclobutanil, naftifine, neo-asozin, nuarimol, octhilinone, ofurace, orysastrobin, oxadixyl, oxathiapiprolin, oxolinic acid, oxpoconazole, oxycarboxin, oxytetracycline, pefurazoate, penconazole, pencycuron, penflufen, penthiopyrad, phosphorous acid (including salts thereof, e.g., fosetyl-aluminum), picarbutrazox, picoxystrobin, piperalin, polyoxin, probenazole, prochloraz, procymidone, propamocarb, propiconazole, propineb, proquinazid, prothiocarb, prothioconazole, pyraclostrobin, pyrametostrobin, pyraoxystrobin, pyrazophos, pyribencarb, pyributicarb, pyrifenox, pyrimethanil, pyriofenone, pyrisoxazole, pyroquilon, pyrrolnitrin, quinconazole, quinofumelin (Registry Number 861647-84-9) quinomethionate, quinoxyfen, quintozene, sedaxane, silthiofam, simeconazole, spiroxamine, streptomycin, sulfur, tebuconazole, tebufloquin, tecloftalam, tecnazene, terbinafine, tetraconazole, thiabendazole, thifluzamide, thiophanate, thiophanate-methyl, thiram, tiadinil, tolclofos-methyl, tolnifanide, tolprocarb, tolyfluanid, triadimefon, triadimenol, triarimol, triticonazole, triazoxide, tribasic copper sulfate, tricyclazole, triclopyricarb, tridemorph, trifloxystrobin, triflumizole, triforine, trimorphamide, uniconazole, uniconazole-P, validamycin, valifenalate (also known as valiphenal), vinclozolin, zineb, ziram, zoxamide, N-[2-(1S,2R)-[1,1′-bicyclopropyl]-2-ylphenyl]-3-(difluoromethyl)-1-methyl-1H-pyrazole-4-carboxamide, α-(1-chlorocyclopropyl)-α-[2-(2,2-dichlorocyclopropyl)-ethyl]-1H-1,2,4-triazole-1-ethanol, (αS)-[3-(4-chloro-2-fluorophenyl)-5-(2,4-difluorophenyl)-4-isoxazolyl]-3-pyridinemethanol, rel-1-[[(2R,3S)-3-(2-chlorophenyl)-2-(2,4-difluorophenyl)-2-oxiranyl]methyl]-1H-1,2,4-triazole, rel-2-[[(2R,3S)-3-(2-chlorophenyl)-2-(2,4-difluorophenyl)-2-oxiranyl]methyl]-1,2-dihydro-3H-1,2,4-triazole-3-thione, rel-1-[[(2R,3S)-3-(2-chlorophenyl)-2-(2,4-difluorophenyl)-2-oxiranyl]methyl]-5-(2-propen-1-ylthio)-1H-1,2,4-triazole, N-[2-[4-[[3-(4-chlorophenyl)-2-propyn-1-yl]oxy]-3-methoxyphenyl]ethyl]-3-methyl-2-[(methylsulfonyl)-amino]butanamide, N-[2-[4-[[3-(4-chlorophenyl)-2-propyn-1-yl]oxy]-3-methoxyphenyl]ethyl]-3-methyl-2-[(ethylsulfonyl)amino]butanamide, N-[4-[4-chloro-3-(trifluoromethyl)phenoxy]-2,5-dimethylphenyl]-N-ethyl-N-methylmethanimidamide, N-[2-(2,4-dichlorophenyl)-2-methoxy-1-methylethyl]-3-(difluoromethyl)-1-methyl-1H-pyrazole-4-carboxamide, N-(3′,4′-difluoro[1,1′-biphenyl]-2-yl)-3-(trifluoromethyl)-2-pyrazinecarboxamide, 3-(difluoromethyl)-N-(2,3-dihydro-1,1,3-trimethyl-1H-inden-4-yl)-1-methyl-1H-pyrazole-4-carboxamide, 5,8-difluoro-N-[2-[3-methoxy-4-[[4-(trifluoromethyl)-2-pyridinyl]oxy]phenyl]ethyl]-4-quinazolinamine, 1-[4-[4-[5R-[(2,6-difluorophenoxy)methyl]-4,5-dihydro-3-isoxazolyl]-2-thiazolyl]-1-piperdinyl]-2-[5-methyl-3-(trifluoromethyl)-1H-pyrazol-1-yl]ethanone, 4-fluorophenyl N-[1-[[[1-(4-cyano-phenyl)ethyl]sulfonyl]methyl]propyl]carbamate, 5-fluoro-2-[(4-fluorophenyl)methoxy]-4-pyrimidinamine, α-(methoxyimino)-N-methyl-2-[[[1-[3-(trifluoromethyl)phenyl]ethoxy]imino]-methyl]benzeneacetamide, and [[4-methoxy-2-[[[(3S,7R,8R,9S)-9-methyl-8-(2-methyl-1-oxopro-poxy)-2,6-dioxo-7-(phenylmethyl)-1,5-dioxonan-3-yl]amino]carbonyl]-3-pyridinyl]oxy]methyl 2-methylpropanoate. Therefore of note is a fungicidal composition comprising component (a1) and component (a2) and as component (b) at least one fungicide selected from the preceding list.

Of particular note are combinations of component (a1) and component (a2) with component (b) compounds selected from aminopyrifen (Registry Number 1531626-08-0), azoxystrobin, benzovindiflupyr, bixafen, captan, carpropamid, chlorothalonil, copper hydroxide, copper oxychloride, copper sulfate, cymoxanil, cyproconazole, cyprodinil, dichlobentiazox (Registry Number 957144-77-3), diethofencarb, difenoconazole, dimethomorph, dipymetitrone, epoxiconazole, ethaboxam, fenarimol, fenhexamid, fluazinam, fludioxonil, fluindapyr, fluopyram, flusilazole, flutianil, flutriafol, fluxapyroxad, folpet, ipflufenoquin (Registry Number 1314008-27-9), iprodione, isofetamid, isoflucypram, isopyrazam, kresoxim-methyl, mancozeb, mandestrobin, meptyldinocap, metalaxyl (including metalaxyl-M/mefenoxam), mefentrifluconazole, metconazole, metrafenone, metyltetraprole (Registry Number 1472649-01-6), myclobutanil, oxathiapiprolin, penflufen, penthiopyrad, phosphorous acid (including salts thereof, e.g., fosetyl-aluminum), picoxystrobin, propiconazole, proquinazid, prothioconazole, pyridachlometyl (Registry Number 1358061-55-8), pyraclostrobin, pyrapropoyne (Registry Number 1803108-03-3), pyrimethanil, sedaxane spiroxamine, sulfur, tebuconazole, thiophanate-methyl, trifloxystrobin, zoxamide, α-(1-chlorocyclopropyl)-α-[2-(2,2-dichlorocyclo-propyl)ethyl]-1H-1,2,4-triazole-1-ethanol, N-[2-(2,4-dichlorophenyl)-2-methoxy-1-methylethyl]-3-(difluoromethyl)-1-methyl-1H-pyrazole-4-carboxamide, 3-(difluoromethyl)-N-(2,3-dihydro-1,1,3-trimethyl-1H-inden-4-yl)-1-methyl-1H-pyrazole-4-carboxamide, 1-[4-[4-[5R-(2,6-difluorophenyl)-4,5-dihydro-3-isoxazolyl]-2-thiazolyl]-1-piperidinyl]-2-[5-methyl-3-(trifluoromethyl)-1H-pyrazol-1-yl]ethanone, 1,1-dimethylethyl N-[6-[[[[(1-methyl-1H-tetrazol-5-yl)phenylmethylene]amino]oxy]methyl]-2-pyridinyl]carbamate, 5-fluoro-2-[(4-fluorophenyl)-methoxy]-4-pyrimidinamine, (aS)-[3-(4-chloro-2-fluorophenyl)-5-(2,4-difluorophenyl)-4-isoxazolyl]-3-pyridinemethanol, rel-1-[[(2R,3S)-3-(2-chlorophenyl)-2-(2,4-difluorophenyl)-2-oxiranyl]methyl]-1H-1,2,4-triazole, rel-2-[[(2R,3S)-3-(2-chlorophenyl)-2-(2,4-difluorophenyl)-2-oxiranyl]methyl]-1,2-dihydro-3H-1,2,4-triazole-3-thione, and rel-1-[[(2R,3S)-3-(2-chloro-phenyl)-2-(2,4-difluorophenyl)-2-oxiranyl]methyl]-5-(2-propen-1-ylthio)-1H-1,2,4-triazole (i.e. as Component (b) in compostions).

Generally preferred for better control of plant diseases caused by fungal plant pathogens (e.g., lower use rate or broader spectrum of plant pathogens controlled) or resistance management are mixtures of component (a1) and component (a2) with a fungicidal compound selected from the group: azoxystrobin, benzovindiflupyr, bixafen, boscalid, carbendazim, chlorothalonil, copper sulfate, cymoxanil, cyproconazole, difenoconazole, dimethomorph, dimoxystrobin, epoxiconazole, fenpropimorph, florylpicoxamid, fludioxonil, fluindapyr, fluquinconazole, fluopicolide, fluoxastrobin, flutriafol, fluxapyroxad, inpyrfluxam, ipfentrifluconazole, iprodione, isoflucypram, kresoxim-methyl, mancozeb, metalaxyl, mefentrifluconazole, metconazole, metominostrobin, picoxystrobin, prothioconazole, pydiflumetofen, pyraclostrobin, pyrametostrobin, pyraoxystrobin, pyriofenone, sedaxane, silthiofam, tebuconazole, thiabendazole, thiophanate-methyl, trifloxystrobin and triticonazole.

In the fungicidal compositions of the present invention, component (a1) and component (a2) and component (b) are present in fungicidally effective amounts. The weight ratio of component (a1) and/or component (a2) to component (b) (i.e. one or more additional fungicidal compounds) is generally between about 1:3000 to about 3000:1, and more typically between about 1:500 to about 500:1. Of note are compositions wherein the weight ratio of component (a1) and/or component (a2) to component (b) is from about 125:1 to about 1:125. Of particular note are compositions wherein the weight ratio of component (a1) and/or component (a2) to component (b) is from about 25:1 to about 1:25, or from about 5:1 to about 1:5. One skilled in the art can easily determine through simple experimentation the weight ratios and application rates of fungicidal compounds necessary for the desired spectrum of fungicidal protection and control. It will be evident that including additional fungicidal compounds in component (b) may expand the spectrum of plant diseases controlled beyond the spectrum controlled by component (a1) and/or component (a2) alone. Furthermore, Tables A1, B1, and C1 exemplify weight ratio combinations of fungicidal compounds of the present invention. Additionally, Table B1 lists typical, more typical and most typical ranges of ratios involving particular fungicidal compounds of component (b).

In the fungicidal compositions of the present invention, component (a1) and component (a2) are present in synergistically effective amounts. The weight ratio of component (a1) to component (a2) is generally between about 1:3000 to about 3000:1, and more typically between about 1:500 to about 500:1. Of note are compositions wherein the weight ratio of component (a1) to component (a2) is from about 125:1 to about 1:125. Of particular note are compositions wherein the weight ratio of component (a1) to component (a2) to is from about 25:1 to about 1:25, or from about 5:1 to about 1:5.

In some embodiments, component (a1) and component (a2) are present and/or applied in a ratio of component (a1):component (a2) in the range of from about 30:1, about 29:1, about 28:1, about 27:1, about 26:1, about 25:1, about 24:1, about 23:1, about 22:1, about 21:1, about 20:1, about 19:1, about 18:1, about 17:1, about 16:1, about 15:1, about 14:1, about 13:1, about 12:1, about 11:1, about 10:1, about 9:1, about 8:1, about 7:1, about 6:1, about 5:1, about 4:1, about 3:1, about 2:1, about 1.75:1, about 1.5:1, about 1.25:1, or about 1:1 to about 1:2, about 1:3, about 1:4, about 1:5, about 1:6, about 1:7, about 1:8, about 1:9, about 1:10, about 1:11, about 1:12, about 1:13, about 1:14, about 1:15, about 1:16, about 1:17, about 1:18, about 1:19, about 1:20, about 1:21, about 1:22, about 1:23, about 1:24, about 1:25, about 1:26, about 1:27, about 1:28, about 1:29, or about 1:30.

As noted above, the present invention includes embodiments wherein the composition comprises components (a1) and (a2) and (b), wherein component (b) comprises at least one fungicidal compound selected from (b1) through (b54). Of particular note is a composition of the present invention wherein component (b) has a different site of action from component (a1) and/or component (a2). In certain instances, a combination with at least one other fungicidal compound having a similar spectrum of control but a different site of action will be particularly advantageous for resistance management. Thus, a composition of the present invention can advantageously comprise at least one fungicidal active compound selected from the group consisting of (b1) through (b54) as described above, having a similar spectrum of control but a different site of action then component (a1) and/or component (a2).

Compositions of component (a1) and component (a2), or component (a1) and component (a2) with component (b), can be further mixed with one or more other biologically active compounds or agents including insecticides, nematocides, bactericides, acaricides, herbicides, herbicide safeners, growth regulators such as insect molting inhibitors and rooting stimulants, chemosterilants, semiochemicals, repellents, attractants, pheromones, feeding stimulants, plant nutrients, other biologically active compounds or entomopathogenic bacteria, virus or fungi to form a multi-component pesticide giving an even broader spectrum of agricultural protection. Thus the present invention also pertains to a composition comprising a fungicidally effective amount of component (a1) and component (a2), or a mixture of component (a1) and component (a2) with component (b), and a biologically effective amount of at least one additional biologically active compound or agent and can further comprise at least one of a surfactant, a solid diluent or a liquid diluent. The other biologically active compounds or agents can also be separately formulated in compositions comprising at least one of a surfactant, solid or liquid diluent. For compositions of the present invention, one or more other biologically active compounds or agents can be formulated together with one or both of components (a1) and (a2) and (b) to form a premix, or one or more other biologically active compounds or agents can be formulated separately from components (a1) and (a2) and (b) and the formulations combined together before application (e.g., in a spray tank) or, alternatively, applied in succession.

Examples of such biologically active compounds or agents with which compositions of component (a1) and component (a2), or component (a1) and component (a2) with component (b), can be formulated are: insecticides such as abamectin, acephate, acequinocyl, acetamiprid, acrinathrin, acynonapyr, afidopyropen, amidoflumet, amitraz, avermectin, azadirachtin, azinphos-methyl, benfuracarb, bensultap, benzpyrimoxan, bifenthrin, kappa-bifenthrin, bifenazate, bistrifluron, borate, broflanilide, buprofezin, cadusafos, carbaryl, carbofuran, cartap, carzol, chlorantraniliprole, chlorfenapyr, chlorfluazuron, chloroprallethrin, chlorpyrifos, chlorpyrifos-e, chlorpyrifos-methyl, chromafenozide, clofentezine, chloroprallethrin, clothianidin, cyantraniliprole, cyclaniliprole, cycloprothrin, cycloxaprid, cyenopyrafen, cyflumetofen, cyfluthrin, beta-cyfluthrin, cyhalodiamide, cyhalothrin, gamma-cyhalothrin, lambda-cyhalothrin, cypermethrin, alpha-cypermethrin, zeta-cypermethrin, cyromazine, deltamethrin, diafenthiuron, diazinon, dicloromezotiaz, dieldrin, diflubenzuron, dimefluthrin, dimehypo, dimethoate, dimpropyridaz, dinotefuran, diofenolan, emamectin, emamectin benzoate, endosulfan, esfenvalerate, ethiprole, etofenprox, epsilon-metofluthrin, etoxazole, fenbutatin oxide, fenitrothion, fenothiocarb, fenoxycarb, fenpropathrin, fenvalerate, fipronil, flometoquin, flonicamid, fluazaindolizine, flubendiamide, flucythrinate, flufenerim, flufenoxuron, flufenoxystrobin, fluensulfone, fluhexafon, fluopyram, flufiprole, flupyradifurone, flupyrimin, fluvalinate, tau-fluvalinate, fluxametamide, fonophos, formetanate, fosthiazate, gamma-cyhalothrin, halofenozide, heptafluthrin, hexaflumuron, hexythiazox, hydramethylnon, imidacloprid, indoxacarb, insecticidal soaps, isofenphos, isocycloseram, kappa-tefluthrin, lambda-cyhalothrin, lufenuron, malathion, meperfluthrin, metaflumizone, metaldehyde, methamidophos, methidathion, methiocarb, methomyl, methoprene, methoxychlor, metofluthrin, methoxyfenozide, epsilon-metofluthrin, epsilon-momfluorothrin, monocrotophos, momfluorothrin, nicotine, nitenpyram, nithiazine, novaluron, noviflumuron, oxamyl, oxazosulfyl, parathion, parathion-methyl, permethrin, phorate, phosalone, phosmet, phosphamidon, pirimicarb, profenofos, profluthrin, propargite, protrifenbute, pyflubumide, pymetrozine, pyrafluprole, pyrethrin, pyridaben, pyridalyl, pyrifluquinazon, pyriminostrobin, pyriprole, pyriproxyfen, rotenone, ryanodine, silafluofen, spinetoram, spinosad, spirodiclofen, spiromesifen, spiropidion, spirotetramat, sulprofos, sulfoxaflor, tebufenozide, tebufenpyrad, teflubenzuron, tefluthrin, kappa-tefluthrin, terbufos, tetrachlorantraniliprole, tetrachlorvinphos, tetramethrin, tetramethylfluthrin, tetraniliprole, thiacloprid, thiamethoxam, thiodicarb, thiosultap-sodium, tioxazafen, tolfenpyrad, tralomethrin, triazamate, trichlorfon, triflumezopyrim, triflumuron, tyclopyrazoflor, zeta-cypermethrin, Bacillus thuringiensis delta-endotoxins, entomopathogenic bacteria, entomopathogenic viruses or entomopathogenic fungi.

One embodiment of biological agents for mixing with compounds of this disclosure include entomopathogenic bacteria such as Bacillus thuringiensis, and the encapsulated delta-endotoxins of Bacillus thuringiensis such as MVP® and MVPII® bioinsecticides prepared by the CellCap® process (CellCap®, MVP® and MVPII® are trademarks of Mycogen Corporation, Indianapolis, Indiana, USA); entomopathogenic fungi such as green muscardine fungus; and entomopathogenic (both naturally occurring and genetically modified) viruses including baculovirus, nucleopolyhedro virus (NPV) such as Helicoverpa zea nucleopolyhedrovirus (HzNPV), Anagrapha falcifera nucleopolyhedrovirus (AfNPV); and granulosis virus (GV) such as Cydia pomonella granulosis virus (CpGV).

General references for these agricultural protectants (i.e. insecticides, fungicides, nematocides, acaricides, herbicides and biological agents) include The Pesticide Manual, 13th Edition, C. D. S. Tomlin, Ed., British Crop Protection Council, Farnham, Surrey, U. K., 2003 and The BioPesticide Manual, 2nd Edition, L. G. Copping, Ed., British Crop Protection Council, Farnham, Surrey, U. K., 2001.

For embodiments where one or more of invertebrate pest control compounds are used, the weight ratio of these compounds (in total) to the component (a1) and component (a2) compounds is typically between about 1:3000 and about 3000:1. Of note are weight ratios between about 1:300 and about 300:1 (for example ratios between about 1:30 and about 30:1). One skilled in the art can easily determine through simple experimentation the biologically effective amounts of active ingredients necessary for the desired spectrum of biological activity.

Component (a1) and component (a2) compounds and/or combinations thereof with component (b) compounds and/or one or more other biologically active compounds or agents can be applied to plants genetically transformed to express proteins toxic to invertebrate pests (such as Bacillus thuringiensis delta-endotoxins). The effect of the exogenously applied present component (a1) and component (a2) alone or in combination with component (b) may be synergistic with the expressed toxin proteins.

Of note is the combination or the composition comprising component (a1) and component (a2), or components (a1) and (a2) and (b), as described in the Summary of the Invention further comprising at least one invertebrate pest control compound or agent (e.g., insecticide, acaricide). Of particular note is a composition comprising component (a1) and component (a2) and at least one (i.e. one or more) invertebrate pest control compound or agent, which then can be subsequently combined with component (b) to provide a composition comprising components (a1) and (a2) and (b) and the one or more invertebrate pest control compounds or agents. Alternatively without first mixing with component (b), a biologically effective amount of the composition comprising component (a1) and component (a2) with at least one invertebrate pest control agent can be applied to a plant or plant seed (directly or through the environment of the plant or plant seed) to protect the plant or plant seed from diseases caused by fungal pathogens and injury caused by invertebrate pests.

Of note is a composition of the present invention which comprises in addition to component (a1) and component (a2), alone or in combination with component (b), at least one invertebrate pest control compound or agent selected from the group consisting abamectin, acetamiprid, acrinathrin, acynonapyr, afidopyropen, amitraz, avermectin, azadirachtin, benfuracarb, bensultap, bifenthrin, buprofezin, broflanilide, cadusafos, carbaryl, cartap, chlorantraniliprole, chloroprallethrin, chlorfenapyr, chlorpyrifos, clothianidin, cyantraniliprole, cyclaniliprole, cycloprothrin, cyfluthrin, beta-cyfluthrin, cyhalothrin, gamma-cyhalothrin, lambda-cyhalothrin, cypermethrin, alpha-cypermethrin, zeta-cypermethrin, cyromazine, deltamethrin, dieldrin, dinotefuran, diofenolan, emamectin, endosulfan, epsilon-metofluthrin, esfenvalerate, ethiprole, etofenprox, etoxazole, fenitrothion, fenothiocarb, fenoxycarb, fenvalerate, fipronil, flometoquin, fluxametamide, flonicamid, flubendiamide, fluensulfone, flufenoxuron, flufenoxystrobin, flufensulfone, flupiprole, flupyrimin, flupyradifurone, fluvalinate, formetanate, fosthiazate, gamma-cyhalothrin, heptafluthrin, hexaflumuron, hydramethylnon, imidacloprid, indoxacarb, isocycloseram, kappa-tefluthrin, lambda-cyhalothrin, lufenuron, meperfluthrin, metaflumizone, methiodicarb, methomyl, methoprene, methoxyfenozide, metofluthrin, monofluorothrin, nitenpyram, nithiazine, novaluron, oxamyl, pyflubumide, pymetrozine, pyrethrin, pyridaben, pyridalyl, pyriminostrobin, pyriproxyfen, ryanodine, spinetoram, spinosad, spirodiclofen, spiromesifen, spirotetramat, sulfoxaflor, tebufenozide, tetramethrin, tetramethylfluthrin, thiacloprid, thiamethoxam, thiodicarb, thiosultap-sodium, tralomethrin, triazamate, triflumezopyrim, triflumuron, tyclopyrazoflor, zeta-cypermethrin, Bacillus thuringiensis delta-endotoxins, all strains of Bacillus thuringiensis and all strains of nucleo polyhedrosis viruses.

In certain instances, combinations of component (a1) and component (a2) of this invention, alone or in mixture with component (b), with other biologically active (particularly fungicidal) compounds or agents (i.e. active ingredients) can result in a greater-than-additive (i.e. synergistic) effect. Reducing the quantity of active ingredients released in the environment while ensuring effective pest control is always desirable. When an enhanced effect of fungicidal active ingredients occurs at application rates giving agronomically satisfactory levels of fungal control, such combinations can be advantageous for reducing crop production cost and decreasing environmental load.

Compositions comprising component (a1) and component (a2) useful for seed treatment can further comprise bacteria and fungi that have the ability to provide protection from the harmful effects of plant pathogenic fungi or bacteria and/or soil born animals such as nematodes. Bacteria exhibiting nematicidal properties may include but are not limited to Bacillus firmus, Bacillus cereus, Bacillus subtillis and Pasteuria penetrans. A suitable Bacillus firmus strain is strain CNCM I-1582 (GB-126) which is commercially available as BioNem™. A suitable Bacillus cereus strain is strain NCMM I-1592. Both Bacillus strains are disclosed in U.S. Pat. No. 6,406,690. Other suitable bacteria exhibiting nematicidal activity are B. amyloliquefaciens IN937a and B. subtilis strain GB03. Bacteria exhibiting fungicidal properties may include but are not limited to B. pumilus strain GB34. Fungal species exhibiting nematicidal properties may include but are not limited to Myrothecium verrucaria, Paecilomyces lilacinus and Purpureocillium lilacinum.

Seed treatments can also include one or more nematicidal agents of natural origin such as the elicitor protein called harpin which is isolated from certain bacterial plant pathogens such as Erwinia amylovora. An example is the Harpin-N-Tek seed treatment technology available as N-Hibit™ Gold CST.

Seed treatments can also include one or more species of legume-root nodulating bacteria such as the microsymbiotic nitrogen-fixing bacteria Bradyrhizobium japonicum. These inocculants can optionally include one or more lipo-chitooligosaccharides (LCOs), which are nodulation (Nod) factors produced by rhizobia bacteria during the initiation of nodule formation on the roots of legumes. For example, the Optimize® brand seed treatment technology incorporates LCO Promoter Technology™ in combination with an inoculant.

Seed treatments can also include one or more isoflavones which can increase the level of root colonization by mycorrhizal fungi. Mycorrhizal fungi improve plant growth by enhancing the root uptake of nutrients such as water, sulfates, nitrates, phosphates and metals. Examples of isoflavones include, but are not limited to, genistein, biochanin A, formononetin, daidzein, glycitein, hesperetin, naringenin and pratensein. Formononetin is available as an active ingredient in mycorrhizal inocculant products such as PHC Colonize® AG.

Seed treatments can also include one or more plant activators that induce systemic acquired resistance in plants following contact by a pathogen. An example of a plant activator which induces such protective mechanisms is acibenzolar-S-methyl.

In the present fungicidal compositions, component (a1) and component (a2) can work synergistically with the additional fungicidal compounds of component (b) to provide such beneficial results as broadening the spectrum of plant diseases controlled, extending duration of preventative and curative protection, and suppressing proliferation of resistant fungal pathogens. In particular embodiments, compositions are provided in accordance with this invention that comprise proportions of component (a1) and component (a2) and component (b) that are especially useful for controlling particular fungal diseases (such as Alternaria solani, Blumeria graminis f. sp. tritici, Botrytis cinerea, Puccinia recondita f. sp. tritici, Rhizoctonia solani, Septoria nodorum, Septoria tritici).

Mixtures of fungicides may also provide significantly better disease control than could be predicted based on the activity of the individual components. This synergism has been described as “the cooperative action of two components of a mixture, such that the total effect is greater or more prolonged than the sum of the effects of the two (or more) taken independently” (see P. M. L. Tames, Neth. J. Plant Pathology 1964, 70, 73-80). In methods providing plant disease control in which synergy is exhibited from a combination of active ingredients (e.g., fungicidal compounds) applied to the plant or seed, the active ingredients are applied in a synergistic weight ratio and synergistic (i.e. synergistically effective) amounts. Measures of disease control, inhibition and prevention cannot exceed 100%. Therefore expression of substantial synergism typically requires use of application rates of active ingredients wherein the active ingredients separately provide much less than 100% effect, so that their additive effect is substantially less than 100% to allow the possibility of increase in effect as result of synergism. On the other hand, application rates of active ingredients that are too low may not show much activity in mixtures even with the benefit of synergism. One skilled in the art can easily identify and optimize through simple experimentation the weight ratios and application rates (i.e. amounts) of fungicidal compounds providing synergy.

A synergistic effect exists whenever the action of a combination of active components is greater than the sum of the action of each of the components alone. Therefore, a synergistic combination is a combination of active components having an action that is greater than the sum of the action of each active component alone, and a synergistically effective amount is an effective amount of a synergistic combination. Well-known methods for determining whether synergy exists include the Colby method, the Tammes method and the Wadley method, all of which are described below. Any one of these methods may be used to determine if synergy exists between compounds A and B.

In the Colby method, also referred to as the Limpels method, the action to be expected E for a given active ingredient combination obeys the so-called Colby formula. According to Colby, the expected action of active ingredients A+B using p+q ppm of active ingredient is:

$$E - X + Y - [ \frac{X \times Y}{100} ]$$

where ppm=milligrams of active ingredient (a.i.) per liter of spray mixture X=% action by component A using p ppm of active ingredient Y=% action by component B using q ppm of active ingredient. If the ratio R defined as the action actually observed (0) divided by the expected action (E) is >1 then the action of the combination is superadditive, i.e. there is a synergistic effect. For a more detailed description of the Colby formula, see Colby, S. R. “Calculating synergistic and antagonistic responses of herbicide combination,” Weeds, Vol. 15, pages 20-22; 1967; see also Limpel et al., Proc. NEWCC 16: 48-53 (1962).

The Tammes method uses a graphic representation to determine whether a synergistic effect exists. See “Isoboles, a graphic representation of synergism in pesticides,” Netherlands Journal of Plant Pathology, 70 (1964) p. 73-80.

The Wadley method is based on comparison of an observed EC50 value (i.e concentration providing 50% control) obtained from experimental data using the dose response curves and an expected EC50 calculated theoretically from the formula:

$${EC 50 ( A + B )}_{exp} = \frac{a + b}{\frac{a}{{EC 50 ( A )}_{obs}} + \frac{b}{{EC 50 ( B )}_{obs}}}$$

wherein a and b are the weight ratios of compound A and B in the mixture and EC50obs is the experimentally determined EC50 value obtained using the dose response curves for the individual compounds. The ratio EC50(A+B)_{expected}/EC50(A+B)_{observed} expresses the factor of interaction (F) (synergy factor). In the case of synergism, F is >1. For a more detailed description of the Wadley method, see Levi et al., EPPO-Bulletin 16, 1986, 651-657.

Without further elaboration, it is believed that one skilled in the art using the preceding description can utilize the present invention to its fullest extent. The following examples are, however, to be construed as merely illustrative, and not limiting of the disclosure in any way whatsoever.

### BIOLOGICAL EXAMPLES OF THE INVENTION

The following tests demonstrate the control efficacy of compositions of this invention (i.e. mixtures) on specific fungal pathogens. In particular, efficacy of compositions were evaluated against pathogen strains that have been identified as sensitive or resistant biotypes, and have been associated with control failure to a previously effective fungicide. For example, a fungicide identified by FRAC.

The strains of Zymoseptoria tritici (synonym Septoria tritici) expressing one or multiple gene mutations used for inoculation in the tests below were sourced as follows.

The Zymoseptoria tritici isolate IPO323 (Epitype of Septoria tritici Desm.) was sourced from Westerdijk Fungal Biodiversity Institute (CBS, Netherlands) as the International Depository Authority (IDA) under the Regulations of the Budapest Treaty on the International Recognition of the Deposit of Microorganisms for the Purposes of Patent Procedure. The isolate was deposited on Jul. 5, 1981 in the CBS library with the reference number CBS 115943.

Zymoseptoria tritici strains TriR6 and TriR10, two phenotypes from the TriMR group expressing CYP51 mutations, were sourced from INRAE (France's National Research Institute for Agriculture, Food and Environment). All isolates were maintained at −80° C. in glycerol, and brought to room temperature prior to use in tests. Isolates were used after one transplant into a Petri dish.

The TriMR group encompasses a number of different phenotypes, each having known fungicide resistance factors. For further information on the phenotype categories and their fungicide resistance factors see: Evolution of resistance to fungicides in populations of Mycosphaerella graminicola: emergence of new phenotypes highly resistant to DMIs, Conference: EPPO workshop on Azole fungicide and Septoria leaf blotch control, December 2010; Leroux et al., Pest Management Science, 2007, 63, 688-98; and Walker, Pest Management Science, 2011, 67, 44-59.

Strains identified as 20, 30, 39 and 97 in the tests below are field isolates with target site mutations conferring reduced sensitivity to SDHI fungicides. The isolates were collected and characterized in 2021 during resistance monitoring in Europe. The table below summarizes the mutations detected for each of these strains as well as the country of origin of the isolates.

| | | | Date of |
|---|---|---|---|
| Strain | Mutation | Country | Sampling |
| 20 | N86S | Ireland | 2021 |
| 30 | F23S, I29V, N33T, N34T, H152R | United Kingdom | 2021 |
| 39 | H152R | United Kingdom | 2021 |
| 97 | T79N | Germany | 2021 |

General protocol for preparing test compositions used in Tests A through G are as follows. Technical fluindapyr was prepared and formulated as an emulsifiable concentrate (100 EC). Fenpicoxamid was obtained as a formulated product (commercially available as Questar™). The products were dispersed in sufficient water to give the desired concentration, and neither organic solvent nor surfactant were added to the suspension. The resulting test mixtures were then used in Tests A-H, spraying at a volume of 250 L/ha using a tunnel sprayer. Application rates were 50 and 150 grams a.i. per hectare for fluindapyr, and 33.3 and 100 grams a.i. per hectare for fenpicoxamid.

### Test Compositions:

$$\frac{Ingredients}{fluindapyr , formulated as 100 EC} \qquad Composition 1$$

$$\frac{Ingredients}{fenpicoxamid , ( Questar™ ) formulated as 50 EC} \qquad Composition 2$$

Test results for Tests A through G are provided in the Tables below. The results in each table correspond to a set of evaluations performed together at the same time. In the tables, a rating of 100 indicates 100% disease control and a rating of 0 indicates no disease control (relative to the untreated controls). Columns labeled “Observed Efficacy” indicate the average of results observed from independent tests run on individual plants (number of replications indicated below). Columns labeled “Expected Efficacy” indicate the expected value for each treatment mixture using the Colby equation, as described above.

### Test A

The test composition was sprayed on 6-day old wheat seedlings. The following day the seedlings were inoculated with a spore suspension of Zymoseptoria tritici (strain IPO323) (the causal agent of Septoria tritici blotch) and incubated in a saturated atmosphere at 20° C. for 48 h, and then moved to a growth chamber at 20° C. for 21 days, after which time visual disease ratings were made. The test results provided in Table A below are the mean average of four tests, each test having four replications (i.e. pots) per composition, where each replication (i.e. pot) contained five plants.

TABLE A
Observed and Expected Efficacy of Composition 1 and Composition
2 Used Alone and in Mixtures in Controlling Septoria Tritici
Blotch caused by Zymoseptoria tritici (Strain IPO323)

| | Application Rate | Observed | Expected |
|---|---|---|---|
| Composition | (g a.i./ha) | Efficacy | Efficacy |
| 1 | 50 | 31 | — |
| 1 | 150 | 54 | — |
| 2 | 33.3 | 33 | — |
| 2 | 100 | 76 | — |
| 1 + 2 | 50 + 33.3 | 74 | 53.77 |
| 1 + 2 | 150 + 100 | 95 | 88.96 |

### Test B

The test suspension was sprayed on 6-day old wheat seedlings. The following day the seedlings were inoculated with a spore suspension of Zymoseptoria tritici (strain TriR6) (the causal agent of Septoria tritici blotch) and incubated in a saturated atmosphere at 20° C. for 48 h, and then moved to a growth chamber at 20° C. for 21 days, after which time visual disease ratings were made. The test results provided in Table B below are the mean average of two tests, each test having four replications (i.e. pots) per composition, where each replication (i.e. pot) contained five plants.

TABLE B
Observed and Expected Effects of Composition 1 and Composition
2 Used Alone and in Mixtures in Controlling Septoria Tritici
Blotch caused by Zymoseptoria tritici (Strain TriR6)

| | Application Rate | Observed | Expected |
|---|---|---|---|
| Composition | (g a.i./ha) | Efficacy | Efficacy |
| 1 | 50 | 22 | — |
| 1 | 150 | 39 | — |
| 2 | 33.3 | 32 | — |
| 2 | 100 | 88 | — |
| 1 + 2 | 50 + 33.3 | 91 | 46.96 |
| 1 + 2 | 150 + 100 | 100 | 92.68 |

### Test C

The test suspension was sprayed on 6-day old wheat seedlings. The following day the seedlings were inoculated with a spore suspension of Zymoseptoria tritici (strain TriR10) (the causal agent of Septoria tritici blotch) and incubated in a saturated atmosphere at 20° C. for 48 h, and then moved to a growth chamber at 20° C. for 21 days, after which time visual disease ratings were made. The test results provided in Table C below are the mean average of two tests, each test having four replications (i.e. pots) per composition, where each replication (i.e. pot) contained five plants.

TABLE C
Observed and Expected Effects of Composition 1 and Composition
2 Used Alone and in Mixtures in Controlling Septoria Tritici Blotch
caused by Zymoseptoria tritici (Strain TriR10)

| | Application Rate | Observed | Expected |
|---|---|---|---|
| Composition | (g a.i./ha) | Efficacy | Efficacy |
| 1 | 50 | 48 | — |
| 1 | 150 | 83 | — |
| 2 | 33.3 | 54 | — |
| 2 | 100 | 95 | — |
| 1 + 2 | 50 + 33.3 | 93 | 76.08 |
| 1 + 2 | 150 + 100 | 100 | 99.15 |

### Test D

The test suspension was sprayed on 6-day old wheat seedlings. The following day the seedlings were inoculated with a spore suspension of Zymoseptoria tritici (strain 20, having the mutation N86S) (the causal agent of Septoria tritici blotch) and incubated in a saturated atmosphere at 20° C. for 48 h, and then moved to a growth chamber at 20° C. for 21 days, after which time visual disease ratings were made. The test results provided in Table D below are the mean average of three tests, each test having four replications (i.e. pots) per composition, where each replication (i.e. pot) contained five plants.

TABLE D
Observed and Expected Effects of Composition 1 and Composition 2
used Alone and in Mixtures in Controlling Septoria Tritici Blotch caused
by Zymoseptoria tritici (Strain 20, with Mutation N86S)

| | Application Rate | Observed | Expected |
|---|---|---|---|
| Composition | (g a.i./ha) | Efficacy | Efficacy |
| 1 | 50 | 5 | — |
| 1 | 150 | 12 | — |
| 2 | 33.3 | 11 | — |
| 2 | 100 | 60 | — |
| 1 + 2 | 50 + 33.3 | 49 | 15.45 |
| 1 + 2 | 150 + 100 | 92 | 64.80 |

### Test E

The test suspension was sprayed on 6-day old wheat seedlings. The following day the seedlings were inoculated with a spore suspension of Zymoseptoria tritici (strain 30, having mutations F23S, I29V, N33T, N34T and H152R) (the causal agent of Septoria tritici blotch) and incubated in a saturated atmosphere at 20° C. for 48 h, and then moved to a growth chamber at 20° C. for 21 days, after which time visual disease ratings were made. The test results provided in Table E below are the mean average of three tests, each test having four replications (i.e. pots) per composition, where each replication (i.e. pot) contained five plants.

TABLE E
Observed and Expected Effects of Composition 1 and Composition
2 used Alone and in Mixtures in Controlling Septoria Tritici
Blotch caused by Zymoseptoria tritici (Strain 30, with
Mutations F23S, I29V, N33T, N34T and H152R)

| | Application Rate | Observed | Expected |
|---|---|---|---|
| Composition | (g a.i./ha) | Efficacy | Efficacy |
| 1 | 50 | 8 | — |
| 1 | 150 | 5 | — |
| 2 | 33.3 | 11 | — |
| 2 | 100 | 32 | — |
| 1 + 2 | 50 + 33.3 | 35 | 18.12 |
| 1 + 2 | 150 + 100 | 70 | 35.40 |

### Test F

The test suspension was sprayed on 6-day old wheat seedlings. The following day the seedlings were inoculated with a spore suspension of Zymoseptoria tritici (strain 39, having mutation H152R) (the causal agent of Septoria tritici blotch) and incubated in a saturated atmosphere at 20° C. for 48 h, and then moved to a growth chamber at 20° C. for 21 days, after which time visual disease ratings were made. The test results provided in Table F below are the mean average of three tests, each test having four replications (i.e. pots) per composition, where each replication (i.e. pot) contained five plants.

TABLE F
Observed and Expected Effects of Composition 1 and
Composition 2 used Alone and in Mixtures in Controlling
Septoria Tritici Blotch caused by Zymoseptoria tritici
(Strain 39, with Mutation H152R)

| | Application Rate | Observed | Expected |
|---|---|---|---|
| Composition | (g a.i./ha) | Efficacy | Efficacy |
| 1 | 50 | 5 | — |
| 1 | 150 | 9 | — |
| 2 | 33.3 | 33 | — |
| 2 | 100 | 88 | — |
| 1 + 2 | 50 + 33.3 | 74 | 36.35 |
| 1 + 2 | 150 + 100 | 97 | 89.08 |

### Test G

The test suspension was sprayed on 6-day old wheat seedlings. The following day the seedlings were inoculated with a spore suspension of Zymoseptoria tritici (strain 97, having mutation T79N) (the causal agent of Septoria tritici blotch) and incubated in a saturated atmosphere at 20° C. for 48 h, and then moved to a growth chamber at 20° C. for 21 days, after which time visual disease ratings were made. The test results provided in Table G below are the mean average of three tests, each test having four replications (i.e. pots) per composition, where each replication (i.e. pot) contained five plants.

TABLE G
Observed and Expected Effects of Composition 1 and Composition 2
used Alone and in Mixtures in Controlling Septoria Tritici Blotch caused
by Zymoseptoria tritici (Strain 97, with Mutation T79N)

| | Application Rate | Observed | Expected |
|---|---|---|---|
| Composition | (g a.i./ha) | Efficacy | Efficacy |
| 1 | 50 | 6 | — |
| 1 | 150 | 8 | — |
| 2 | 33.3 | 31 | — |
| 2 | 100 | 63 | — |
| 1 + 2 | 50 + 33.3 | 71 | 35.14 |
| 1 + 2 | 150 + 100 | 94 | 65.96 |

General protocol for preparing test compositions used in Tests H through N are as follows. Benzovindiflupyr was obtain as a formulated product (commercially available as ELATUS® PLUS). Fenpicoxamid was as described above for Composition 2. The products were dispersed in sufficient water to give the desired concentration, and neither organic solvent nor surfactant were added to the suspension. The resulting test mixtures were then used in Tests H-N, spraying at a volume of 250 L/ha using a tunnel sprayer. Application rates were 25 and 75 grams a.i. per hectare for benzovindiflupyr, and 33.3 and 100 grams a.i. per hectare for fenpicoxamid.

### Test Compositions:

$$\frac{Ingredients}{\begin{matrix}benzovindiflupyr ( ELATUS ® PLUS ) , \\ formulated as 100 EC\end{matrix}} \qquad Composition 3$$

$$\frac{Ingredients}{fenpicoxamid , ( Questar™ ) formulated as 50 EC} \qquad Composition 2$$

Test results for Tests H through N are provided in the Tables below. The results in each table correspond to a set of evaluations performed together at the same time. In the tables, a rating of 100 indicates 100% disease control and a rating of 0 indicates no disease control (relative to the untreated controls). Columns labeled “Observed Efficacy” indicate the average of results observed from independent tests run on individual plants (number of replications indicated below). Columns labeled “Expected Efficacy” indicate the expected value for each treatment mixture using the Colby equation, as described above.

### Test H

The test suspension was sprayed on 6-day old wheat seedlings. The following day the seedlings were inoculated with a spore suspension of Zymoseptoria tritici (strain IPO323) (the causal agent of Septoria tritici blotch) and incubated in a saturated atmosphere at 20° C. for 48 h, and then moved to a growth chamber at 20° C. for 21 days, after which time visual disease ratings were made. Test results provided in Table H below are for a single test, each test having four replications (i.e. pots) per composition, where each replication (i.e. pot) contained five plants.

TABLE H
Observed and Expected Efficacy of Composition 3 and Composition
2 used Alone and in Mixtures in Controlling Septoria Tritici
Blotch caused by Zymoseptoria tritici (Strain IPO323)

| | Application Rate | Observed | Expected |
|---|---|---|---|
| Composition | (g a.i./ha) | Efficacy | Efficacy |
| 3 | 25 | 8 | — |
| 3 | 75 | 11 | — |
| 2 | 33.3 | 8 | — |
| 2 | 100 | 46 | — |
| 3 + 2 | 25 + 33.3 | 17 | 15.36 |
| 3 + 2 | 75 + 100 | 92 | 51.94 |

### Test I

The test suspension was sprayed on 6-day old wheat seedlings. The following day the seedlings were inoculated with a spore suspension of Zymoseptoria tritici (strain mutation TriR6) (the causal agent of Septoria tritici blotch) and incubated in a saturated atmosphere at 20° C. for 48 h, and then moved to a growth chamber at 20° C. for 21 days, after which time visual disease ratings were made. Test results provided in Table I below are for a single test, each test having four replications (i.e. pots) per composition, where each replication (i.e. pot) contained five plants.

TABLE I
Observed and Expected Efficacy of Composition 3 and Composition
2 used Alone and in Mixtures in Controlling Septoria Tritici Blotch
caused by Zymoseptoria tritici (Strain Mutation TriR6)

| | Application Rate | Observed | Expected |
|---|---|---|---|
| Composition | (g a.i./ha) | Efficacy | Efficacy |
| 3 | 25 | 16 | — |
| 3 | 75 | 89 | — |
| 2 | 33.3 | 24 | — |
| 2 | 100 | 88 | — |
| 3 + 2 | 25 + 33.3 | 86 | 36.16 |
| 3 + 2 | 75 + 100 | 99 | 98.68 |

### Test J

The test suspension was sprayed on 6-day old wheat seedlings. The following day the seedlings were inoculated with a spore suspension of Zymoseptoria tritici (strain mutation TriR10) (the causal agent of Septoria tritici blotch) and incubated in a saturated atmosphere at 20° C. for 48 h, and then moved to a growth chamber at 20° C. for 21 days, after which time visual disease ratings were made. Test results provided in Table J below are for a single test, each test having four replications (i.e. pots) per composition, where each replication (i.e. pot) contained five plants.

TABLE J
Observed and Expected Efficacy of Composition 3 and Composition
2 used Alone and in Mixtures in Controlling Septoria Tritici Blotch
caused by Zymoseptoria tritici (Strain Mutation TriR10)

| | Application Rate | Observed | Expected |
|---|---|---|---|
| Composition | (g a.i./ha) | Efficacy | Efficacy |
| 3 | 25 | 24 | — |
| 3 | 75 | 92 | — |
| 2 | 33.3 | 51 | — |
| 2 | 100 | 98 | — |
| 3 + 2 | 25 + 33.3 | 97 | 62.76 |
| 3 + 2 | 75 + 100 | 100 | 99.84 |

### Test K

The test suspension was sprayed on 6-day old wheat seedlings. The following day the seedlings were inoculated with a spore suspension of Zymoseptoria tritici (strain 20, having mutation N86S) (the causal agent of Septoria tritici blotch) and incubated in a saturated atmosphere at 20° C. for 48 h, and then moved to a growth chamber at 20° C. for 21 days, after which time visual disease ratings were made. Test results provided in Table K below are for a single test, each test having four replications (i.e. pots) per composition, where each replication (i.e. pot) contained five plants.

TABLE K
Observed and Expected Efficacy of Composition 3 and Composition 2
used Alone and in Mixtures in Controlling Septoria Tritici Blotch caused
by Zymoseptoria tritici (Strain 20, with Mutation N86S)

| | Application Rate | Observed | Expected |
|---|---|---|---|
| Composition | (g a.i./ha) | Efficacy | Efficacy |
| 3 | 25 | 4 | — |
| 3 | 75 | 1 | — |
| 2 | 33.3 | 2 | — |
| 2 | 100 | 48 | — |
| 3 + 2 | 25 + 33.3 | 14 | 5.92 |
| 3 + 2 | 75 + 100 | 62 | 48.52 |

### Test L

The test suspension was sprayed on 6-day old wheat seedlings. The following day the seedlings were inoculated with a spore suspension of Zymoseptoria tritici (strain 30, having mutations F23S, I29V, N33T, N34T, and H152R) (the causal agent of Septoria tritici blotch) and incubated in a saturated atmosphere at 20° C. for 48 h, and then moved to a growth chamber at 20° C. for 21 days, after which time visual disease ratings were made. Test results provided in Table L below are for a single test, each test having four replications (i.e. pots) per composition, where each replication (i.e. pot) contained five plants.

TABLE L
Observed and Expected Efficacy of Composition 3 and Composition
2 used Alone and in Mixtures in Controlling Septoria Tritici
Blotch caused by Zymoseptoria tritici (Strain 30, with
Mutations F23S, 129V, N33T, N34T, and H152R)

| | Application Rate | Observed | Expected |
|---|---|---|---|
| Composition | (g a.i./ha) | Efficacy | Efficacy |
| 3 | 25 | 6 | — |
| 3 | 75 | 5 | — |
| 2 | 33.3 | 9 | — |
| 2 | 100 | 15 | — |
| 3 + 2 | 25 + 33.3 | 11 | 14.46 |
| 3 + 2 | 75 + 100 | 15 | 19.25 |

### Test M

The test suspension was sprayed on 6-day old wheat seedlings. The following day the seedlings were inoculated with a spore suspension of Zymoseptoria tritici (strain 39, having mutation H152R) (the causal agent of Septoria tritici blotch) and incubated in a saturated atmosphere at 20° C. for 48 h, and then moved to a growth chamber at 20 CC for 21 days, after which time visual disease ratings were made. Test results provided in Table M below are for a single test, each test having four replications (i.e. pots) per composition, where each replication (i.e. pot) contained five plants.

TABLE M
Observed and Expected Efficacy of Composition 3 and Composition 2
used Alone and in Mixtures in Controlling Septoria Tritici Blotch caused
by Zymoseptoria tritici (Strain 39, with Mutation H152R)

| | Application Rate | Observed | Expected |
|---|---|---|---|
| Composition | (g a.i./ha) | Efficacy | Efficacy |
| 3 | 25 | 8 | — |
| 3 | 75 | 5 | — |
| 2 | 33.3 | 5 | — |
| 2 | 100 | 13 | — |
| 3 + 2 | 25 + 33.3 | 7 | 12.6 |
| 3 + 2 | 75 + 100 | 72 | 17.35 |

### Test N

The test suspension was sprayed on 6-day old wheat seedlings. The following day the seedlings were inoculated with a spore suspension of Zymoseptoria tritici (strain 97, having mutation T79N) (the causal agent of Septoria tritici blotch) and incubated in a saturated atmosphere at 20° C. for 48 h, and then moved to a growth chamber at 20° C. for 21 days, after which time visual disease ratings were made. Test results provided in Table N below are for a single test, each test having four replications (i.e. pots) per composition, where each replication (i.e. pot) contained five plants.

TABLE N
Observed and Expected Efficacy of Composition 3 and Composition 2
used Alone and in Mixtures in Controlling Septoria Tritici Blotch caused
by Zymoseptoria tritici (Strain 97, with Mutation T79N)

| | Application Rate | Observed | Expected |
|---|---|---|---|
| Composition | (g a.i./ha) | Efficacy | Efficacy |
| 3 | 25 | 0 | — |
| 3 | 75 | 8 | — |
| 2 | 33.3 | 17 | — |
| 2 | 100 | 68 | — |
| 3 + 2 | 25 + 33.3 | 14 | 17 |
| 3 + 2 | 75 + 100 | 90 | 70.56 |

General protocol for preparing test compositions used in Tests O through Q are as follows. Fluxapyroxad was obtain as a formulated product (commercially available as IMTREX®). Fenpicoxamid was as described above for Composition 2. The products were dispersed in sufficient water to give the desired concentration, and neither organic solvent nor surfactant were added to the suspension. The resulting test mixtures were then used in Tests O-Q, spraying at a volume of 250 L/ha using a tunnel sprayer. Application rates were 41.67, 62.5 and 125 grams a.i. per hectare for fluxapyroxad, and 33.3, 75 and 100 grams a.i. per hectare for fenpicoxamid

### Test Compositions:

$$\frac{Ingredients}{fluxapyroxad , ( IMTREX ® ) formulated as 62.5 EC} \qquad Composition 4$$

$$\frac{Ingredients}{fenpicoxamid , ( Questar™ ) formulated as 50 EC} \qquad Composition 2$$

### Test O

The test suspension was sprayed on 6-day old wheat seedlings. The following day the seedlings were inoculated with a spore suspension of Zymoseptoria tritici (strain 20, having mutation N86S) (the causal agent of Septoria tritici blotch) and incubated in a saturated atmosphere at 20° C. for 48 h, and then moved to a growth chamber at 20° C. for 21 days, after which time visual disease ratings were made. Test results provided in Table O below are the mean average of two tests, each test having four replications (i.e. pots) per composition, where each replication (i.e. pot) contained five plants.

TABLE O
Observed and Expected Efficacy of Composition 4 and Composition 2
used Alone and in Mixtures in Controlling Septoria Tritici Blotch caused
by Zymoseptoria tritici (Strain 20, with Mutation N86S)

| | Application Rate | Observed | Expected |
|---|---|---|---|
| Composition | (g a.i./ha) | Efficacy | Efficacy |
| 4 | 41.67 | 11 | — |
| 4 | 62.5 | 7 | — |
| 4 | 125 | 12 | — |
| 2 | 33.3 | 16 | — |
| 2 | 75 | 27 | — |
| 2 | 100 | 42 | — |
| 4 + 2 | 41.67 + 33.3 | 53 | 23.7 |
| 4 + 2 | 62.5 + 75 | 46 | 31.6 |
| 4 + 2 | 125 + 100 | 45 | 48.5 |

### Test P

The test suspension was sprayed on 6-day old wheat seedlings. The following day the seedlings were inoculated with a spore suspension of Zymoseptoria tritici (strain 30, having mutations F23S, I29V, N33T, N34T, and H152R) (the causal agent of Septoria tritici blotch) and incubated in a saturated atmosphere at 20° C. for 48 h, and then moved to a growth chamber at 20° C. for 21 days, after which time visual disease ratings were made. Test results provided in Table P below are the mean average of two tests, each test having four replications (i.e. pots) per composition, where each replication (i.e. pot) contained five plants.

TABLE P
Observed and Expected Efficacy of Composition 4 and Composition
2 used Alone and in Mixtures in Controlling Septoria Tritici
Blotch caused by Zymoseptoria tritici (Strain 30, with
Mutations F23S, I29V, N33T, N34T, and H152R)

| | Application Rate | Observed | Expected |
|---|---|---|---|
| Composition | (g a.i./ha) | Efficacy | Efficacy |
| 4 | 41.67 | 15 | — |
| 4 | 62.5 | 5 | — |
| 4 | 125 | 12 | — |
| 2 | 33.3 | 16 | — |
| 2 | 75 | 27 | — |
| 2 | 100 | 42 | — |
| 4 + 2 | 41.67 + 33.3 | 38 | 20.79 |
| 4 + 2 | 62.5 + 75 | 42 | 12.48 |
| 4 + 2 | 125 + 100 | 47 | 39.51 |

### Test Q

The test suspension was sprayed on 6-day old wheat seedlings. The following day the seedlings were inoculated with a spore suspension of Zymoseptoria tritici (strain 97, having mutation T79N) (the causal agent of Septoria tritici blotch) and incubated in a saturated atmosphere at 20° C. for 48 h, and then moved to a growth chamber at 20° C. for 21 days, after which time visual disease ratings were made. Test results provided in Table Q below are the mean average of two tests, each test having four replications (i.e. pots) per composition, where each replication (i.e. pot) contained five plants.

TABLE Q
Observed and Expected Efficacy of Composition 4 and Composition 2
used Alone and in Mixtures in Controlling Septoria Tritici Blotch caused
by Zymoseptoria tritici (strain 97, with mutation T79N)

| | Application Rate | Observed | Expected |
|---|---|---|---|
| Composition | (g a.i./ha) | Efficacy | Efficacy |
| 4 | 41.67 | 18 | — |
| 4 | 62.5 | 20 | — |
| 4 | 125 | 12 | — |
| 2 | 33.3 | 24 | — |
| 2 | 75 | 46 | — |
| 2 | 100 | 67 | — |
| 4 + 2 | 41.67 + 33.3 | 59 | 38.65 |
| 4 + 2 | 62.5 + 75 | 73 | 57.61 |
| 4 + 2 | 125 + 100 | 67 | 70.55 |

What is claimed is:

1. A composition comprising:
(a1) a succinate dehydrogenase inhibitor (SDHI); and
(a2) a picolinamide.

2. The composition of claim 1 wherein the SDHI is selected from
(a1-a) phenylbenzamides, benodanil, flutolanil, mepronil, phenyl-oxo-ethyl thiophene amides, isofetamid, pyridinyl-ethyl-benzamides, fluopyram, furan carboxamides, fenfuram, oxathiin carboxamides, carboxin and oxycarboxin, thiazole carboxamides, thifluzamide, pyrazole-4-carboxamides, benzovindiflupyr, bixafen, flubeneteram, fluindapyr, fluxapyroxad, furametpyr, inpyrfluxam, isopyrazam, penflufen, penthiopyrad, sedaxane, N-[2-(2,4-dichlorophenyl)-2-methoxy-1-methylethyl]-3-(difluoromethyl)-1-methyl-1H-pyrazole-4-carboxamide, N-cyclopropyl-N-benzyl-pyrazole carboxamides, isoflucypram, N-methoxy(phenylethyl)pyrazole carboxamides, pydiflumetofen, pyridine carboxamides, boscalid, pyrazine carboxamide fungicides and pyraziflumid; and
(a1-b) aminoindane amides having the structure of formula (I): 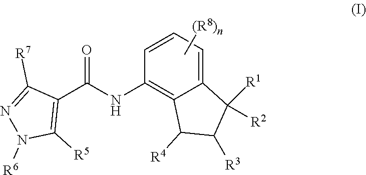
wherein
R¹, R², R³ and R⁴ are each independently H, C₁-C₄ alkyl, C₁-C₄ haloalkyl, C₃-C₆ cycloalkyl or C₃-C₆ halocycloalkyl;
R⁵ and R⁷ are each independently H, C₁-C₄ alkyl or C₁-C₄ haloalkyl;
R⁶ is C₁-C₄ alkyl, C₁-C₄ haloalkyl, C₃-C₆ cycloalkyl, C₃-C₆ halocycloalkyl, C₁-C₄ alkoxy, C₁-C₄ haloalkoxy, C₁-C₄ alkylthio or C₁-C₄ haloalkylthio;
R⁸ is halo, —OH, —SH, C₁-C₄ alkyl, C₁-C₄ haloalkyl, C₁-C₄ alkoxy, C₁-C₄ haloalkoxy, C₁-C₄ alkylthio or C₁-C₄ haloalkylthio; and
n is 0 to 3; and
(a1-c) combinations thereof.

3. The composition of claim 1 wherein the SDHI aminoindane amide of formula (I) is fluindapyr, with the structure:

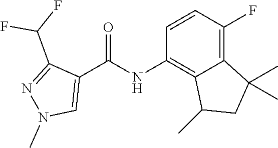 [SMILES: CC1CC(C)(C)c2c(F)ccc(NC(=O)c3cn(C)nc3C(F)F)c21]

4. The composition of claim 1 wherein the SDHI is benzovindiflupyr.

5. The composition of claim 1 wherein the SDHI is fluxapyroxad.

6. The composition of claim 1 wherein the picolinamide is selected from
(a2-a) fenpicoxamid, florylpicoxamid, [(1S,2S)-2-(4-fluoro-2-methyl-phenyl)-1,3-dimethyl-butyl](2S)-2-[(3-acetoxy-4-methoxy-pyridine-2-carbonyl)amino]propanoate, [(1S,2S)-2-(4-fluoro-2-methyl-phenyl)-1,3-dimethyl-butyl](2S)-2-[[3-(acetoxymethoxy)-4-methoxy-pyridine-2-carbonyl]amino]propanoate, and [(1S,2S)-2-(4-fluoro-2-methyl-phenyl)-1,3-dimethyl-butyl](2S)-2-[(3-hydroxy-4-methoxy-pyridine-2-carbonyl)amino]propanoate.

7. The composition of claim 1 wherein the picolinamide is selected from (a2-a) fenpicoxamid and florylpicoxamid and (a2-b) metarylpicoxamid.

8. The composition of claim 7 wherein the picolinamide is fenpicoxamid.

9. The composition of claim 7 wherein the picolinamide is florylpicoxamid.

10. The composition of claim 7 wherein the picolinamide is metarylpicoxamid.

11. The composition of claim 1 wherein the SDHI is selected from (a1-a) benzovindiflupyr, fluindapyr and fluxapyroxad, and the picolinamide is selected from (a2-a) fenpicoxamid and florylpicoxamid and (a2-b) metarylpicoxamid.

12. The composition of claim 11 wherein the SDHI is fluindapyr.

13. The composition of claim 11 wherein the picolinamide is fenpicoxamid.

14. The composition of claim 1 further comprising at least one component (b) selected from:
(b1) methyl benzimidazole carbamate (MBC) fungicides;
(b2) dicarboximide fungicides;
(b3) demethylation inhibitor (DMI) fungicides;
(b4) phenylamide (PA) fungicides;
(b5) amine/morpholine fungicides;
(b6) phospholipid biosynthesis inhibitor fungicides;
(b7) additional succinate dehydrogenase inhibitor (SDHI) fungicides;
(b8) hydroxy(2-amino)pyrimidine fungicides;
(b9) anilinopyrimidine (AP) fungicides;
(b10) N-phenyl carbamate fungicides;
(b11) quinone outside inhibitor (QoI) fungicides;
(b12) phenylpyrrole (PP) fungicides;
(b13) azanaphthalene fungicides;
(b14) cell peroxidation inhibitor fungicides;
(b15) melanin biosynthesis inhibitor-reductase (MBI-R) fungicides;
(b16a) melanin biosynthesis inhibitor-dehydratase (MBI-D) fungicides;
(b16b) melanin biosynthesis inhibitor-polyketide synthase (MBI-P) fungicides;
(b17) keto reductase inhibitor (KRI) fungicides;
(b18) squalene-epoxidase inhibitor fungicides;
(b19) polyoxin fungicides;
(b20) phenylurea fungicides;
(b21) quinone inside inhibitor (QiI) fungicides;
(b22) benzamide and thiazole carboxamide fungicides;
(b23) enopyranuronic acid antibiotic fungicides;
(b24) hexopyranosyl antibiotic fungicides;
(b25) glucopyranosyl antibiotic: protein synthesis fungicides;
(b26) glucopyranosyl antibiotic fungicides;
(b27) cyanoacetamide-oxime fungicides;
(b28) carbamate fungicides;
(b29) oxidative phosphorylation uncoupling fungicides;
(b30) organo tin fungicides;
(b31) carboxylic acid fungicides;
(b32) heteroaromatic fungicides;
(b33) phosphonate fungicides;
(b34) phthalamic acid fungicides;
(b35) benzotriazine fungicides;
(b36) benzene-sulfonamide fungicides;
(b37) pyridazinone fungicides;
(b38) thiophene-carboxamide fungicides;
(b39) complex I NADH oxidoreductase inhibitor fungicides;
(b40) carboxylic acid amide (CAA) fungicides;
(b41) tetracycline antibiotic fungicides;
(b42) thiocarbamate fungicides;
(b43) benzamide fungicides;
(b44) microbial fungicides;
(b45) quinone outside inhibitor, stigmatellin binding (QoSI) fungicides;
(b46) plant extract fungicides;
(b47) cyanoacrylate fungicides;
(b48) polyene fungicides;
(b49) oxysterol binding protein inhibitor (OSBPI) fungicides;
(b50) aryl-phenyl-ketone fungicides;
(b51) host plant defense induction fungicides;
(b52) multi-site activity fungicides;
(b53) biologicals with multiple modes of action;
(b54) fungicides other than fungicides of component (a1) and component (a2) and components (b1) through (b53); and
salts of compounds of (b1) through (b54).

15. The composition of claim 1 and at least one additional component selected from surfactants, solid diluents and liquid diluents.

16. The composition of claim 1 wherein the SDHI and the picolinamide are present in a ratio of SDHI:picolinamide in the range of from about 2:1 to about 1:1.

17. The composition of claim 1 wherein the SDHI and the picolinamide are present in a ratio of SDHI:picolinamide of about 1.5:1

18. The composition of claim 1 wherein the SDHI is in a form selected from a suspension concentrate, a capsule suspension, an emulsifiable concentrate, a granule, a wettable granule, and combinations thereof.

19. The composition of claim 1 wherein the picolinamide is in a form selected from a suspension concentrate, a capsule suspension, an emulsifiable concentrate, a granule, a wettable granule, and combinations thereof.

20. A method for protecting a plant or plant seed from diseases caused by fungal pathogens comprising applying a fungicidally effective amount of the composition of claim 1 to the plant or plant seed.
